(19) United States
(12) Patent Application Publication
(10) Pub. No.: US 2020/0357210 A1
(43) Pub. Date: Nov. 12, 2020

(54) ENTRY-EXIT MANAGEMENT SYSTEM, ENTRY-EXIT MANAGEMENT METHOD AND RECORDING MEDIUM

(71) Applicant: NEC CORPORATION, Tokyo (JP)

(72) Inventor: Rui ISHIYAMA, Tokyo (JP)

(73) Assignee: NEC CORPORATION, Tokyo (JP)

(21) Appl. No.: 16/640,532

(22) PCT Filed: Aug. 30, 2018
(86) PCT No.: PCT/JP2018/032116

§ 371 Date: Feb. 20, 2020

(30) Foreign Application Priority Data
Sep. 1, 2017 (JP) 2017-168897

(51) Int. Cl. G07C 9/22; G06Q 10/10; G07C 9/00

(52) U.S. Cl. CPC G07C 9/22; G07C 9/00571; G06Q 10/1091

(57) ABSTRACT

An entry-exit management system includes: a memory configured to store instructions; and at least one processor configured to execute the instructions to: register a dot identifier extracted from a dot described with a writing tool on an object to be an admission pass of a visitor; capture an image of the dot; check a dot identifier extracted from a dot an image of which is captured against a dot identifier registered; and control entry-exit of the visitor, based on a check result.

### TECHNICAL FIELD

The present disclosure relates to an entry-exit management system, an entry-exit management method, an information processing device, and the like.

### BACKGROUND ART

In aforementioned Technical Field, PTL 1 discloses a technology of issuing an admission pass by printing authentication information related to a receipt number of a visitor on a print medium and determining whether or not entry is approved by reading the authentication information on the admission pass at an entrance gate.

### CITATION LIST

### Patent Literature

PTL 1: Japanese Unexamined Patent Application Publication No. 2008-171350

### SUMMARY OF INVENTION

### Technical Problem

However, the technology described in the aforementioned literature requires a device for printing authentication information on a print medium, in order to issue an admission pass, and therefore takes cost and effort for issuing and managing admission passes.

An example of an object of the present disclosure is to provide a technology resolving the aforementioned problem.

### Solution to Problem

In order to achieve the object described above, one aspect of an entry-exit management system according to the present disclosure includes:

registration means configured to register a dot identifier extracted from a dot described with a writing tool on an object to be an admission pass of a visitor;

image capture means configured to capture an image of the dot;

checking means configured to check a dot identifier extracted from a dot an image of which is captured by the image capture means against a dot identifier registered in the registration means; and

control means configured to control entry-exit of the visitor, based on a check result by the checking means.

In order to achieve the object described above, one aspect of an entry-exit management method according to the present disclosure includes:

registering a dot identifier extracted from a dot being given to an object to be an admission pass of a visitor and being described with a writing tool;

capturing an image of the dot;

checking a dot identifier extracted from the dot an image of which is captured against the registered dot identifier; and

controlling entry-exit of the visitor, based on the check result.

In order to achieve the object described above, one aspect of an information processing device according to the present disclosure includes:

registration means configured to register a dot identifier extracted from a dot described with a writing tool on an object to be an admission pass of a visitor;

acquisition means configured to acquire a dot identifier extracted from a captured image of the dot;

checking means configured to check a dot identifier acquired by the acquisition means against a dot identifier registered in the registration means; and

instruction means configured to instruct control of entry-exit of the visitor, based on a check result by the checking means.

In order to achieve the object described above, one aspect of an information processing program held in a recording medium according to the present disclosure, the information processing program causes a computer to execute:

registration processing of registering, in registration means, a dot identifier extracted from a dot described with a writing tool on an object to be an admission pass of a visitor;

acquisition processing of acquiring a dot identifier extracted from a captured image of the dot;

checking processing of checking the acquired dot identifier against the registered dot identifier; and

instruction processing of instructing control of entry-exit of the visitor, based on the check result.

### Advantageous Effects of Invention

Cost and effort required for entry-exit management can be reduced.

### BRIEF DESCRIPTION OF DRAWINGS

FIG. 1 is a block diagram illustrating a configuration of an entry-exit management system according to a first example embodiment.

FIG. 2A is a diagram illustrating an overview of an entry-exit management system according to a second example embodiment.

FIG. 2B is a diagram illustrating a generation method of a dot allowing extraction of a dot feature value to be a dot identifier according to the second example embodiment.

FIG. 3A is a sequence diagram illustrating an operation procedure of the entry-exit management system according to the second example embodiment.

FIG. 3B is a sequence diagram illustrating another operation procedure of the entry-exit management system according to the second example embodiment.

FIG. 3C is a sequence diagram illustrating yet another operation procedure of the entry-exit management system according to the second example embodiment.

FIG. 4 is a block diagram illustrating a functional configuration of an entry-exit management server as an information processing device according to the second example embodiment.

FIG. 5 is a diagram illustrating a structure of an entry-exit management database according to the second example embodiment.

FIG. 6 is a block diagram illustrating a functional configuration of a registration device according to the second example embodiment.

FIG. 7 is a block diagram illustrating a functional configuration of an opening-closing device according to the second example embodiment.

FIG. 8A is a block diagram illustrating an example of a functional configuration of a dot identifier extraction unit according to the second example embodiment.

FIG. 8B is a flowchart illustrating a procedure of an example of dot identifier extraction processing according to the second example embodiment.

FIG. 9A is a block diagram illustrating an example of a functional configuration of a coordinate system determination unit according to the second example embodiment.

FIG. 9B is a schematic diagram for illustrating an operation of the coordinate system determination unit according to the second example embodiment.

FIG. 9C is a block diagram illustrating another example of the functional configuration of the coordinate system determination unit according to the second example embodiment.

FIG. 9D is a schematic diagram for illustrating an operation of the coordinate system determination unit according to the second example embodiment.

FIG. 10A is a schematic diagram for illustrating an operation of a normalized image generation unit according to the second example embodiment.

FIG. 10B is a schematic diagram for illustrating an operation of a fixed region determination unit according to the second example embodiment.

FIG. 11A is a block diagram illustrating another example of the functional configuration of the dot identifier extraction unit according to the second example embodiment.

FIG. 11B is a flowchart illustrating a procedure of the other example of the dot identifier extraction processing according to the second example embodiment.

FIG. 12A is a block diagram illustrating yet another example of the functional configuration of the dot identifier extraction unit according to the second example embodiment.

FIG. 12B is a flowchart illustrating a procedure of yet another example of the dot identifier extraction processing according to the second example embodiment.

FIG. 13 is a block diagram illustrating a hardware configuration of the entry-exit management server as the information processing device according to the second example embodiment.

FIG. 14 is a flowchart illustrating a processing procedure of the entry-exit management server as the information processing device according to the second example embodiment.

FIG. 15 is a block diagram illustrating a hardware configuration of the registration device according to the second example embodiment.

FIG. 16 is a flowchart illustrating a processing procedure of the registration device according to the second example embodiment.

FIG. 17 is a block diagram illustrating a hardware configuration of the opening-closing device according to the second example embodiment.

FIG. 18A is a flowchart illustrating a processing procedure of the opening-closing device according to the second example embodiment.

FIG. 18B is a flowchart illustrating another processing procedure of the opening-closing device according to the second example embodiment.

FIG. 19 is a diagram illustrating an overview of an entry-exit management system according to a third example embodiment.

FIG. 20 is a sequence diagram illustrating an operation procedure of the entry-exit management system according to the third example embodiment.

FIG. 21 is a block diagram illustrating a functional configuration of a smartphone as a registration device according to the third example embodiment.

FIG. 22 is a block diagram illustrating a hardware configuration of the smartphone as the registration device according to the third example embodiment.

FIG. 23 is a flowchart illustrating a processing procedure of the smartphone as the registration device according to the third example embodiment.

FIG. 24 is a diagram illustrating an overview of an entry-exit management system according to a fourth example embodiment.

FIG. 25 is a diagram illustrating a structure of an entry-exit management database according to the fourth example embodiment.

FIG. 26 is a flowchart illustrating a processing procedure of an entry-exit management server as an information processing device according to the fourth example embodiment.

FIG. 27 is a diagram illustrating an overview of an entry-exit management system according to a fifth example embodiment.

FIG. 28 is a diagram illustrating a structure of an entry-exit management database according to the fifth example embodiment.

FIG. 29A is a flowchart illustrating a processing procedure of an entry-exit management server as an information processing device according to the fifth example embodiment.

FIG. 29B is a flowchart illustrating another processing procedure of the entry-exit management server as the information processing device according to the fifth example embodiment.

FIG. 30 is a diagram illustrating an overview of an entry-exit management system according to a sixth example embodiment.

FIG. 31 is a diagram illustrating a structure of an entry-exit management database according to the sixth example embodiment.

FIG. 32 is a flowchart illustrating a processing procedure of an entry-exit management server as an information processing device according to the sixth example embodiment.

FIG. 33 is a diagram illustrating an overview of an entry-exit management system according to a seventh example embodiment.

FIG. 34 is a diagram illustrating a structure of an entry-exit management database according to the seventh example embodiment.

### EXAMPLE EMBODIMENT

Example embodiments will be exemplarily described in detail below with reference to drawings. However, components described in the following example embodiments are merely exemplifications and are not intended to limit the technical scope of the present example embodiment thereto.

### First Example Embodiment

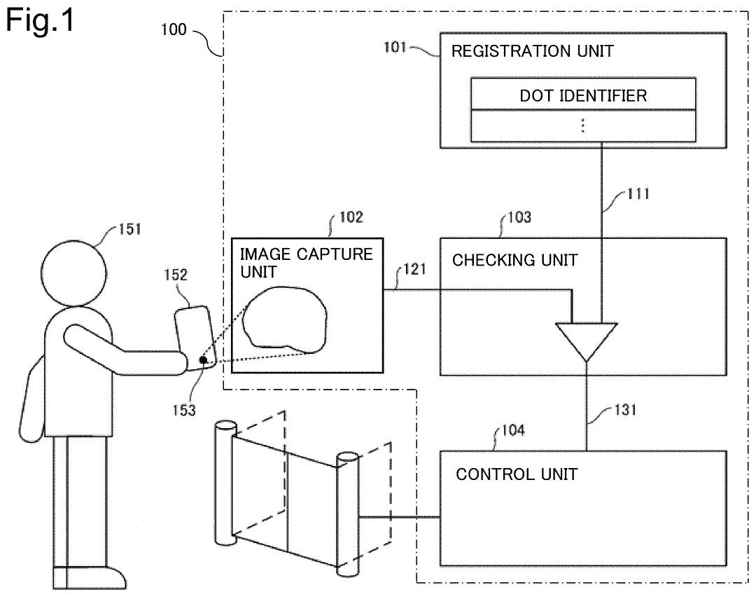

An entry-exit management system 100 as a first example embodiment will be described by use of FIG. 1. The entry-exit management system 100 is a system managing entry-exit of visitors.

As illustrated in FIG. 1, the entry-exit management system 100 includes a registration unit 101, image capture unit 102, a checking unit 103, and a control unit 104. The registration unit 101 registers a dot identifier 111 extracted from a dot 153 described with a writing tool on an object 152 to be an admission pass of a visitor 151. The image capture unit 102 captures an image of the dot 153. The checking unit 103 checks a dot identifier 121 extracted from the dot 153 an image of which is captured by the image capture unit 102 against the dot identifier 111 registered in the registration unit 101. The control unit 104 controls entry-exit of the visitor 151, based on the check result by the checking unit 103.

According to the present example embodiment, entry-exit management is performed by use of a dot identifier extracted from a dot being given to an object and being described with a writing tool, and therefore cost and effort required for the entry-exit management can be reduced.

### Second Example Embodiment

Next, an entry-exit management system according to a second example embodiment will be described. The entry-exit management system according to the present example embodiment manages entry-exit to and from a venue, based on a dot described on a possession of a visitor with a writing tool. For example, the venue includes a building, a business in a building, or a special event site. A case of adding an admission pass function to a possession at venue reception will be described in the present example embodiment. While a “business card” of a visitor as a possession of a visitor will be representatively described as an object on which a dot is described, according to the present example embodiment, the object is not limited to a “business card” as long as a dot can be described on the object with a writing tool. The object is not limited to a possession of a visitor and may be an object carried by the visitor (belonging).

### Entry-Exit Management System

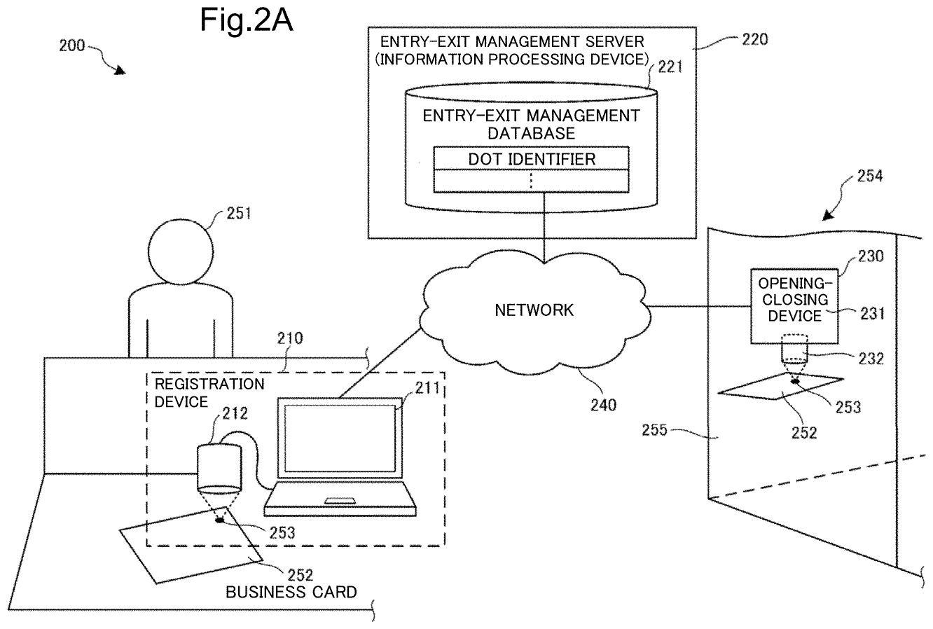

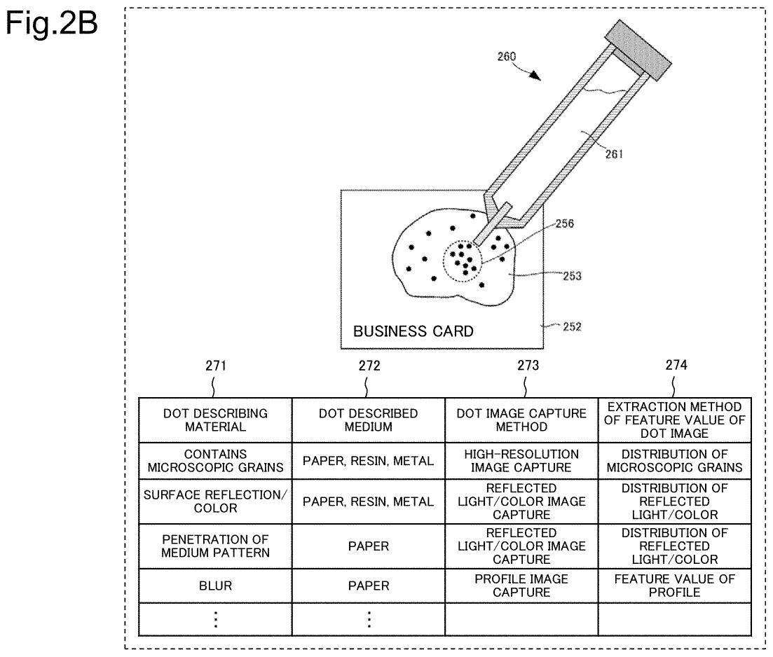

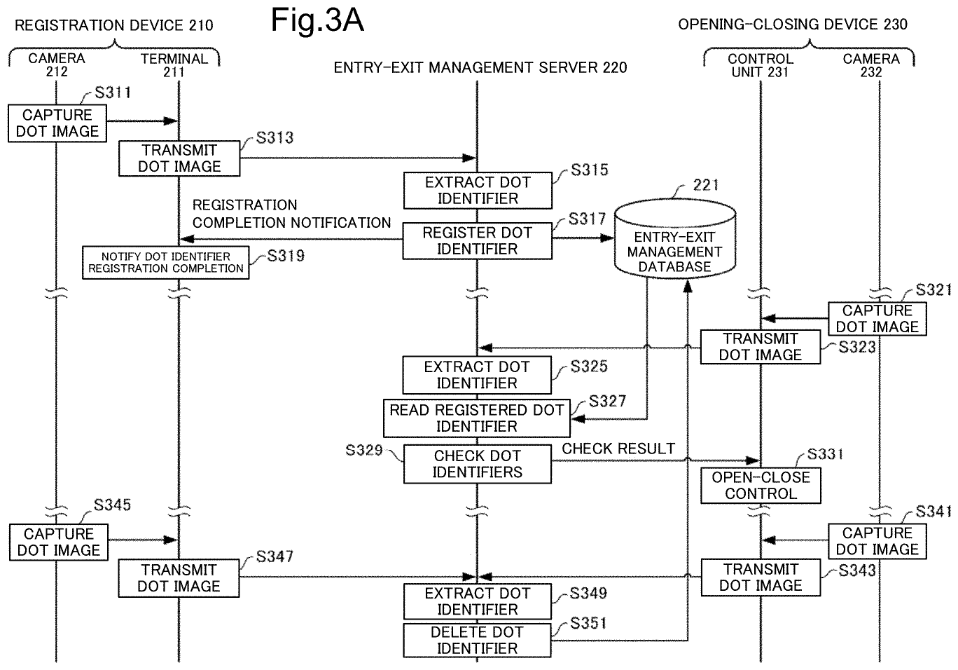

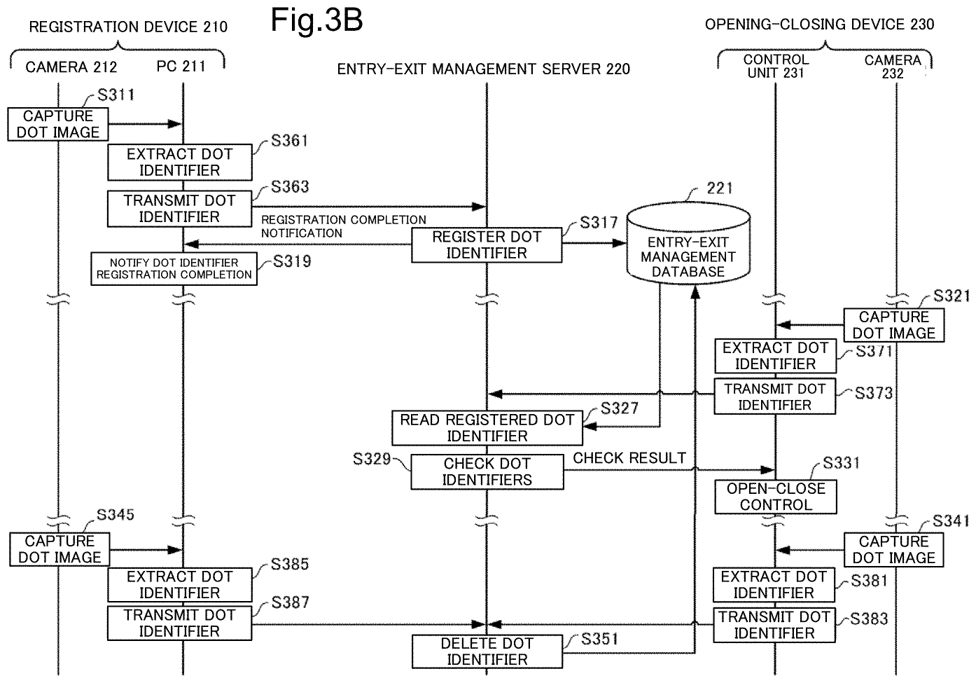

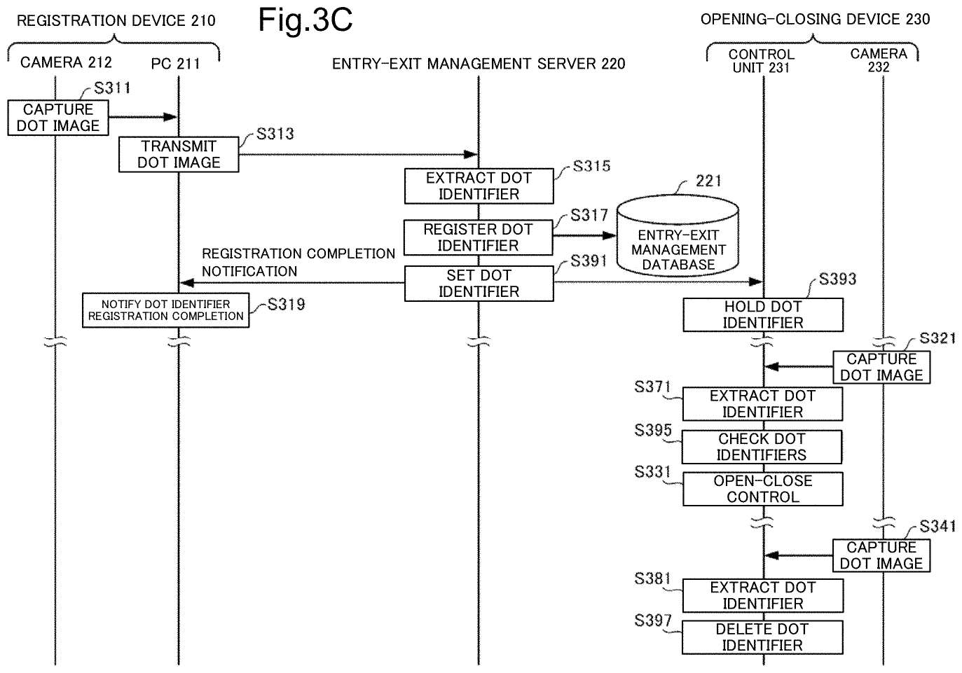

A configuration and an operation of the entry-exit management system according to the present example embodiment will be described with reference to FIG. 2A to FIG. 3C.

### Overview

FIG. 2A is a diagram illustrating an overview of an entry-exit management system 200 according to the present example embodiment.

The entry-exit management system 200 includes a registration device 210, an entry-exit management server 220 as an information processing device, and an opening-closing device 230 that are connected through a network 240. The registration device 210 includes a terminal 211 including an image capture unit 212 or being connectable to the image capture unit 212, and captures an image of a dot 253 described with a writing tool on an object 252 including a business card, for a check of dot identifiers in the entry-exit management server 220. Then, a dot identifier extracted from a dot image in which an image of the dot 253 is captured is registered in an entry-exit management database 221 included in the entry-exit management server 220. The entry-exit management server 220 checks a dot identifier registered in the entry-exit management database 221 against a dot identifier of a dot an image of which is captured by the opening-closing device 230 and notifies the check result to the opening-closing device 230. The opening-closing device 230 includes a control unit 231 including an image capture unit 232 or being connectable to the image capture unit 232 and captures an image of a dot 253 described with a writing tool on an object 252 including a business card, for a check of dot identifiers in the entry-exit management server 220. Then, when a match between the registered dot identifier and the dot identifier of the dot an image of which is captured is notified from the entry-exit management server 220, the opening-closing device 230 opens a door 255 (or a lock) in a facility 254 and approves entry. On the other hand, when a mismatch between the registered dot identifier and the dot identifier of the dot an image of which is captured is notified from the entry-exit management server 220, the opening-closing device 230 closes the door 255 (or the lock) in the facility 254 and disapproves entry. Status of visitors in a venue being an entry-exit management target can be grasped by storing a visitor, based on approval for entry to the venue by the visitor or actual entry from an entrance, and on the other hand, deleting a visitor, based on approval for exit from the venue by the visitor or actual exit from the entrance.

### Dot Identifier Extraction Method

FIG. 2B is a diagram illustrating a generation method of a dot allowing extraction of a dot feature value to be a dot identifier according to the present example embodiment.

The upper diagram in FIG. 2B is a schematic diagram of a state in which a dot is described on an object (possession) with a writing tool, according to the present example embodiment. Note that a dimensional relation between elements is not accurate. It is assumed that the object (possession) is an object 252 including a business card. A dot 253 containing microscopic grains 256 is described with a writing tool 260 on any position on the surface of the object 252 including the business card. The writing tool 260 is filled with ink 261 containing the microscopic grains 256. A dot entry medium is not limited to ink. The medium may be solid pencil lead, India ink, or the like.

The dot 253 described on any position on the surface of the object 252 including the business card contains the microscopic grains 256 in random positions. Fine particles such as metal powder or glass powder, or taggants may be used as the microscopic grains 256. It is desirable that the microscopic grains 256 be grains having a reflection characteristic different from a material constituting the dot 253 (excluding the microscopic grains 256). Further, it is desirable that the microscopic grains 256 be unevenly contained in the dot 253. In other words, it is desirable that a distribution of the microscopic grain 256 in the dot 253 be uneven. Further, a plane shape of the dot 253 is an indeterminate shape. The plane shape of the dot 253 refers to a shape of the dot 253 viewed from the top. For example, such a dot 253 can be formed by dropping only one drop of printing ink, paint, or the like in which the microscopic grains 256 are mixed on a surface of an object by use of the writing tool 260 such as a pen, and then solidifying the drop. However, without being limited to such a method, the forming method of the dot 253 may use any other method such as applying printing ink, paint, or the like in which the microscopic grain 256 is mixed, with a brush or the like.

The lower diagram in FIG. 2B is a diagram illustrating examples of a method describing a dot allowing extraction of a dot identifier on an object (possession) with a writing tool and an extraction method of a dot identifier, according to the present example embodiment. The describing method of a dot allowing extraction of a dot identifier is not limited to FIG. 2B.

Dot describing materials 271 include a material containing microscopic grains, a material having characteristic surface reflection or color pattern, a material through which a pattern of a medium (paper) penetrates, and a material on which a blur on a medium (paper) appears. Each restriction on a dot described medium 272, differences between dot image capture methods 273, and each extraction method 274 of a feature value of a dot image as a dot identifier are as illustrated in the diagram. In the present example embodiment, a material containing microscopic grains will be hereinafter used as a material allowing description of a dot allowing extraction of a dot identifier on a wide range of media, allowing an image capture unit to be portable and to provide a stable captured image, and readily allowing extraction of an identifiable dot identifier. However, the dot material, the dot describing method, the dot image capture method, and the dot identifier extraction method are not limited to the above, and may be as illustrated in FIG. 2B or may be different from the above.

### Operational Sequence

FIG. 3A is a sequence diagram illustrating an operation procedure of the entry-exit management system 200 according to the present example embodiment. FIG. 3A is an operational sequence of the entry-exit management system 200 in which the entry-exit management server 220 extracts a dot identifier. It is assumed that a visitor has already presented his/her business card to a receptionist, and a dot is described on the business card with a writing tool.

A registration operation of a dot identifier will be described. In Step S311, the image capture unit (camera) 212 in the registration device 210 captures an image of a dot image on a business card. In Step S313, the terminal 211 in the registration device 210 transmits the dot image captured from the business card by the image capture unit (camera) 212 to the entry-exit management server 220. In Step S315, the entry-exit management server 220 extracts a dot identifier from the dot image acquired from the registration device 210. Then, in Step S317, the entry-exit management server 220 registers the extracted dot identifier in the entry-exit management database 221. Further, in Step S317, the entry-exit management server 220 transmits completion of dot identifier registration to the registration device 210. In Step S319, the terminal 211 in the registration device 210 notifies the completion of the registration of the dot identifier.

An open-close control operation at a visit will be described. In Step S321, the image capture unit (camera) 232 in the opening-closing device 230 captures an image of a dot image on a business card. In Step S323, the control unit 231 in the opening-closing device 230 transmits the dot image captured from the business card by the image capture unit (camera) 232 to the entry-exit management server 220. In Step S325, the entry-exit management server 220 extracts a dot identifier from the dot image acquired from the opening-closing device 230. Then, in Step S327, the entry-exit management server 220 reads dot identifiers already registered in the entry-exit management database 221. In Step S329, the entry-exit management server 220 checks whether or not the extracted dot identifier is included in the registered dot identifiers. Then, the entry-exit management server 220 notifies the check result to the control unit 231 in the opening-closing device 230. In Step S331, the control unit 231 in the opening-closing device 230 performs open-close control. Specifically, the control unit 231 approves entry of a visitor when the extracted dot identifier is included in the registered dot identifiers and disapproves entry of the visitor when the extracted dot identifier is not included in the registered dot identifiers.

A dot identifier deletion operation will be described. In Step S341, the image capture unit (camera) 232 in the opening-closing device 230 captures an image of a dot image on a business card. In Step S343, the control unit 231 in the opening-closing device 230 transmits the dot image captured from the business card by the image capture unit (camera) 232 to the entry-exit management server 220. Alternatively, in Step S345, the image capture unit (camera) 212 in the registration device 210 captures an image of a dot image on a business card. In Step S347, the terminal 211 in the registration device 210 transmits the dot image captured from the business card by the image capture unit (camera) 212 to the entry-exit management server 220. In Step S349, the entry-exit management server 220 extracts a dot identifier from the dot image acquired from the opening-closing device 230 or the registration device 210. Then, in Step S351, when a matching dot identifier is registered in the entry-exit management database 221, the entry-exit management server 220 deletes the dot identifier. The deletion operation is not mandatory, and entry status of a visitor is changed from approved to disapproved by deleting a dot identifier from the entry-exit management database 221 at various other timings.

FIG. 3B is a sequence diagram illustrating another operation procedure of the entry-exit management system 200 according to the present example embodiment. FIG. 3B is an operational sequence of the entry-exit management system 200 in which each of the registration device 210 and the opening-closing device 230 extracts a dot identifier. It is assumed that a visitor has already presented his/her business card to a receptionist, and a dot is described on the business card with a writing tool. Further, in FIG. 3B, a step similar to that in FIG. 3A is given the same step number, and redundant description thereof is omitted.

A registration operation of a dot identifier will be described. In Step S361, the terminal 211 in the registration device 210 extracts a dot identifier from a dot image captured from a business card by the image capture unit (camera) 212. Then, in Step S363, the terminal 211 in the registration device 210 transmits the extracted dot identifier to the entry-exit management server 220.

An open-close control operation at a visit will be described. In Step S371, the control unit 231 in the opening-closing device 230 extracts a dot identifier from a dot image captured from a business card by the image capture unit (camera) 232. Then, in Step S373, the control unit 231 in the opening-closing device 230 transmits the extracted dot identifier to the entry-exit management server 220.

A dot identifier deletion operation will be described. In Step S381, the control unit 231 in the opening-closing device 230 extracts a dot identifier from a dot image captured from a business card by the image capture unit (camera) 232. Then, in Step S383, the control unit 231 in the opening-closing device 230 transmits the extracted dot identifier to the entry-exit management server 220. Alternatively, in Step S385, the image capture unit (camera) 212 in the registration device 210 extracts a dot identifier from a dot image captured from a business card by the image capture unit (camera) 212. Then, in Step S387, the image capture unit (camera) 212 in the registration device 210 transmits the extracted dot identifier to the entry-exit management server 220. The deletion operation is not mandatory, and entry status of a visitor is changed from approved to disapproved by deleting a dot identifier from the entry-exit management database 221 at various other timings.

FIG. 3C is a sequence diagram illustrating yet another operation procedure of the entry-exit management system 200 according to the present example embodiment. FIG. 3C is an operational sequence of the entry-exit management system 200 in which the opening-closing device 230 checks dot identifiers in the own device. It is assumed that a visitor has already presented his/her business card to a receptionist, and a dot is described on the business card with a writing tool. Further, in FIG. 3C, a step similar to that in FIG. 3A and FIG. 3B is given the same step number, and redundant description thereof is omitted.

A registration operation of a dot identifier will be described. In Step S391, the entry-exit management server 220 sets an extracted dot identifier to the opening-closing device 230. Further, in Step S391, the entry-exit management server 220 transmits completion of dot identifier registration to the registration device 210. In Step S393, the control unit 231 in the opening-closing device 230 holds the set dot identifier.

An open-close control operation at a visit will be described. In Step S395, the control unit 231 in the opening-closing device 230 checks whether or not the extracted dot identifier is included in held dot identifiers. Then, in Step S331, the control unit 231 in the opening-closing device 230 performs the open-close control.

A dot identifier deletion operation will be described. In Step S397, when a dot identifier matching the extracted dot identifier is held, the control unit 231 in the opening-closing device 230 deletes the dot identifier. The deletion operation is not mandatory, and entry status of a visitor is changed from approved to disapproved by deleting a dot identifier from the control unit 231 in the opening-closing device 230 at various other timings.

In the operational sequences in FIG. 3A to FIG. 3C, it is assumed that an entry-exit location (venue) and a date and time of entry-exit are previously set. When an entry-exit location is set at registration, input and registration of the entry-exit location are performed. Further, when management based on a visitor identifier (ID) is performed, input and registration of the visitor identifier (ID) are performed. Such input of a visitor identifier (ID) may be registered in the entry-exit management database 221 by operation input by an operator or by character recognition from a captured image of a business card. Furthermore, a described content of a business card may be registered in the entry-exit management database 221 in association with a dot identifier.

### Entry-Exit Management Server

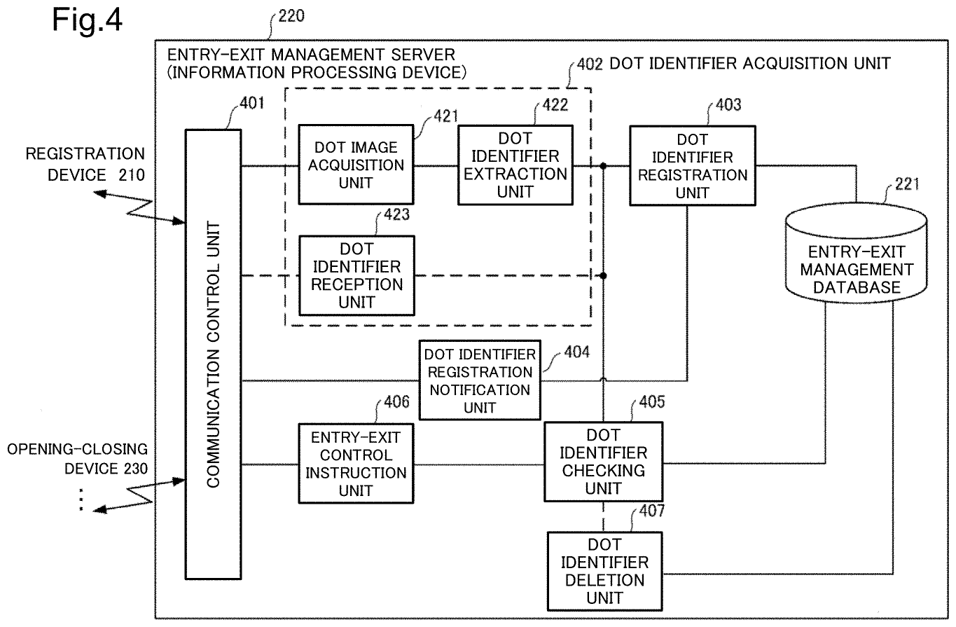

FIG. 4 is a block diagram illustrating a functional configuration of the entry-exit management server 220 as the information processing device according to the present example embodiment.

The entry-exit management server 220 includes a communication control unit 401, a dot identifier acquisition unit 402, a dot identifier registration unit 403, the entry-exit management database 221, a dot identifier registration notification unit 404, a dot identifier checking unit 405, an entry-exit control instruction unit 406, and a dot identifier deletion unit 407.

The communication control unit 401 controls communication with the registration device 210 and the opening-closing device 230 through the network 240. The dot identifier acquisition unit 402 includes a dot image acquisition unit 421, a dot identifier extraction unit 422, and a dot identifier reception unit 423. Then, when a dot image is transmitted from the registration device 210 or the opening-closing device 230, the dot image acquisition unit 421 receives the dot image, and the dot identifier extraction unit 422 extracts a dot identifier from the dot image. On the other hand, when a dot identifier is transmitted from the registration device 210 or the opening-closing device 230, the dot identifier reception unit 423 receives the dot identifier. The dot identifier acquisition unit 402 may include only either of the dot image acquisition unit 421 and the dot identifier extraction unit 422, and the dot identifier reception unit 423. The dot identifier registration unit 403 registers a dot identifier extracted by the dot identifier extraction unit 422 or a dot identifier received by the dot identifier reception unit 423 in the entry-exit management database 221. The dot identifier registration notification unit 404 notifies completion of registration of a dot identifier in the entry-exit management database 221 to the registration device 210.

The dot identifier checking unit 405 checks whether or not a dot identifier acquired from the opening-closing device 230 by the dot identifier acquisition unit 402 matches a dot identifier registered in the entry-exit management database 221. As for a match between dot identifiers, the difference derived from the check result being equal to or less than a predetermined threshold value may be determined as a match. The entry-exit control instruction unit 406 instructs the opening-closing device 230 to perform entry-exit control, based on a check result by the dot identifier checking unit 405. The optional dot identifier deletion unit 407 deletes a dot identifier being registered in the entry-exit management database 221 and being the same as a dot identifier from the registration device 210 or the opening-closing device 230.

Although not illustrated in FIG. 4, when management based on a visitor identifier (ID) is performed, the entry-exit management server 220 may perform character recognition on a captured image of a business card and register a visitor identifier (ID) in the entry-exit management database 221 when registration processing is performed, and the visitor identifier (ID) may be checked when open-close control is performed. Further, a visitor storage unit for performing processing of storing a visitor, based on entry, and deleting a visitor, based on exit, may be provided in the entry-exit management database 221 or may be separately provided.

### Entry-Exit Management Database

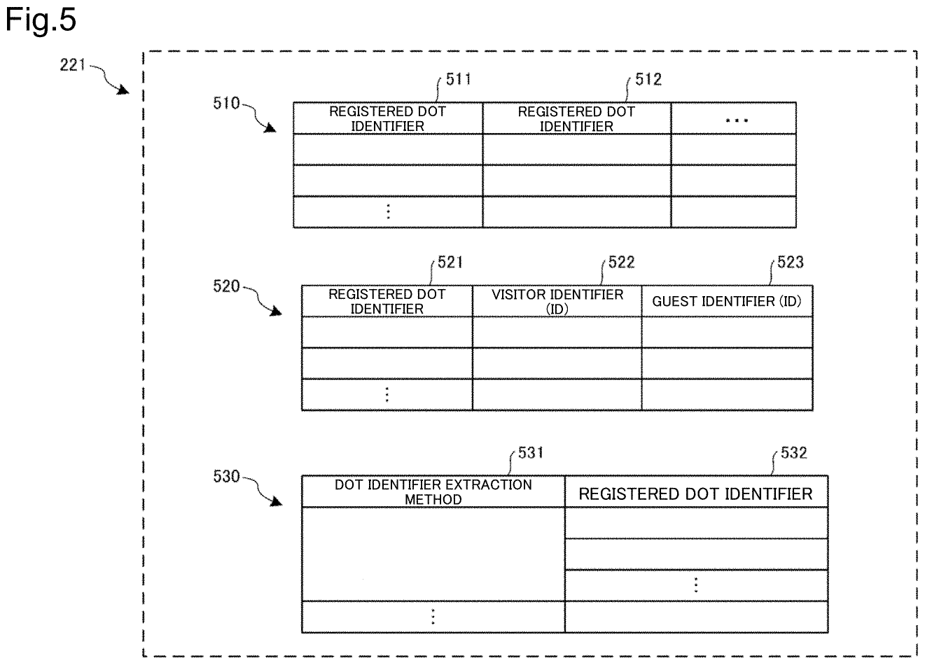

FIG. 5 is a diagram illustrating a structure of the entry-exit management database 221 according to the present example embodiment. The entry-exit management database 221 is used for entry-exit management by registration of a dot identifier of a visitor.

A configuration 510, a configuration 520, a configuration 530, and the like are registered in the entry-exit management database 221. The configuration 510 stores a registered dot identifier 511. A plurality of dot identifiers including a registered dot identifier 512 may be registered. In this case, for example, a plurality of dots are described on an object 252 including a business card. Then, a dot identifier of one dot may control entry to a building, and a dot identifier of another dot may control entry to a room in the building. Alternatively, more secure control of permitting entry-exit when dot identifiers of a plurality of dots match may be provided.

The configuration 520 stores a registered dot identifier 521, a visitor identifier (ID) 522, and a guest identifier (ID) 523 in association with one another. The configuration 530 stores different dot identifier extraction methods and dot identifiers in association with each other.

Use of the configuration 510 provides the simplest visitor authentication approving entry-exit of a visitor with an admission pass according to the present example embodiment. Use of the configuration 520 allows confirmation of a visitor or a guest at entry-exit, visit notification processing for a visitor or a guest, and the like. Furthermore, confirmation of an exiting person and a non-exiting person is also provided.

The structure of the entry-exit management database 221 is not limited to FIG. 5, and a dot identifier may be registered in association with other additional information, or the above may be registered in combination depending on a use. Further, information included in the entry-exit management database 221 is not limited to FIG. 5. Other information useful for enhancing reliability of entry-exit management, providing more efficient entry-exit management, or providing other effects such as an advertisement effect may be added.

### Functional Configuration of Registration Device

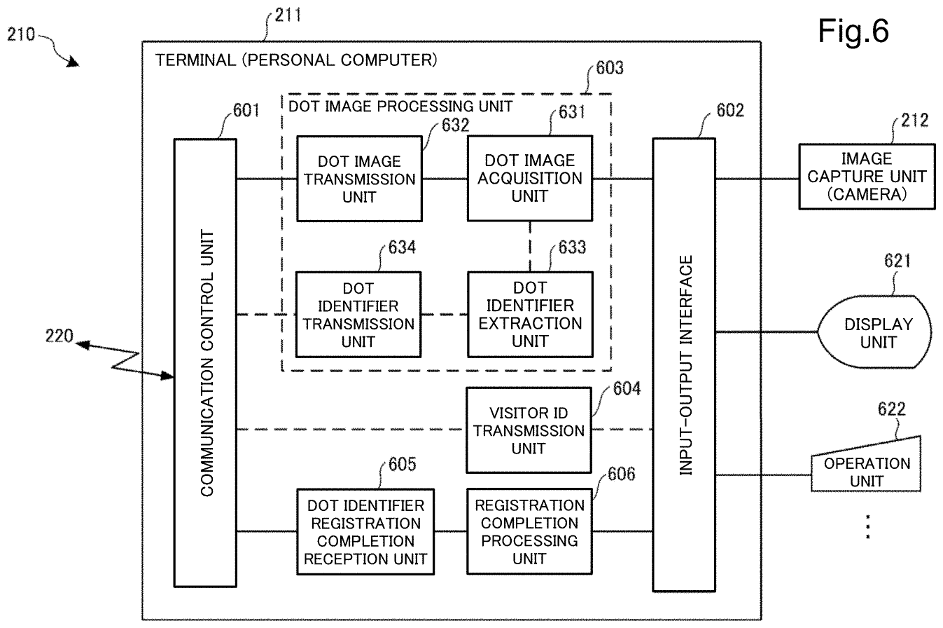

FIG. 6 is a block diagram illustrating a functional configuration of the registration device 210 according to the present example embodiment.

The registration device 210 includes the terminal 211, the image capture unit (camera) 212, a display unit 621, and an operation unit 622. The terminal 211 includes a communication control unit 601, an input-output interface 602, a dot image processing unit 603, an optional visitor identifier (ID) transmission unit 604, a dot identifier registration completion reception unit 605, and a registration completion processing unit 606. The image capture unit (camera) 212, the display unit 621, and the operation unit 622 are connected to the input-output interface 602 in the terminal 211.

The communication control unit 601 controls communication with the entry-exit management server 220 through the network 240. The input-output interface 602 interfaces with input-output equipment. The dot image processing unit 603 includes a dot image acquisition unit 631, a dot image transmission unit 632, a dot identifier extraction unit 633, and a dot identifier transmission unit 634. When a dot image is transmitted to the entry-exit management server 220, a dot image acquired by the dot image acquisition unit 631 is transmitted from the dot image transmission unit 632. On the other hand, when a dot identifier is transmitted to the entry-exit management server 220, a dot identifier is extracted by the dot identifier extraction unit 633 from a dot image acquired by the dot image acquisition unit 631 and is transmitted from the dot identifier transmission unit 634. For example, when authentication based on a visitor identifier (ID) is also performed, the optional visitor identifier (ID) transmission unit 604 transmits a visitor identifier (ID) input from the operation unit 622. The dot identifier registration completion reception unit 605 receives, from the entry-exit management server 220, a registration completion notification of a dot identifier in the entry-exit management database 221. The registration completion processing unit 606 performs registration completion processing such as reporting registration completion to the display unit 621.

Although not illustrated in FIG. 6, when management based on a visitor identifier (ID) is performed, the registration device 210 may perform character recognition on a captured image of a business card, transmit a visitor identifier (ID) to the entry-exit management server 220, and register the visitor identifier (ID) in the entry-exit management database 221.

### Functional Configuration of Opening-Closing Device

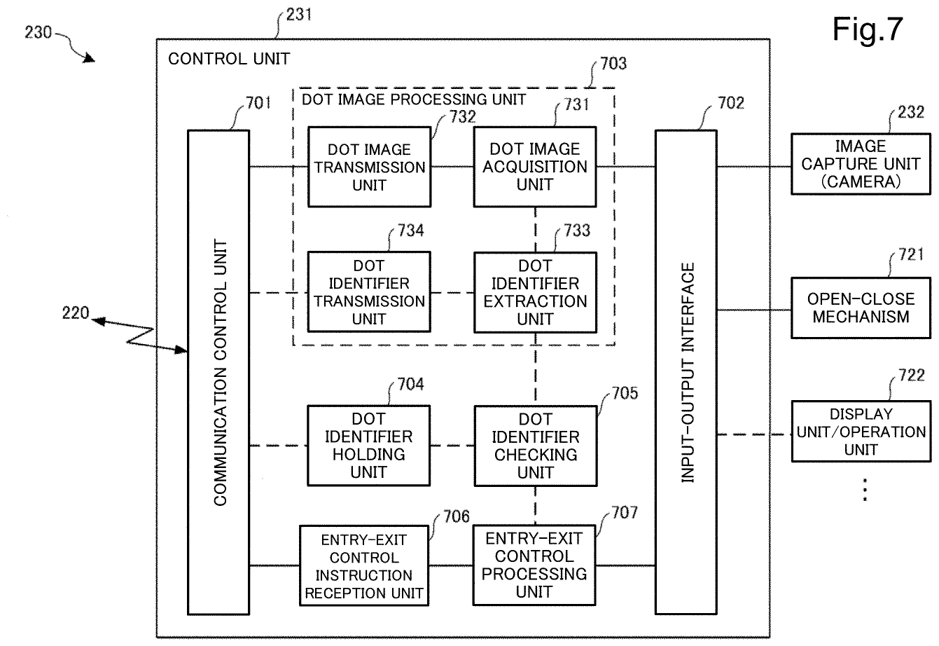

FIG. 7 is a block diagram illustrating a functional configuration of the opening-closing device 230 according to the present example embodiment.

The opening-closing device 230 includes the control unit 231, the image capture unit (camera) 232, an open-close mechanism 721, and a display unit/operation unit 722 as required. The control unit 231 includes a communication control unit 701, an input-output interface 702, a dot image processing unit 703, an optional dot identifier holding unit 704, an optional dot identifier checking unit 705, an entry-exit control instruction reception unit 706, and an entry-exit control processing unit 707. The image capture unit (camera) 232, the open-close mechanism 721, and the display unit/operation unit 722 are connected to the input-output interface 702 in the control unit 231.

The communication control unit 701 controls communication with the entry-exit management server 220 through the network 240. The input-output interface 702 interfaces with input-output equipment. The dot image processing unit 703 includes a dot image acquisition unit 731, a dot image transmission unit 732, a dot identifier extraction unit 733, and a dot identifier transmission unit 734. When a dot image is transmitted to the entry-exit management server 220, a dot image acquired by the dot image acquisition unit 731 is transmitted from the dot image transmission unit 732. On the other hand, when a dot identifier is transmitted to the entry-exit management server 220, a dot identifier is extracted by the dot identifier extraction unit 733 from a dot image acquired by the dot image acquisition unit 731 and is transmitted from the dot identifier transmission unit 734. When a check of dot identifiers is performed by the control unit 231, the optional dot identifier holding unit 704 holds a dot identifier transmitted from the entry-exit management server 220. The optional dot identifier checking unit 705 checks the dot identifier extracted by the dot identifier extraction unit 733 against the dot identifier held in the dot identifier holding unit 704. The entry-exit control instruction reception unit 706 receives an instruction from the entry-exit management server 220 for entry-exit control based on the check result of the dot identifiers. The entry-exit control processing unit 707 performs entry-exit control processing on the open-close mechanism 721 in response to an instruction for entry-exit control received by the entry-exit control instruction reception unit 706 or an instruction for entry-exit control based on a check result by the dot identifier checking unit 705.

Although not illustrated in FIG. 7, when management based on a visitor identifier (ID) is performed, the opening-closing device 230 may perform character recognition on a captured image of a business card and transmit a visitor identifier (ID) to the entry-exit management server 220; and the visitor identifier (ID) may be checked against a visitor identifier (ID) registered in the entry-exit management database 221.

### Example of Dot Identifier Extraction Unit

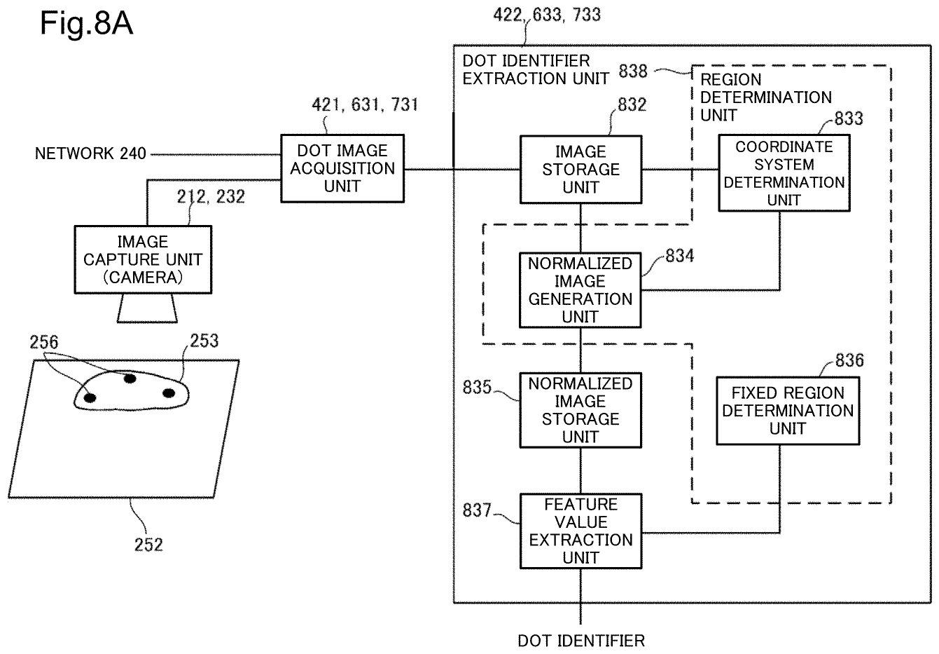

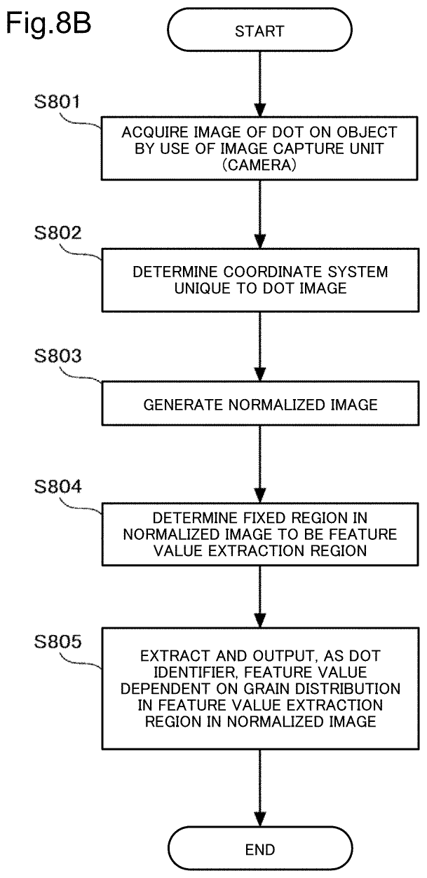

FIG. 8A is a block diagram illustrating an example of a functional configuration of the dot identifier extraction units 422, 633, and 733 according to the present example embodiment. FIG. 8A illustrates part of the entry-exit management server 220, the registration device 210, and the opening-closing device 230 that include the dot identifier extraction units 422, 633, and 733. Referring to FIG. 8A, the dot identifier extraction units 422, 633, and 733 according to the present example embodiment have a function of extracting a dot identifier of an object 252.

In FIG. 8A, an object 252 as an object, a dot 253 being formed on the surface of the object 252 and being described with a writing tool, and microscopic grains 256 contained in the dot 253 are the same as the object 252, the dot 253, and the microscopic grains 256 described with reference to FIG. 2B.

The image capture units (cameras) 212 and 232 have a function of optically acquiring an image of the dot 253 on the object 252, that is, an image capture function. For example, a camera using a charge coupled devices (CCD) image sensor or a complementary metal oxide (CMOS) image sensor may be used as the image capture units (cameras) 212 and 232.

The dot image acquisition units 421, 631, and 731 acquire dot images through the network 240 in the case of the entry-exit management server 220, and from the image capture units (cameras) 212 and 232 in the case of the registration device 210 and the opening-closing device 230. The dot image acquisition units 631 and 731 have a function of acquiring an image of the dot 253 on the object 252 by use of the image capture units (cameras) 212 and 232 and saving the image in the image storage unit 832. The dot image acquisition units 421, 631, and 731 acquire images each of which contains a plane shape of the dot 253 on the object 252. Further, the dot image acquisition units 421, 631, and 731 acquire images with quality allowing extraction of a feature value dependent on a distribution of the grains 256 existing in the dot 253.

The dot identifier extraction units 422, 633, and 733 have a function of extracting a dot identifier from a dot image. Each of the dot identifier extraction units 422, 633, and 733 includes, as main function units, an image storage unit 832, a coordinate system determination unit 833, a normalized image generation unit 834, a normalized image storage unit 835, a fixed region determination unit 836, and a feature value extraction unit 837.

For example, each of the dot identifier extraction units 422, 633, and 733 may be provided by an information processing unit and a program, the information processing unit including an arithmetic processing unit, such as one or more microprocessors, and a storage unit used as the image storage unit 832, the normalized image storage unit 835, and the like, such as a memory and a hard disk. The program is read into the memory from an external computer-readable recording medium at startup of the information processing unit or the like, and provides function configuration units, such as the coordinate system determination unit 833, the normalized image generation unit 834, the fixed region determination unit 836, and the feature value extraction unit 837, on the arithmetic processing unit by controlling an operation of the arithmetic processing unit.

The coordinate system determination unit 833 has a function of determining a coordinate system unique to an image of the dot 253 from an entire image of the dot 253 stored in the image storage unit 832. The coordinate system unique to an image of the dot 253 is defined by three parameters being a position of the origin, a direction of an axis, and a scale. The coordinate system unique to an image of the dot 253 is determined from the entire image of the dot 253 and therefore is dependent on a plane shape of the dot 253.

The normalized image generation unit 834 has a function of normalizing an image of the dot 253 stored in the image storage unit 832 to a normalized coordinate system and saving the normalized image into the normalized image storage unit 835. The normalized coordinate system is defined by three parameters being a position of the origin, a direction of an axis, and a scale.

The fixed region determination unit 836 has a function of determining a predetermined region in a normalized image of the dot 253 stored in the normalized image storage unit 835 to be a feature value extraction region. The predetermined region may have any shape, any size, and any number of regions as long as the region is a fixed region. As described above, the coordinate system unique to an image of the dot 253 is dependent on the plane shape of the dot 253, and therefore the normalized image and the feature value extraction region being a fixed region therein are regions dependent on the plane shape of the dot 253.

The coordinate system determination unit 833, the normalized image generation unit 834, and the fixed region determination unit 836 constitute a region determination unit 838 determining a region dependent on a plane shape of a layer from an image of the dot 253.

The feature value extraction unit 837 has a function of extracting and outputting, as a dot identifier, a feature value dependent on a distribution of the grains 256 in the aforementioned feature value extraction region in the normalized image of the dot 253 stored in the normalized image storage unit 835.

### Dot Identifier Extraction Processing

FIG. 8B is a flowchart illustrating a procedure of an example of dot identifier extraction processing according to the present example embodiment. Operations of the dot identifier extraction units 422, 633, and 733 will be described below with reference to FIG. 8A and FIG. 8B. Since configurations and operations of the dot identifier extraction units 422, 633, and 733 are similar, the dot identifier extraction unit 633 will be representatively described below.

The dot image acquisition unit 631 acquires an image of the dot 253 on the object 252 by use of the image capture units (cameras) 212 and 232, and the dot identifier extraction unit 633 saves the dot image into the image storage unit 832 (Step S801).

Next, the coordinate system determination unit 833 in the dot identifier extraction unit 633 inputs the image of the dot 253 from the image storage unit 832 and analyzes the image, determines a coordinate system unique to an image of the dot 253, and conveys a position of the origin, a direction of an axis, and a scale of the unique coordinate system to the normalized image generation unit 834 (Step S802).

Next, based on the coordinate system unique to an image of the dot 253 determined by the coordinate system determination unit 833 and a normalized coordinate system, the normalized image generation unit 834 in the dot identifier extraction unit 633 normalizes the image of the dot 253 stored in the image storage unit 832 and saves the normalized image into the normalized image storage unit 835 (Step S803).

Next, the fixed region determination unit 836 in the dot identifier extraction unit 633 determines a predetermined fixed region in the normalized image stored in the normalized image storage unit 835 to be a feature value extraction region and conveys the region to the feature value extraction unit 837 (Step S804).

Next, the feature value extraction unit 837 in the dot identifier extraction unit 633 extracts and outputs, as a dot identifier, a feature value dependent on a distribution of the grains 256 in the aforementioned feature value extraction region in the normalized image of the dot 253 stored in the normalized image storage unit 835 (Step S805).

### Example of Coordinate System Determination Unit

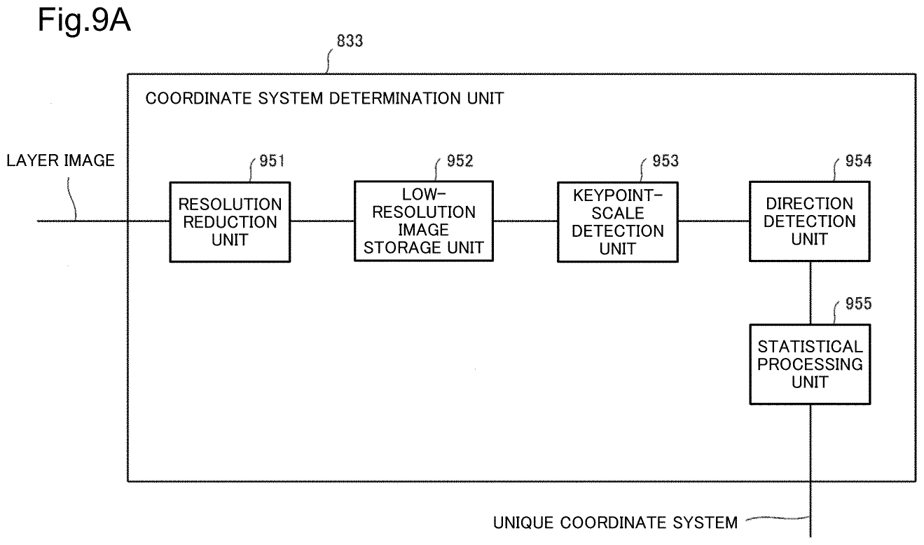

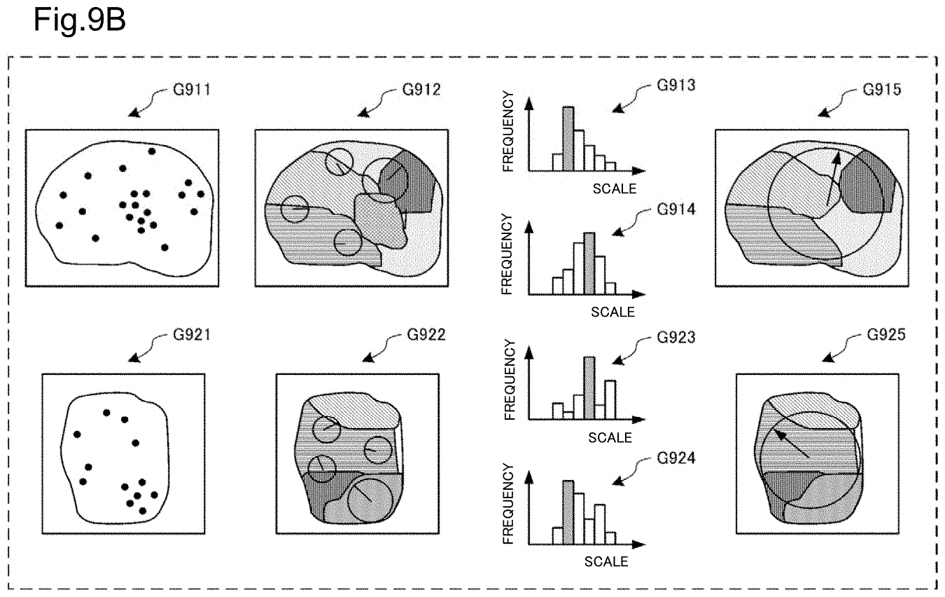

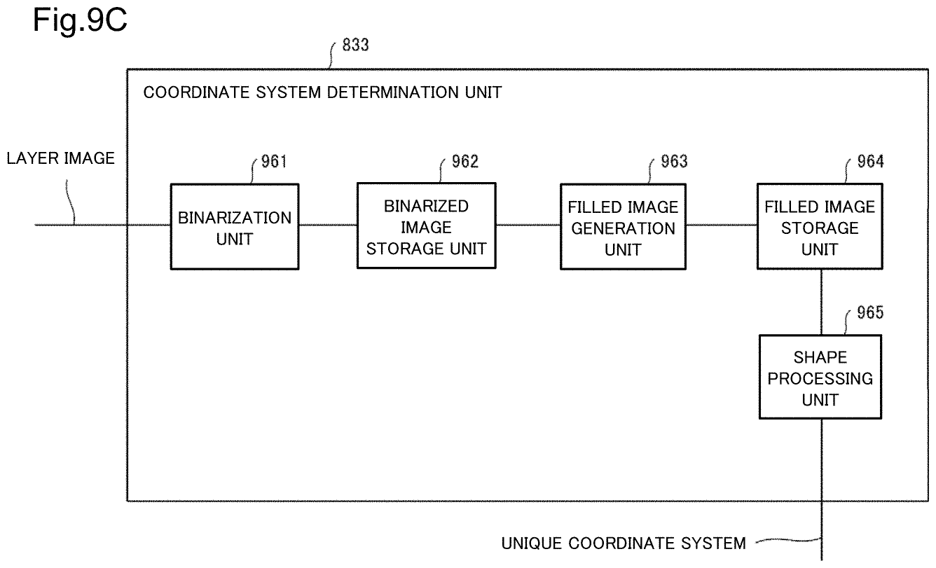

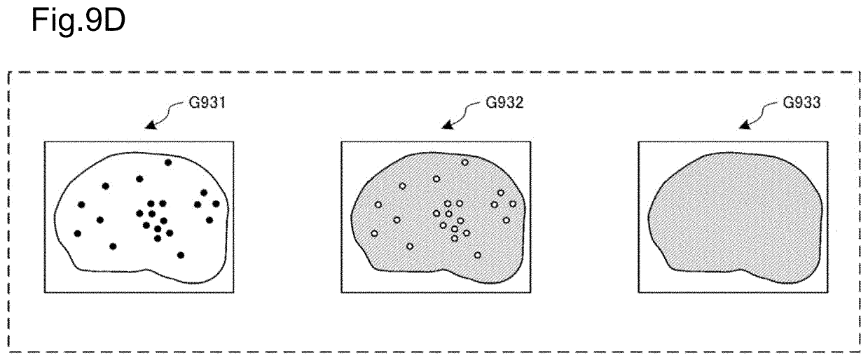

FIG. 9A is a block diagram illustrating an example of a functional configuration of the coordinate system determination unit 833 according to the present example embodiment.

The coordinate system determination unit 833 in this example includes a resolution reduction unit 951, a low-resolution image storage unit 952, a keypoint-scale detection unit 953, a direction detection unit 954, and a statistical processing unit 955.

The resolution reduction unit 951 has a function of reducing resolution of an image of the dot 253 stored in the image storage unit 832, in accordance with a predetermined criterion, and saving the resulting image into the low-resolution image storage unit 952. When the grains 256 are unevenly contained in the dot 253 and a reflection characteristic of the grain 256 is different from other materials of the dot 253, a gradation pattern according to a density of the grain 256 appears when resolution of the image of the dot 253 is reduced. The resolution reduction unit 951 is a function configuration unit for generating a gradation pattern according to the density of the grain 256 from the image of the dot 253.

The keypoint-scale detection unit 953 has a function of detecting a keypoint and a scale from an image having a gradation pattern stored in the low-resolution image storage unit 952. The keypoint means a dot or a region characteristically appearing on an image even when a scale changes, and the detected scale means an optimum scale most insusceptible to a scale change. Detection of a keypoint and a scale by the keypoint-scale detection unit 953 corresponds to detection of a keypoint and a scale performed in a process of generating a scale-invariant feature transform (SIFT) descriptor. While the SIFT is generally not suited for an image in which microscopic grains 256 are interspersed, a keypoint and a scale can be stably extracted from a gradation pattern generated by resolution reduction as described above.

The direction detection unit 954 has a function of, for each keypoint detected by the keypoint-scale detection unit 953, determining a “direction” characterizing the keypoint. Detection of a direction by the direction detection unit 954 corresponds to detection of an orientation performed in the process of generating a SIFT descriptor.

The statistical processing unit 955 has a function of determining the origin, an axis, and a scale of a unique coordinate system, based on a keypoint and a scale detected by the keypoint-scale detection unit 953 and a direction for each keypoint detected by the direction detection unit 954. For example, the statistical processing unit 955 determines the origin of the unique coordinate system, based on a distribution of a plurality of keypoints. Specifically, the statistical processing unit 955 determines the barycenter of the plurality of detected keypoints to be the origin of the unique coordinate system. Further, the statistical processing unit 955 determines the scale and the axis of the unique coordinate system, based on distributions of scales and directions of the plurality of keypoints. Specifically, the statistical processing unit 955 determines the centers of the distributions of scales and directions of the plurality of keypoints to be the scale and the axis of the unique coordinate system, respectively. In other words, the center of the distribution of scales of the plurality of keypoints is determined to be the scale of the unique coordinate system, and the center of the distribution of directions of the plurality of keypoints is determined to be the axis of the unique coordinate system. For example, a mode may be used as the center of a distribution. However, without being limited to a mode, an average or a median may be used.

FIG. 9B is a schematic diagram for illustrating an operation of the coordinate system determination unit 833 according to the present example embodiment. An image G911 in FIG. 9B illustrates an image of the dot 253 stored in the image storage unit 832. From the image G911, the resolution reduction unit 951 generates an image having a gradation pattern dependent on a density of the grains 256 in the dot 253, as illustrated in an image G912. For convenience, different gradations are represented by different hatching types in FIG. 9B. Next, the keypoint-scale detection unit 953 detects a keypoint and a scale from the image G912. A circle described on the image G912 represents a scale, and the center of the circle represents a keypoint. Next, the direction detection unit 954 detects a direction for each keypoint. A segment in a circle described on the image G912 represents a direction.

Next, in order to determine the scale and the axis of the unique coordinate system, based on distributions of scales and directions of the detected keypoints, the statistical processing unit 955 generates a histogram in which the horizontal axis represents a scale and the vertical axis represents a frequency, as illustrated in a histogram G913, and a histogram in which the horizontal axis represents a direction and the vertical axis represents a frequency, as illustrated in a histogram G914. Next, the statistical processing unit 955 determines a scale giving the mode from the histogram G913 and determines the scale to be the scale of the unique coordinate system. Further, the statistical processing unit 955 determines a direction giving the mode from the histogram G914 and determines the direction to be the direction of the axis of the unique coordinate system. Furthermore, the statistical processing unit 955 determines the barycenter of the detected keypoints and determines the barycenter to be the origin of the unique coordinate system. In FIG. 9B, a circle described in an image G915 represents the scale of the unique coordinate system, the center of the circle represents the origin of the unique coordinate system, and an arrow in the circle represents the direction of the axis of the unique coordinate system.

FIG. 9B illustrates another image G921 differing in a plane shape of a dot and a distribution of grains in the dot compared with the image G911, a low-resolution image G922 generated from the image G921, detected keypoints and scales, generated histograms G923 and G924, and an image G925 describing a determined unique coordinate system. Thus, a unique coordinate system often becomes different when a plane shape of a layer and a distribution of grains in the layer become different.

### Another Example of Coordinate System Determination Unit

FIG. 9C is a block diagram illustrating another example of the functional configuration of the coordinate system determination unit 833 according to the present example embodiment.

The coordinate system determination unit 833 in this example includes a binarization unit 961, a binarized image storage unit 962, a filled image generation unit 963, a filled image storage unit 964, and a shape processing unit 965.

The binarization unit 961 has a function of binarizing an image of the dot 253 stored in the image storage unit 832 and saving the resulting image into the binarized image storage unit 962. Consequently, a binarized image in which most of pixels in a background region are white pixels (value 0), and white pixels (value 0) and black pixels (value 1) coexist in a dot 253 region according to a distribution of the grains 256.

The filled image generation unit 963 has a function of generating an image (filled image) having the same shape as the plane shape of the dot 253 and being completely filled with black pixels, from a binarized image stored in the binarized image storage unit 962, and saving the image into the filled image storage unit 964. Any method may be used as the method of generating a filled image from a binarized image. For example, the filled image generation unit 963 may generate a filled image by performing a morphological operation on a binarized image stored in the binarized image storage unit 962. Further, denoting a predetermined pixel length as n, the filled image generation unit 963 may generate a filled image from a binarized image by executing n-pixel expansion processing and n-pixel contraction processing. The n-pixel expansion processing means processing of, when a value of a pixel of interest is “1,” performing an operation of setting a value of every pixel existing within an n pixel length from the pixel of interest to “1” with every surface element in the binarized image assumed as a pixel of interest. Further, the n-pixel contraction processing means processing of, when a value of an pixel of interest is “0,” performing an operation of setting a value of every pixel existing within the n pixel length from the pixel of interest to “0” on the binary image after undergoing the n-pixel expansion processing with every surface element in the binarized image assumed as a pixel of interest.

The shape processing unit 965 has a function of determining a unique coordinate system from a feature of a filled image stored in the filled image storage unit 964. For example, the shape processing unit 965 determines the barycenter of the filled image to be the origin of the unique coordinate system. Further, for example, the shape processing unit 965 determines an axis passing the aforementioned barycenter, being parallel to an image plane, and minimizing or maximizing a secondary moment around the axis to be the axis of the unique coordinate system. Furthermore, for example, the shape processing unit 965 determines an area of the aforementioned filled image to be the scale of the unique coordinate system.

FIG. 9D is a schematic diagram for illustrating an operation of the coordinate system determination unit according to the present example embodiment.

In FIG. 9D, an image G931 represents an image of the dot 253 stored in the image storage unit 832. The binarization unit 961 generates a binarized image G932 from the image G931. For convenience, black pixels are represented by hatching, and white pixels are represented by white circles in FIG. 9D. Next, the filled image generation unit 963 generates a filled image G933 filled with black pixels, from the binarized image G932. Next, the shape processing unit 965 extracts the barycenter, the moment, and the area of the filled image G933, and determines the above to be the origin, the axis, and the scale of the unique coordinate system, respectively.

### Normalized Image Generation Unit

The normalized image generation unit 834 assumes the origin of the coordinate system unique to an image of the dot 253 determined by the coordinate system determination unit 833 to be the origin of a normalized coordinate system. Further, the normalized image generation unit 834 rotates the image of the dot 253 around the origin in such a way that the axis of the unique coordinate system matches the axis of the normalized coordinate system. Furthermore, the normalized image generation unit 834 enlarges or reduces the image of the dot 253 in such a way that the scale of the unique coordinate system matches the scale of the normalized coordinate system. In other words, the normalized image generation unit 834 generates a normalized image by performing coordinate transformation having the unique coordinate system as a coordinate system before transformation and the normalized coordinate system as a coordinate system after transformation on the image of the dot 253.

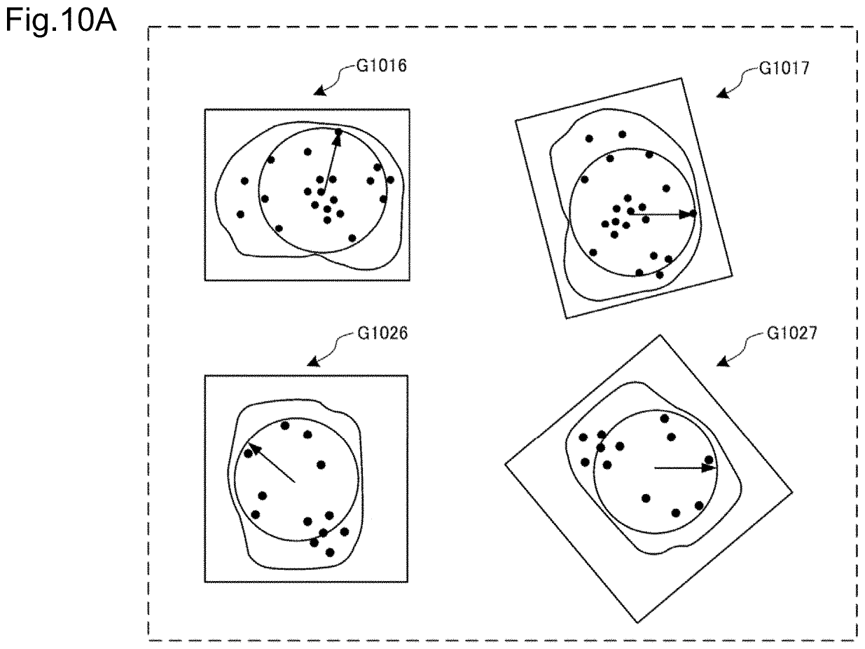

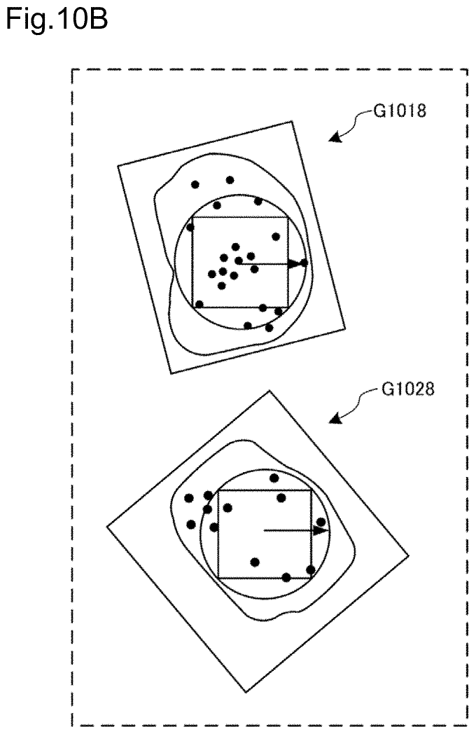

FIG. 10A is a schematic diagram for illustrating an operation of the normalized image generation unit 834 according to the present example embodiment. In FIG. 10A, images G1016 and G1026 are images acquired by drawing a unique coordinate system on each of the images G911 and G921 illustrated in FIG. 9B. Specifically, a circle described in a solid line in each of the images G1016 and G1026 represents the scale of each unique coordinate system, the center of the circle represents the origin of each unique coordinate system, and an arrow in the circle represents the axis of each unique coordinate system.

The normalized image generation unit 834 generates normalized images by rotating the images G1016 and G1026 around each origin, and also by enlarging or reducing the images in such a way that the axis of each unique coordinate system matches the axis of each normalized coordinate system and also the scale of each unique coordinate system matches the scale of each normalized coordinate system. In FIG. 10A, images G1017 and G1027 illustrate thus generated normalized images of the images G1016 and G1026. A circle described in each of the images G1017 and G1027 represents a scale of each normalized coordinate system, and an arrow in the circle represents the axis of each normalized coordinate system.

### Fixed Region Determination Unit

The fixed region determination unit 836 defines a fixed region in a normalized image by use of a normalized coordinate system. For example, the fixed region determination unit 836 determines a square having the origin of the normalized coordinate system as the barycenter, having the scale of the normalized coordinate system as a size of a side, and having two sides parallel to the axis of the normalized coordinate system to be a fixed region. It is a matter of course that the shape of the fixed region is not limited to a square and may be another shape such as a rectangle. Further, the size of a side does not need to match the scale of the normalized coordinate system and may be any fixed value.

FIG. 10B is a schematic diagram for illustrating an operation of the fixed region determination unit 836 according to the present example embodiment. In FIG. 10B, images G1018 and G1028 are examples of images acquired by adding feature value extraction regions to the images G1017 and G1027 illustrated in FIG. 10A. Specifically, a circle described in each of the images G1018 and G1028 represents the scale of each normalized coordinate system, the center of the circle represents the origin of each normalized coordinate system, and an arrow in the circle represents the axis of each normalized coordinate system. Then, a square described in a solid line in each of the images G1018 and G1028 represents a fixed region to be a region from which a feature value is extracted.

### Feature Value Extraction Unit

The feature value extraction unit 837 has a function of extracting and outputting, as a dot identifier, a feature value dependent on the distribution of the grains 256 in the aforementioned feature value extraction region in the normalized image of the dot 253 stored in the normalized image storage unit 835.

For example, the following vectors each of which has a fixed number of dimensions may be considered as feature values extracted by the feature value extraction unit 837.

### Feature Value Example 1

The feature value extraction unit 837 divides the feature value extraction region in the normalized image of the dot 253 into (n×m) blocks by dividing the feature value extraction region into n equal parts in a direction parallel to the axis of the normalized coordinate system and dividing the feature value extraction region into m equal parts in a direction perpendicular to the axis. Next, the feature value extraction unit 837 extracts a luminance of each block. Next, the feature value extraction unit 837 compares a luminance of each block with a threshold value and quantizes a luminance of each block into a binary value by, for example, setting a value 1 to a luminance when the luminance is equal to or greater than the threshold value and setting a value 0 otherwise. Then, the feature value extraction unit 837 outputs a bit string in which the quantized values of the blocks are arranged in a predetermined order as an (n×m)-dimensional feature value constituting a dot identifier.

### Feature Value Example 2

The feature value extraction unit 837 extracts binary robust independent elementary features (BRIEF) having a fixed bit length from the feature value extraction region in the normalized image of the dot 253 and outputs the BRIEF as a feature value having a fixed number of dimensions and constituting an individual identifier.

However, feature values extracted by the feature value extraction unit 837 are not limited to the examples described above. For example, the feature value extraction unit 837 may extract an SIFT feature value from the feature value extraction region in the normalized image of the dot 253 as a dot identifier. In this case, when an SIFT feature value is directly extracted from an image of the feature value extraction region, one of the grains 256 becomes the minimum scale and the direction cannot be determined, and the descriptor becomes unstable. Accordingly, it is desirable to generate an image having a gradation pattern by reducing resolution of the image of the feature value extraction region in accordance with a predetermined criterion and extract an SIFT feature value from the image having the aforementioned gradation pattern. However, it is more preferable to extract the aforementioned feature value having a fixed number of dimensions rather than the SIFT feature value from viewpoints of identifying power and acceleration of identification and checking.

### Another Example of Dot Identifier Extraction Unit

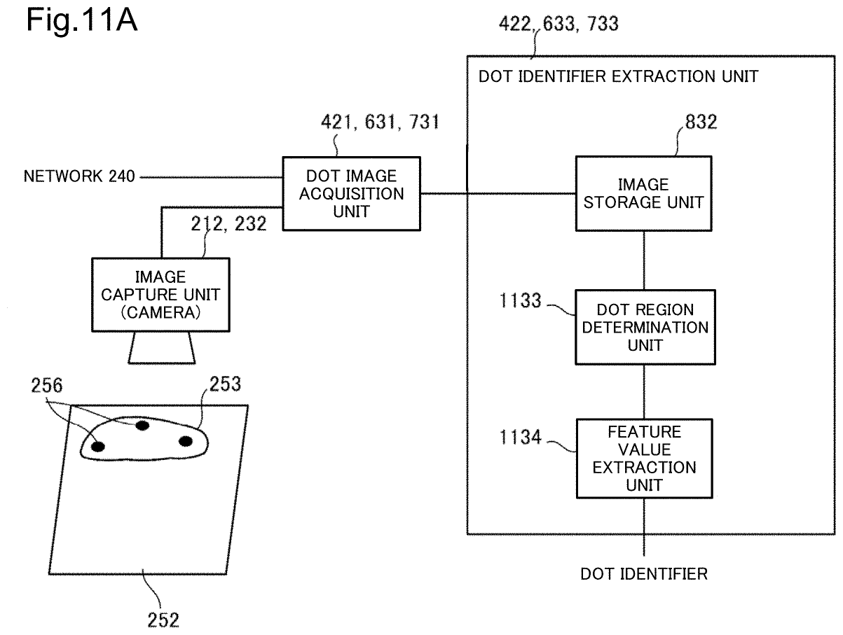

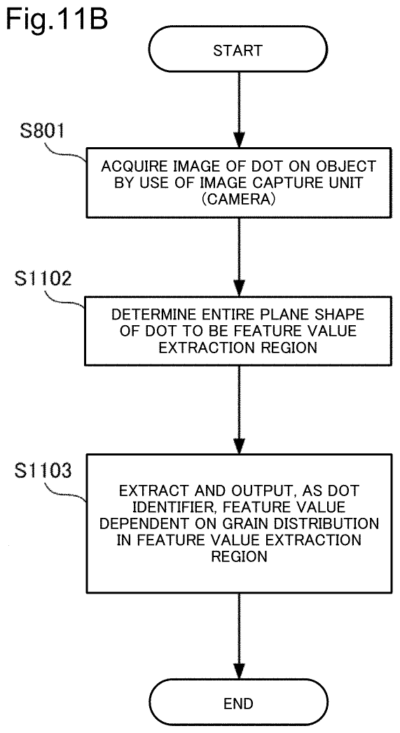

FIG. 11A is a block diagram illustrating another example of the functional configuration of the dot identifier extraction units 422, 633, and 733 according to the present example embodiment. FIG. 11A illustrates part of the entry-exit management server 220, the registration device 210, and the opening-closing device 230 that include the dot identifier extraction units 422, 633, and 733. Referring to FIG. 11A, the dot identifier extraction units 422, 633, and 733 according to the present example embodiment have a function of extracting a dot identifier of an object 252. In FIG. 11A, a component similar to that in FIG. 8A is given the same reference number, and redundant description thereof is omitted.

The dot identifier extraction units 422, 633, and 733 have a function of extracting a dot identifier from a dot image. Each of the dot identifier extraction units 422, 633, and 733 in this example includes a dot region determination unit 1133 and a feature value extraction unit 1134 as main function units. A program for each of the dot identifier extraction units 422, 633, and 733 is read into the memory from an external computer-readable recording medium at startup of the information processing unit or the like, and provides function configuration units, such as the dot region determination unit 1133 and the feature value extraction unit 1134, on the arithmetic processing unit by controlling an operation of the arithmetic processing unit.

The dot region determination unit 1133 has a function of determining an entire plane shape of a dot 253 stored in the image storage unit 832 as a feature value extraction region.

The feature value extraction unit 1134 has a function of extracting a feature value dependent on a distribution of grains 256 from the aforementioned feature value extraction region in an image of the dot 253 stored in the image storage unit 832 and outputting the feature value as a dot identifier.

FIG. 11B is a flowchart illustrating a procedure of another example of the dot identifier extraction processing according to the present example embodiment. Operations of the dot identifier extraction units 422, 633, and 733 will be described below with reference to FIG. 11A and FIG. 11B, with an operation of the dot identifier extraction unit 633 as a representative. In FIG. 11B, a step similar to that in FIG. 8B is given the same step number, and redundant description thereof is omitted.

The dot region determination unit 1133 in the dot identifier extraction unit 633 determines an entire plane shape of the dot 253 as a feature value extraction region (Step S1102). The dot region determination unit 1133 may extract the entire plane shape of the dot 253 by, for example, binarizing the image of the dot 253 and performing a morphological operation on the binarized image.

Next, the feature value extraction unit 1134 in the dot identifier extraction unit 633 extracts a feature value dependent on a distribution of the grains 256 from the aforementioned feature value extraction region in the image of the dot 253 stored in the image storage unit 832 and outputs the feature value as a dot identifier (Step S1103).

Since normalization of a coordinate system is not performed in the present example embodiment, the feature value extraction unit 1134 extracts a feature value robust to rotation of an image, or the like, such as an SIFT feature value. However, a feature value extracted by the feature value extraction unit 1134 is not limited to an SIFT feature value. Further, when an SIFT feature value is directly extracted from an image, one of the grains 256 becomes the minimum scale and the direction cannot be determined, and the descriptor becomes unstable and an inlier ratio decreases, thus making matching difficult. Then, an SIFT feature value is extracted as follows in this example.

First, the feature value extraction unit 1134 reduces resolution of an image of the feature value extraction region in the dot 253 in accordance with a predetermined criterion. Consequently, an image having a gradation pattern dependent on a density of the grains 256 in the dot 253 is generated. Next, the feature value extraction unit 1134 extracts an SIFT feature value from the image having the aforementioned gradation pattern.

### Yet Another Example of Dot Identifier Extraction Unit

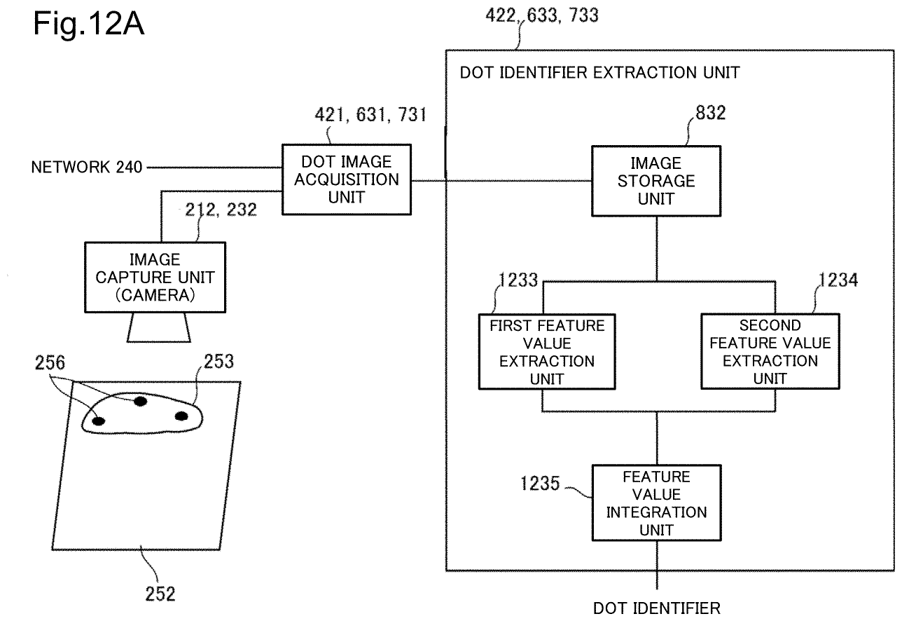

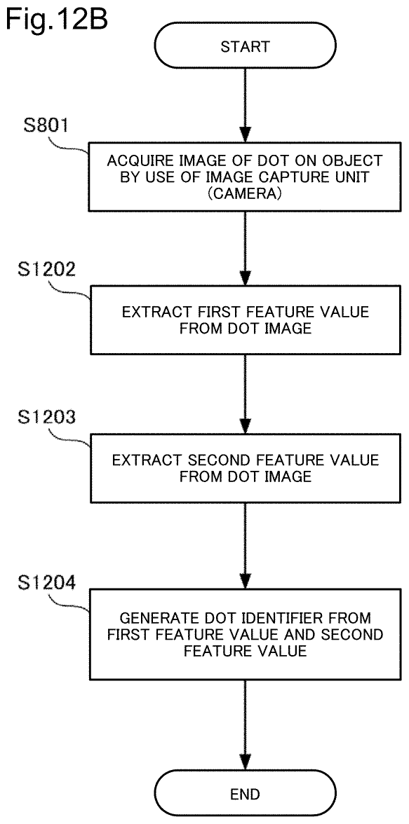

FIG. 12A is a block diagram illustrating yet another example of the functional configuration of the dot identifier extraction units 422, 633, and 733 according to the present example embodiment. FIG. 12A illustrates part of the entry-exit management server 220, the registration device 210, and the opening-closing device 230 that include the dot identifier extraction units 422, 633, and 733. Referring to FIG. 12A, the dot identifier extraction units 422, 633, and 733 according to the present example embodiment have a function of extracting a dot identifier of an object 252. In FIG. 12A, a component similar to that in FIG. 8A or FIG. 11A is given the same reference number, and redundant description thereof is omitted.

The dot identifier extraction units 422, 633, and 733 have a function of extracting a dot identifier from a dot image. Each of the dot identifier extraction units 422, 633, and 733 in this example includes an image storage unit 832, a first feature value extraction unit 1233, a second feature value extraction unit 1234, and a feature value integration unit 1235 as main function units. A program for each of the dot identifier extraction units 422, 633, and 733 is read into the memory from an external computer-readable recording medium at startup of the information processing unit or the like, and provides function configuration units, such as the first feature value extraction unit 1233, the second feature value extraction unit 1234, and the feature value integration unit 1235, on the arithmetic processing unit by controlling an operation of the arithmetic processing unit.

The first feature value extraction unit 1233 has a function of extracting a plane shape of a dot 253 and a feature value dependent on a distribution of grains 256 from an image of the dot 253, as a first feature value. For example, the first feature value extraction unit 1233 may be provided by the coordinate system determination unit 833, the normalized image generation unit 834, the normalized image storage unit 835, the fixed region determination unit 836, and the feature value extraction unit 837 that are described with reference to FIG. 8A. Alternatively, for example, the first feature value extraction unit 1233 may be provided by the dot region determination unit 1133 and the feature value extraction unit 1134 that are described with reference to FIG. 11A.

The second feature value extraction unit 1234 has a function of extracting a feature value dependent on the plane shape of the dot 253 from the image of the dot 253, as a second feature value. For example, the second feature value extraction unit 1234 has a function of extracting a feature value dependent on the plane shape of the dot 253 but not dependent on the distribution of the grains 256 from the image of the dot 253, as a second feature value. For example, the minimum or the maximum secondary moment calculated in a process of determining the axis of the unique coordinate system by the coordinate system determination unit 833 described with reference to FIG. 9C may be used as a feature value extracted by the second feature value extraction unit 1234. However, a feature value extracted by the second feature value extraction unit 1234 is not limited to the above, and another feature value such as an area or a perimeter of the plane shape of the dot 253 may be used.

The feature value integration unit 1235 has a function of generating a dot identifier from a first feature value extracted by the first feature value extraction unit 1233 and a second feature value extracted by the second feature value extraction unit 1234. For example, the feature value integration unit 1235 determines a feature value acquired by linking the first feature value and the second feature value as a dot identifier.

FIG. 12B is a flowchart illustrating a procedure of yet another example of the dot identifier extraction processing according to the present example embodiment. Operations of the dot identifier extraction units 422, 633, and 733 will be described below with reference to FIG. 12A and FIG. 12B, with an operation of the dot identifier extraction unit 633 as a representative. In FIG. 12B, a step similar to that in FIG. 8B or FIG. 11B is given the same step number, and redundant description thereof is omitted.

The first feature value extraction unit 1233 in the dot identifier extraction unit 633 extracts a first feature value dependent on a plane shape of the dot 253 and a distribution of the grains 256 from an image of the dot 253 (Step S1202).

Next, the second feature value extraction unit 1234 in the dot identifier extraction unit 633 extracts a second feature value dependent on the plane shape of the dot 253 from the image of the dot 253 (Step S1203).

Next, the feature value integration unit 1235 in the dot identifier extraction unit 633 generates a dot identifier by integrating the first feature value and the second feature value, and outputs the dot identifier (Step S1204).

Thus, a dot identifier includes a first feature value and a second feature value in this example. Accordingly, in checking and identification using a dot identifier extracted in this example, a comparison between dot identifiers may be performed with a combination of one of, two of, or all of three patterns being a comparison between first feature values, a comparison between second feature values, and a comparison between the entireties putting the first feature value and the second feature value together. Accordingly, for example, a form of first comparing second feature values and excluding candidates that are not the same nor similar, and then comparing first feature values for the remaining candidates as final identification and checking can be provided.

### Hardware Configuration of Entry-Exit Management Server

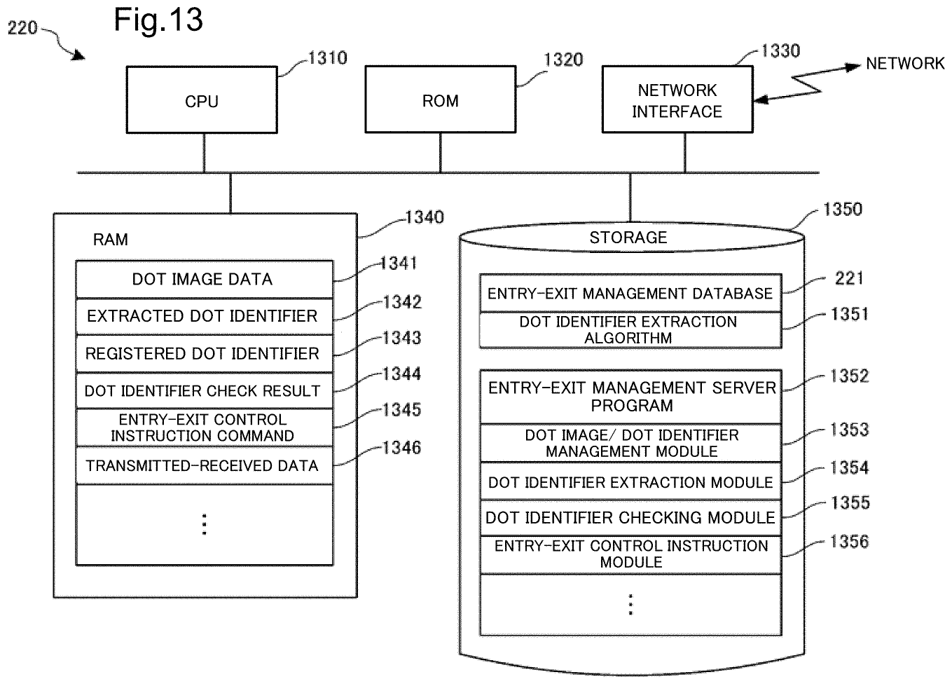

FIG. 13 is a block diagram illustrating a hardware configuration of the entry-exit management server 220 as the information processing device according to the present example embodiment. In FIG. 13, a functional configuration for character-recognizing a visitor identifier (ID) from a captured image of a business card, or the like for considering a visitor identification (ID) is omitted.

In FIG. 13, a central processing unit (CPU) 1310 is a processor for arithmetic control and provides the function configuration units in FIG. 4 by executing a program. There may be one or a plurality of CPUs 1310. A read only memory (ROM) 1320 stores initial data, fixed data for a program and the like, and a program. A network interface 1330 controls communication with the registration device 210 and the opening-closing device 230 through a network.

A random access memory (RAM) 1340 is a random access memory used by the CPU 1310 as a work area for temporary storage. A region for storing data required for providing the present example embodiment is secured in the RAM 1340. Dot image data 1341 are data of a dot image received from the registration device 210 or the opening-closing device 230. An extracted dot identifier 1342 is data of a dot identifier received from the registration device 210 or the opening-closing device 230, or data of a dot identifier extracted from the dot image data 1341. A registered dot identifier 1343 is data of a registered dot identifier read from the entry-exit management database 221. A dot identifier check result 1344 is data indicating a check result between an extracted dot identifier 1342 and a registered dot identifier 1343. An entry-exit control instruction command 1345 is data of an entry-exit control command for giving an instruction to the opening-closing device 230, based on a dot identifier check result 1344. Transmitted-received data 1346 store data transmitted and received through a network and include a dot image, a dot identifier, and an entry-exit control command in this example.

A storage 1350 stores a database, various parameters, or the following data or programs required for providing the present example embodiment that are used by the CPU 1310. Data including a dot identifier are registered in the entry-exit management database 221, as illustrated in FIG. 5. A dot identifier extraction algorithm 1351 is an algorithm to be used for dot identifier extraction. The storage 1350 holds the following programs. An entry-exit management server program 1352 is a program controlling the entire entry-exit management server 220. A dot image/dot identifier management module 1353 is a module managing a dot image and a dot identifier received from the registration device 210 or the opening-closing device 230, or a dot identifier extracted by the entry-exit management server program 1352. A dot identifier extraction module 1354 is a module extracting a dot identifier from a dot image. A dot identifier checking module 1355 is a module checking a registered dot identifier read from the entry-exit management database 221 against a dot identifier newly extracted from a dot image. An entry-exit control instruction module 1356 is a module instructing the opening-closing device 230 to perform entry-exit control, based on a check result by the dot identifier checking module 1355.

A program and data related to a general-purpose function and another executable function of the entry-exit management server 220 are not illustrated in the RAM 1340 and the storage 1350 in FIG. 13.

### Processing Procedure of Entry-Exit Management Server

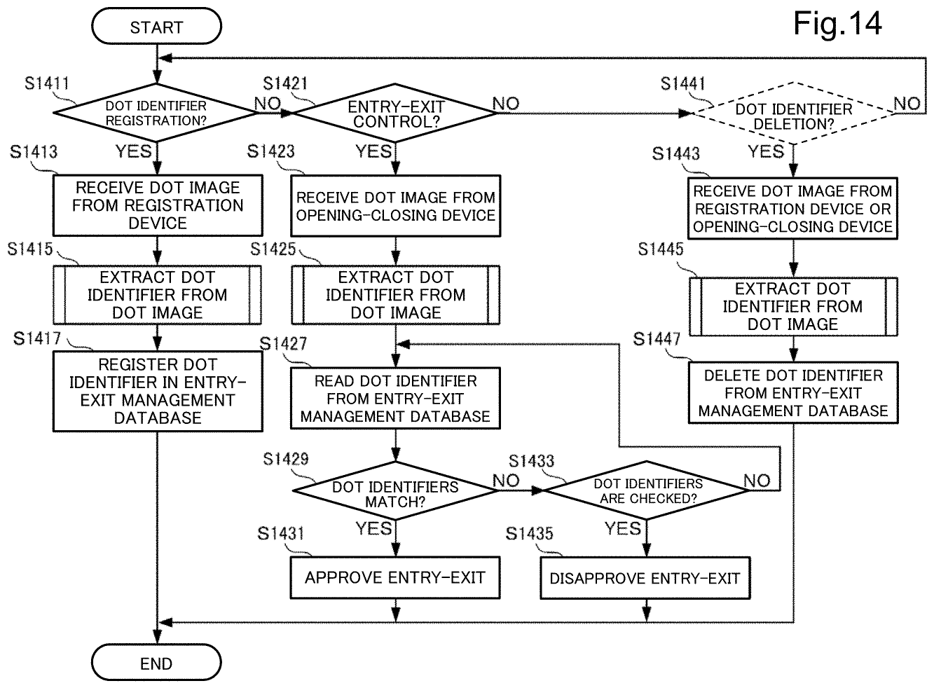

FIG. 14 is a flowchart illustrating a processing procedure of the entry-exit management server 220 as the information processing device according to the present example embodiment. The flowchart is executed by the CPU 1310 in FIG. 13 by use of the RAM 1340 and provides the function configuration units in FIG. 4. The flowchart in FIG. 14 corresponds to the operational sequence in FIG. 3A by which the entry-exit management server extracts a dot identifier. Further, processing “EXTRACT DOT IDENTIFIER FROM DOT IMAGE” in FIG. 14 is selected from the dot identifier extraction processing presented in FIG. 2B and FIG. 8A to FIG. 12B and for example, executes processing in accordance with the flowchart in FIG. 8B, FIG. 11B, or FIG. 12B. Further, in FIG. 14, processing for character-recognizing a visitor identifier (ID) from a captured image of a business card, or the like for considering a visitor identification (ID) is omitted.

In Step S1411, the entry-exit management server 220 determines whether or not dot identifier registration processing is to be performed. For example, the dot identifier registration processing is determined to be performed by reception of a dot image or a dot identifier from the registration device 210, or a registration instruction command. When determining that the dot identifier registration processing is to be performed, in Step S1413, the entry-exit management server 220 receives a dot image from the registration device 210. In Step S1415, the entry-exit management server 220 extracts a dot identifier from the received dot image. Then, in Step S1417, the entry-exit management server 220 registers the extracted dot identifier in the entry-exit management database 221.

When determining that the dot identifier registration processing is not to be performed, in Step S1421, the entry-exit management server 220 determines whether or not entry-exit control processing is to be performed. For example, the entry-exit control processing is determined to be performed by reception of a dot image or a dot identifier from the opening-closing device 230, or an entry-exit control instruction command. When determining that the entry-exit control processing is to be performed, in Step S1423, the entry-exit management server 220 receives a dot image from the opening-closing device 230. In Step S1425, the entry-exit management server 220 extracts a dot identifier from the received dot image. Then, in Step S1427, the entry-exit management server 220 reads a registered dot identifier from the entry-exit management database 221 and checks the read dot identifier against the dot identifier extracted from the received dot image.

In Step S1429, the entry-exit management server 220 determines whether or not the check of the dot identifiers indicates a match. Whether or not the check of the dot identifiers indicates a match may be determined to be a match when the difference derived from the check result is equal to or less than a predetermined threshold value. When determining that the dot identifiers match, in Step S1431, the entry-exit management server 220 notifies approval of entry-exit to the opening-closing device 230. On the other hand, when determining that the dot identifiers do not match, in Step S1433, the entry-exit management server 220 determines whether or not a check of a dot identifier to be checked is completed, the dot identifier being registered in the entry-exit management database 221. For example, a dot identifier to be checked may be selected from registered dot identifiers, based on additional information such as a date and time of visit by a visitor. When determining that the check is completed, in Step S1435, the entry-exit management server 220 notifies disapproval of entry-exit to the opening-closing device 230. On the other hand, when determining that the check is not completed, the entry-exit management server 220 continues a check against another dot identifier from Step S1427.

When determining that neither the dot identifier registration processing nor the entry-exit control processing is to be performed, in Step S1441, the entry-exit management server 220 determines whether or not deletion of a dot identifier is to be performed. For example, a dot identifier may be deleted, based on a deletion request from the registration device 210 or the opening-closing device 230, a case of a predetermined registration time or a predetermined date and time of visit being overdue, or the like. Alternatively, a deletion instruction may be given by an operator at reception. A procedure in the case of a deletion request from the registration device 210 or the opening-closing device 230 will be described below. When determining that the dot identifier deletion processing is to be performed, in Step S1443, the entry-exit management server 220 receives a dot image from the registration device 210 or the opening-closing device 230. In Step S1445, the entry-exit management server 220 extracts a dot identifier from the received dot image. Then, when the extracted dot identifier is registered in the entry-exit management database 221, in Step S1447, the entry-exit management server 220 deletes the dot identifier. Deletion may be determined with reference to not only a dot identifier but also additional information.

### Hardware Configuration of Registration Device

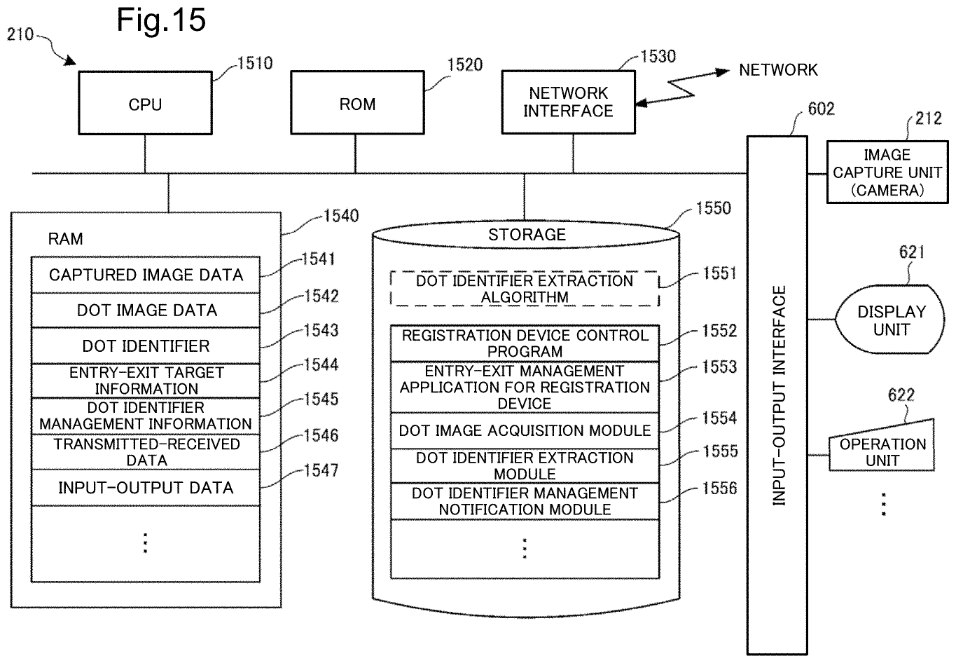

FIG. 15 is a block diagram illustrating a hardware configuration of the registration device 210 according to the present example embodiment. In FIG. 15, a functional configuration for character-recognizing a visitor identifier (ID) from a captured image of a business card, or the like for considering a visitor identification (ID) is omitted.

In FIG. 15, a CPU 1510 is a processor for arithmetic control and provides the function configuration units in FIG. 6 by executing a program. There may be one or a plurality of CPUs 1510. A ROM 1520 stores initial data, fixed data for a program and the like, and a program. A network interface 1530 controls communication with the entry-exit management server 220 through a network.

A RAM 1540 is a random access memory used by the CPU 1510 as a work area for temporary storage. A region for storing data required for providing the present example embodiment is secured in the RAM 1540. Captured image data 1541 are image data including a dot 253 described on an object 252 an image of which is captured by the image capture unit (camera) 212. Dot image data 1542 are data of a dot image extracted from captured image data 1541. When the image capture unit (camera) 212 has a dot image extraction function, the dot image data 1542 are data of a dot image received from the image capture unit (camera) 212. A dot identifier 1543 is data of a dot identifier extracted from dot image data 1542 when the registration device 210 has the function of extracting a dot identifier from a dot image. Entry-exit target information 1544 is information, such as a visitor identifier (ID) and a date and time of visit, being added when additional information is used for authentication other than a dot identifier check. Dot identifier management information 1545 is information for dot identifier management used in a case of a notification of registration of a dot identifier in the entry-exit management database 221, an instruction from the registration device 210 for deletion of a dot identifier from the entry-exit management database 221, or the like. Transmitted-received data 1546 store data transmitted and received through the network and include a dot image, a dot identifier, and a registration completion notification in this example. Input-output data 1547 are data input and output from and to input-output equipment through the input-output interface 602.

A storage 1550 stores a database, various parameters, or the following data or programs required for providing the present example embodiment that are used by the CPU 1510. A dot identifier extraction algorithm 1551 is an algorithm used for dot identifier extraction when the registration device 210 has the dot identifier extraction function. The storage 1550 holds the following programs. A registration device control program 1552 is a program controlling the entire registration device 210. An entry-exit management application for a registration device 1553 is an application program for performing entry-exit management as the registration device 210. A dot image acquisition module 1554 is a module including acquisition of a dot image from an image captured by the image capture unit (camera) 212 and enlargement of a dot image. A dot identifier extraction module 1555 is a module extracting a dot identifier from a dot image when the registration device 210 has the dot identifier extraction function. A dot identifier management notification module 1556 is a module managing a notification of registration of a dot identifier in the entry-exit management database 221, an instruction from the registration device 210 for deletion of a dot identifier from the entry-exit management database 221, or the like.

The input-output interface 602 serves as an interface for controlling data input and output from and to an input-output device. As illustrated in FIG. 6, the input-output interface 602 is connected to the image capture unit (camera) 212, the display unit 621, the operation unit 622, and the like, according to the present example embodiment.

A program and data related to a general-purpose function and another executable function of the registration device 210 are not illustrated in the RAM 1540 and the storage 1550 in FIG. 15.

### Processing Procedure of Registration Device

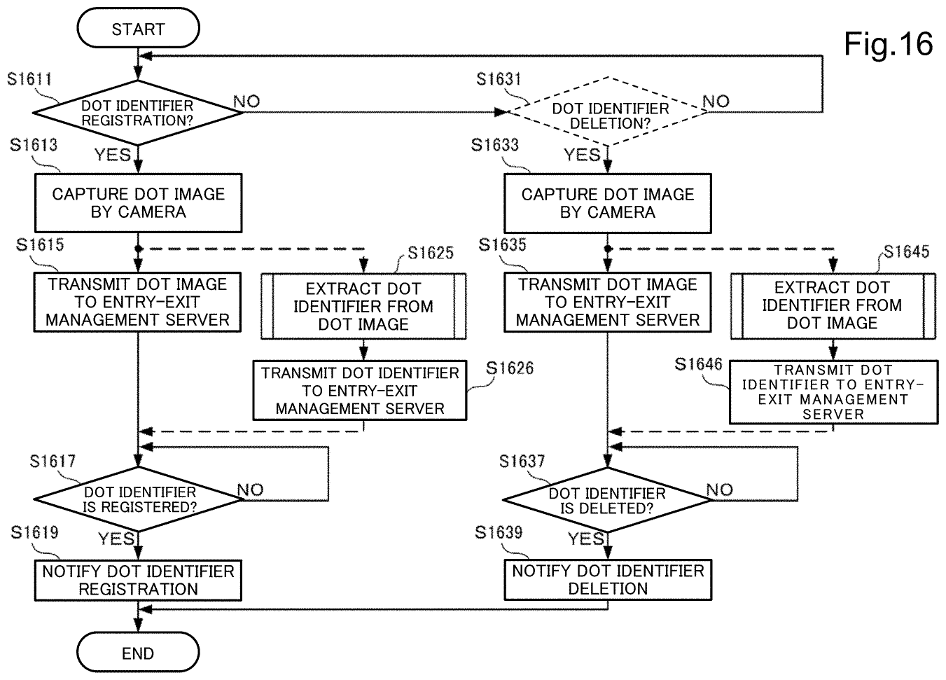

FIG. 16 is a flowchart illustrating a processing procedure of the registration device 210 according to the present example embodiment. The flowchart is executed by the CPU 1510 in FIG. 15 by use of the RAM 1540 and provides the function configuration units in FIG. 6. Processing “EXTRACT DOT IDENTIFIER FROM DOT IMAGE” in FIG. 16 is selected from the dot identifier extraction processing presented in FIG. 2B and FIG. 8A to FIG. 12B and for example, executes processing in accordance with the flowchart in FIG. 8B, FIG. 11B, or FIG. 12B. Further, in FIG. 16, processing for character-recognizing a visitor identifier (ID) from a captured image of a business card, or the like for considering a visitor identification (ID) is omitted.

In Step S1611, the registration device 210 determines whether or not dot identifier registration processing is to be performed. For example, the dot identifier registration processing is determined to be performed by acquisition of a dot image or a dot identifier in the registration device 210, or a registration instruction command. When determining that the dot identifier registration processing is to be performed, in Step S1613, the registration device 210 captures an image of a dot image by the image capture unit (camera) 212.

When the registration device 210 does not have the dot identifier extraction function, in Step S1615, the registration device 210 transmits the captured dot image to the entry-exit management server 220. On the other hand, when the registration device 210 has the dot identifier extraction function, in Step S1625, the registration device 210 extracts a dot identifier from the captured dot image. Then, in Step S1626, the registration device 210 transmits the extracted dot identifier to the entry-exit management server 220.

Next, in Step S1617, the registration device 210 awaits a notification of dot identifier registration completion from the entry-exit management server 220. When a notification of dot identifier registration completion is received, in Step S1619, the registration device 210 notifies dot identifier registration completion by display or the like.

When determining that the dot identifier registration processing is not to be performed, in Step S1631, the registration device 210 determines whether or not dot identifier deletion processing is to be performed. Note that the dot identifier deletion processing in the registration device 210 is not mandatory but optional. For example, when a dot identifier registered in the registration device 210 is extracted again, it may be determined that a visitor exits, and the dot identifier may be deleted. Alternatively, the deletion processing by an operator at reception may be performed. When determining that the dot identifier deletion processing is to be performed, in Step S1633, the registration device 210 captures an image of a dot image by the image capture unit (camera) 212.

When the registration device 210 does not have the dot identifier extraction function, in Step S1635, the registration device 210 transmits the captured dot image to the entry-exit management server 220. On the other hand, when the registration device 210 has the dot identifier extraction function, in Step S1645, the registration device 210 extracts a dot identifier from the captured dot image. Then, in Step S1646, the registration device 210 transmits the extracted dot identifier to the entry-exit management server 220.

Next, in Step S1637, the registration device 210 awaits a notification of dot identifier deletion completion from the entry-exit management server 220. When a notification of dot identifier registration completion is received, in Step S1639, the registration device 210 notifies dot identifier deletion completion by display or the like.

### Hardware Configuration of Opening-Closing Device

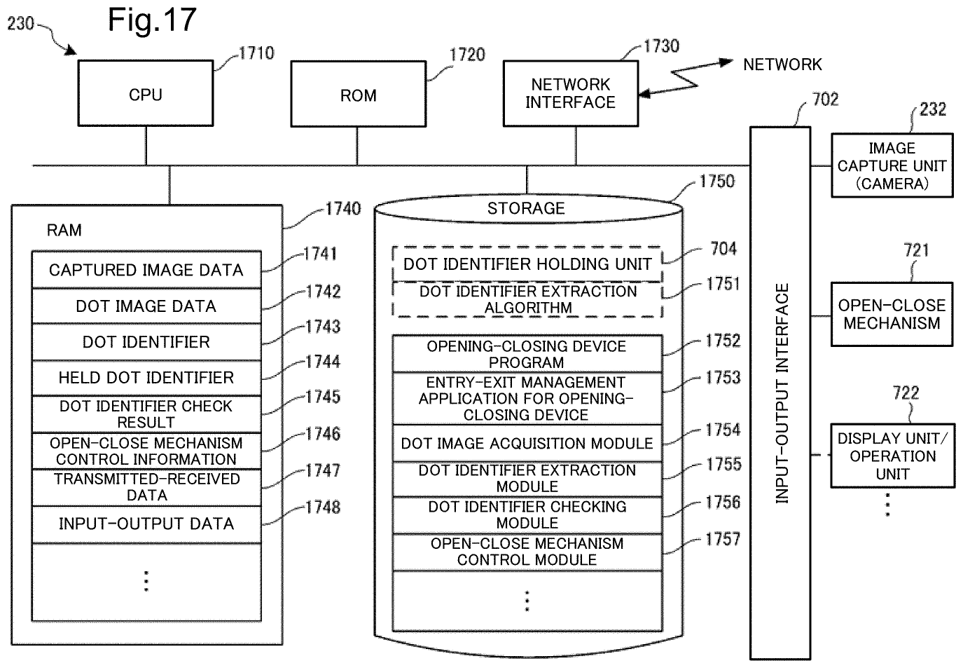

FIG. 17 is a block diagram illustrating a hardware configuration of the opening-closing device 230 according to the present example embodiment. In FIG. 17, a functional configuration for character-recognizing a visitor identifier (ID) from a captured image of a business card, or the like for considering a visitor identification (ID) is omitted.

In FIG. 17, a CPU 1710 is a processor for arithmetic control and provides the function configuration units in FIG. 7 by executing a program. There may be one or a plurality of CPUs 1710. A ROM 1720 stores initial data, fixed data for a program and the like, and a program. A network interface 1730 controls communication with the entry-exit management server 220 through a network.

A RAM 1740 is a random access memory used by the CPU 1710 as a work area for temporary storage. A region for storing data required for providing the present example embodiment is secured in the RAM 1740. Captured image data 1741 are image data including a dot 253 described on an object 252 an image of which is captured by the image capture unit (camera) 232. Dot image data 1742 are data of a dot image extracted from captured image data 1741. When the image capture unit (camera) 232 has the dot image extraction function, the dot image data 1742 are data of a dot image received from the image capture unit (camera) 232. A dot identifier 1743 is data of a dot identifier extracted from dot image data 1742 when the opening-closing device 230 has the function of extracting a dot identifier from a dot image. A held dot identifier 1744 is data of a dot identifier read from the dot identifier holding unit 704 when the opening-closing device 230 has a dot identifier checking processing function. A dot identifier check result 1745 is data of a check result between an extracted dot identifier 1743 and a held dot identifier 1744 read from the dot identifier holding unit 704 when the opening-closing device 230 has the dot identifier checking processing function. Open-close mechanism control information 1746 is information for instructing open-close control of the open-close mechanism 721, based on a check result between dot identifiers. Transmitted-received data 1747 store data transmitted and received through the network and include a dot image, an extracted dot identifier, and a holding instruction dot identifier in this example. Input-output data 1748 are data input and output from and to input-output equipment through the input-output interface 602.

A storage 1750 stores a database, various parameters, or the following data or programs required for providing the present example embodiment that are used by the CPU 1710. When the opening-closing device 230 has the dot identifier checking processing function, the dot identifier holding unit 704 holds a dot identifier transmitted from the entry-exit management server 220, for the checking processing in the opening-closing device 230. A dot identifier extraction algorithm 1751 is an algorithm used for dot identifier extraction when the opening-closing device 230 has the dot identifier extraction function. The storage 1750 holds the following programs. An opening-closing device program 1752 is a program controlling the entire opening-closing device 230. An entry-exit management application for an opening-closing device 1753 is an application program for performing entry-exit management as the opening-closing device 230. A dot image acquisition module 1754 is a module including acquisition of a dot image from an image captured by the image capture unit (camera) 232 and enlargement of a dot image. A dot identifier extraction module 1755 is a module extracting a dot identifier from a dot image when the opening-closing device 230 has the dot identifier extraction function. A dot identifier checking module 1756 is a module checking an extracted dot identifier 1743 against a held dot identifier 1744 read from the dot identifier holding unit 704 when the opening-closing device 230 has the dot identifier checking processing function. An open-close mechanism control module 1757 is a module instructing open-close control of the open-close mechanism 721, based on an open-close control instruction from the entry-exit management server 220 or a check result between dot identifiers.

The input-output interface 702 serves as an interface for controlling data input and output from and to an input-output device. As illustrated in FIG. 7, the input-output interface 702 is connected to the image capture unit (camera) 232, the open-close mechanism 721, the display unit/operation unit 722, and the like, according to the present example embodiment.

A program and data related to a general-purpose function and another executable function of the opening-closing device 230 are not illustrated in the RAM 1740 and the storage 1750 in FIG. 17.

### Processing Procedure of Opening-Closing Device

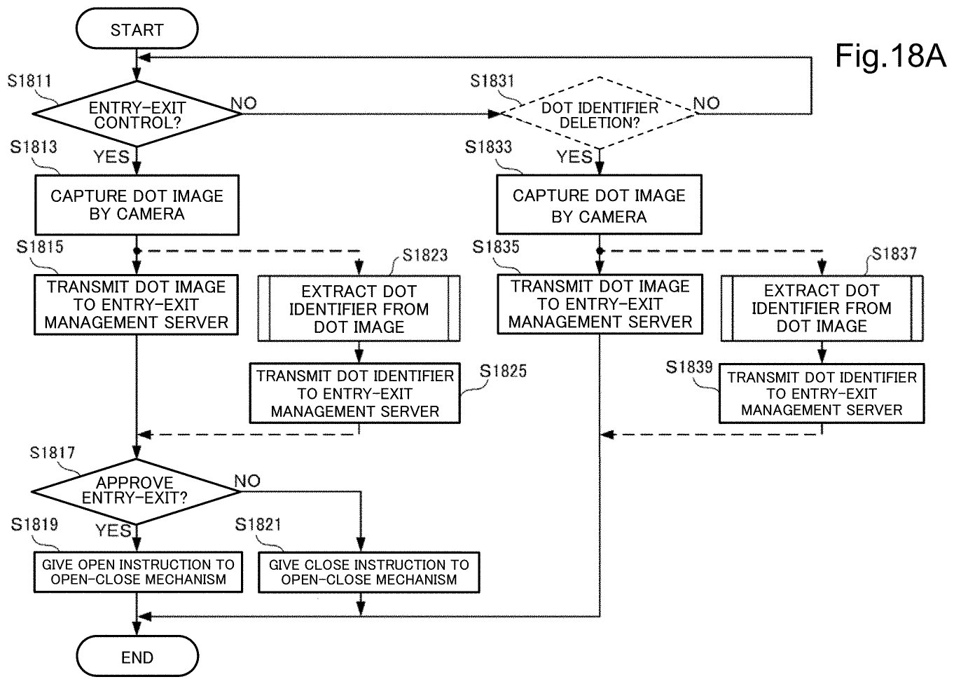

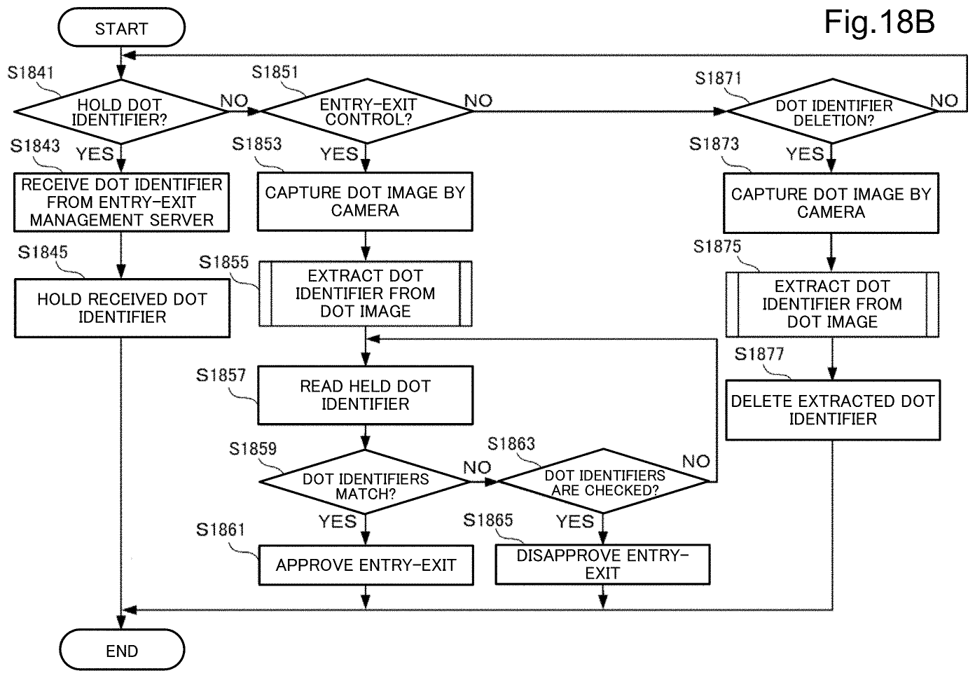

FIG. 18A is a flowchart illustrating a processing procedure of the opening-closing device 230 according to the present example embodiment. The flowchart is executed by the CPU 1710 in FIG. 17 by use of the RAM 1740 and provides the function configuration units in FIG. 7. The flowchart in FIG. 18A is a flowchart when the opening-closing device 230 does not have a dot identifier check function. Processing “EXTRACT DOT IDENTIFIER FROM DOT IMAGE” in FIG. 18A is selected from the dot identifier extraction processing presented in FIG. 2B and FIG. 8A to FIG. 12B and for example, executes processing in accordance with the flowchart in FIG. 8B, FIG. 11B, or FIG. 12B. Further, in FIG. 18A, processing for character-recognizing a visitor identifier (ID) from a captured image of a business card, or the like for considering a visitor identification (ID) is omitted.

In Step S1811, the opening-closing device 230 determines whether or not entry-exit control processing is to be performed. For example, the entry-exit control processing is determined to be performed by acquisition of a dot image or a dot identifier in the opening-closing device 230 or an open-close control instruction command. When determining that the entry-exit control processing is to be performed, in Step S1813, the opening-closing device 230 captures an image of a dot image by the image capture unit (camera) 232.

When the opening-closing device 230 does not have the dot identifier extraction function, in Step S1815, the opening-closing device 230 transmits the captured dot image to the entry-exit management server 220. On the other hand, when the opening-closing device 230 has the dot identifier extraction function, in Step S1823, the opening-closing device 230 extracts a dot identifier from the captured dot image. Then, in Step S1825, the opening-closing device 230 transmits the extracted dot identifier to the entry-exit management server 220.

Next, in Step S1817, the opening-closing device 230 awaits a notification of whether or not entry-exit is approved from the entry-exit management server 220. When a notification of approval of entry-exit is received, in Step S1819, the opening-closing device 230 gives an open instruction for the open-close mechanism 721 or an instruction for approval of entry-exit. On the other hand, when a notification of disapproval of entry-exit is received, in Step S1821, the opening-closing device 230 gives a close instruction for the open-close mechanism 721 or an instruction for disapproval of entry-exit.

When determining that the entry-exit control processing is not to be performed, in Step S1831, the opening-closing device 230 determines whether or not dot identifier deletion processing is to be performed. Note that the dot identifier deletion processing in the opening-closing device 230 is not mandatory but optional. For example, when a dot identifier registered in the opening-closing device 230 is extracted again, it may be determined that a visitor exits from a location where the opening-closing device 230 is installed, and a dot identifier indicating entry-exit approval to and from such a location may be deleted. When determining that the dot identifier deletion processing is to be performed, in Step S1833, the opening-closing device 230 captures an image of a dot image by the image capture unit (camera) 232.

When the opening-closing device 230 does not have the dot identifier extraction function, in Step S1835, the opening-closing device 230 transmits the captured dot image to the entry-exit management server 220 along with location information about where the opening-closing device 230 is installed. On the other hand, when the opening-closing device 230 has the dot identifier extraction function, in Step S1837, the opening-closing device 230 extracts a dot identifier from the captured dot image. Then, in Step S1839, the opening-closing device 230 transmits the extracted dot identifier to the entry-exit management server 220 along with the location information about where the opening-closing device 230 is installed.

### Another Processing Procedure of Opening-Closing Device

FIG. 18B is a flowchart illustrating another processing procedure of the opening-closing device 230 according to the present example embodiment. The flowchart is executed by the CPU 1710 in FIG. 17 by use of the RAM 1740 and provides the function configuration units in FIG. 7. The flowchart in FIG. 18B is a flowchart when the opening-closing device 230 has the dot identifier check function. Processing “EXTRACT DOT IDENTIFIER FROM DOT IMAGE” in FIG. 18B is selected from the dot identifier extraction processing presented in FIG. 2B and FIG. 8A to FIG. 12B and for example, executes processing in accordance with the flowchart in FIG. 8B, FIG. 11B, or FIG. 12B. Further, in FIG. 18B, processing for character-recognizing a visitor identifier (ID) from a captured image of a business card, or the like for considering a visitor identification (ID) is omitted.

In Step S1841, the opening-closing device 230 determines whether or not an instruction for holding a dot identifier related to the opening-closing device 230 is received, the instruction being transmitted from the entry-exit management server 220. When determining that a dot identifier holding instruction is received, in Step S1843, the opening-closing device 230 receives a dot identifier from the entry-exit management server 220. Then, in Step S1845, the opening-closing device 230 holds the received dot identifier in the dot identifier holding unit 704.

When determining that a dot identifier holding instruction is not received, in Step S1851, the opening-closing device 230 determines whether or not entry-exit control processing is to be performed. When determining that the entry-exit control processing is to be performed, in Step S1853, the opening-closing device 230 captures an image of a dot image by the image capture unit (camera) 232. In Step S1855, the opening-closing device 230 extracts a dot identifier from the captured dot image. Then, in Step S1857, the opening-closing device 230 reads a held dot identifier from the dot identifier holding unit 704 and checks the dot identifier against the dot identifier extracted from the captured dot image.

In Step S1859, the opening-closing device 230 determines whether or not the check of the dot identifiers indicates a match. Whether or not the check of the dot identifiers indicates a match may be determined to be a match when the difference derived from the check result is equal to or less than a predetermined threshold value. When determining that the dot identifiers match, in Step S1861, the opening-closing device 230 notifies approval of entry-exit to the open-close mechanism 721. On the other hand, when determining that the dot identifiers do not match, in Step S1863, the opening-closing device 230 determines whether or not a check of a dot identifier to be checked is completed, the dot identifier being held in the dot identifier holding unit 704. For example, a dot identifier to be checked may be selected from held dot identifiers, based on additional information such as a date and time of visit by a visitor. When determining that the check is completed, in Step S1865, the opening-closing device 230 notifies disapproval of entry-exit to the open-close mechanism 721. On the other hand, when determining that the check is not completed, the opening-closing device 230 continues a check against another dot identifier from Step S1857.

When determining that neither the dot identifier holding processing nor the entry-exit control processing is to be performed, in Step S1871, the opening-closing device 230 determines whether or not dot identifier deletion processing is to be performed. For example, when a dot identifier held in the opening-closing device 230 is extracted again, it may be determined that a visitor exits from a location where the opening-closing device 230 is installed, and a dot identifier indicating entry-exit approval to and from such a location may be deleted. When determining that the dot identifier deletion processing is to be performed, in Step S1873, the opening-closing device 230 captures an image of a dot image by the image capture unit (camera) 232. In Step S1875, the opening-closing device 230 extracts a dot identifier from the captured dot image. Then, when the extracted dot identifier is held in the dot identifier holding unit 704, the dot identifier is deleted. Deletion may be determined with reference to not only a dot identifier but also additional information.

The present example embodiment performs entry-exit management by use of a dot identifier extracted from a dot being given to an object and being described with a writing tool, and therefore cost and effort required for entry-exit management can be reduced. For example, since an admission pass function is added to a possession by a dot at reception, cost and effort required for newly issuing an admission pass such as an IC card can be reduced. Further, a printer or the like for printing a bar code or the like is not required, and fabrication by copying or the like does not occur either. Further, another person cannot recognize that an object is an admission pass, therefore a theft or use by another person can be prevented. Furthermore, a dot image and a dot identifier do not include information related to personal information at all, and therefore protection of personal information required in face authentication or the like is also perfectly performed.

### Third Example Embodiment

Next, an entry-exit management system according to a third example embodiment will be described. Compared with the aforementioned second example embodiment, the entry-exit management system according to the present example embodiment differs in being capable of addition of an admission pass function to a possession at any date and time at any location instead of addition of the admission pass function at venue reception. The other configuration and operation are similar to those according to the second example embodiment, and therefore the same configuration and operation are given the same reference signs, thus omitting detailed description thereof.

### Entry-Exit Management System

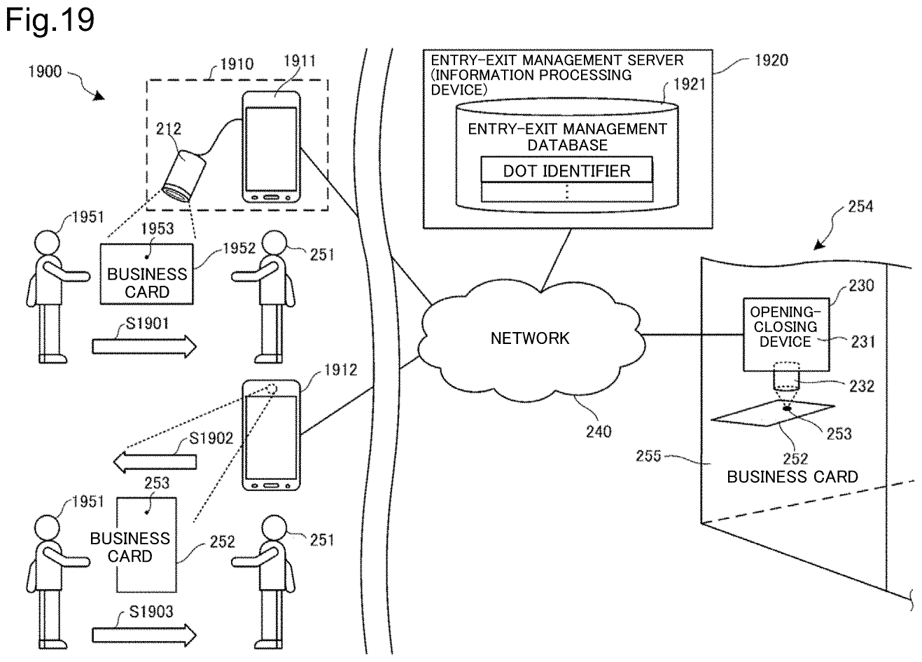

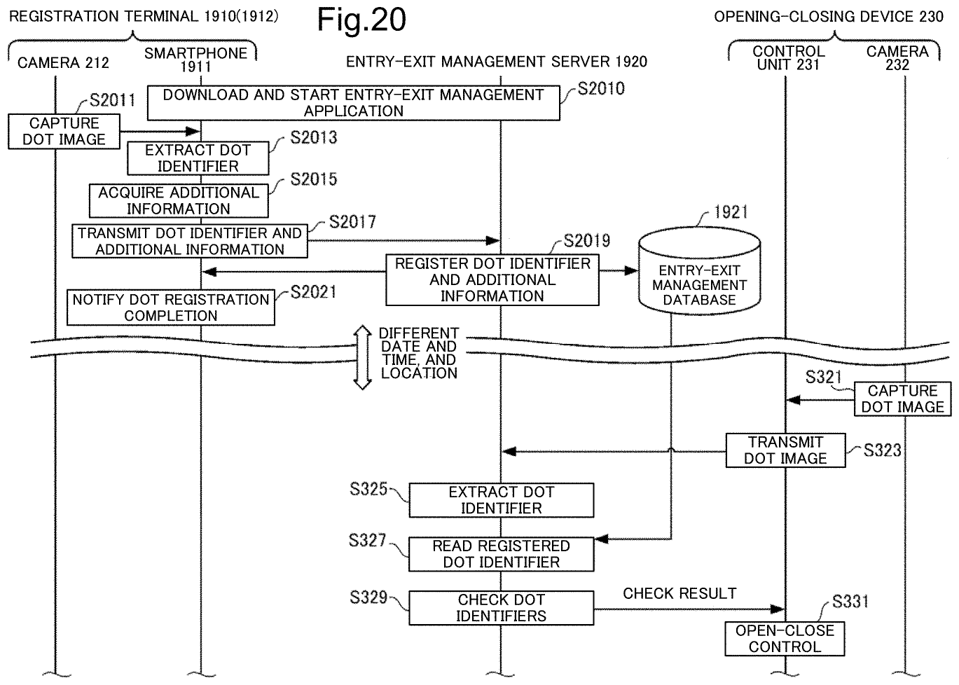

A configuration and an operation of an entry-exit management system 1900 according to the present example embodiment will be described with reference to FIG. 19 and FIG. 20.

### Overview

FIG. 19 is a diagram illustrating an overview of the entry-exit management system 1900 according to the present example embodiment. A component similar to that in FIG. 2A is given the same reference number, and redundant description thereof is omitted.

The entry-exit management system 1900 includes a registration terminal 1910, a smartphone 1912, an entry-exit management server 1920 as an information processing device, and an opening-closing device 230 that are connected through a network 240. The registration terminal 1910 includes a smartphone 1911 connectable to an image capture unit 212 and for a check of dot identifiers in the entry-exit management server 1920, for example, captures an image of a dot 1953 described with a writing tool on a business card 1952 of a guest 1951 and registers the image in an entry-exit management database 1921. When an image of a dot 1953 described with a writing tool on a business card 1952 of a guest 1951 is captured and registered, the image may not be registered on site; and the guest 1951 may previously describe the dot 1953 on the business card 1952 with a writing tool and register the image in the entry-exit management database 1921.

Further, the smartphone 1912 is a smartphone including a high-resolution camera and for a check of dot identifiers in the entry-exit management server 1920, for example, captures an image of a dot 253 described with a writing tool on an object 252 including a business card of a visitor 251 and registers the image in the entry-exit management database 1921. When the smartphones 1911 and 1912 have a function of extracting a dot identifier from a dot image, dot identifiers are transmitted from the smartphones 1911 and 1912 to the entry-exit management server 1920.

The entry-exit management server 1920 includes the entry-exit management database 1921, checks a registered dot identifier against a dot identifier of a dot an image of which is captured by the opening-closing device 230, and notifies the check result to the opening-closing device 230.

### Operational Sequence

FIG. 20 is a sequence diagram illustrating an operation procedure of the entry-exit management system 1900 according to the present example embodiment. In FIG. 20, the smartphones 1911 and 1912 will be described on an assumption that the smartphones have the function of extracting a dot identifier from a dot image. Further, a step similar to that in FIG. 3A is given the same step number, and redundant description thereof is omitted. Furthermore, a dot identifier deletion operation is omitted.

In Step S2010, the smartphone 1911 in the registration terminal 1910 and the smartphone 1912 with a high-resolution camera download an entry-exit management application for a registration terminal from the entry-exit management server 1920 and start the application. Download and startup may not be performed simultaneously, and the downloaded entry-exit management application for a registration terminal may be started when required. The registration terminal 1910 will be hereinafter representatively described.

A dot identifier registration operation will be described. It is assumed that a dot is already described with a writing tool on a business card of a visitor or a business card of a guest. In Step S2011, the image capture unit (camera) 212 in the registration terminal 1910 captures a dot image on a business card at any date and time, and at any location. In Step S2013, the smartphone 1911 in the registration terminal 1910 extracts a dot identifier from the dot image captured from the business card by the image capture unit (camera) 212. Next, as an option as required, in Step S2015, the smartphone 1911 in the registration terminal 1910 acquires additional information. The additional information may include present location information based on the Global Positioning System (GPS), present date-and-time information from a timer, or a visitor identifier and a guest identifier. In Step S2017, the smartphone 1911 in the registration terminal 1910 transmits the extracted dot identifier and, as required, the additional information to the entry-exit management server 1920. In Step S2019, the entry-exit management server 1920 registers the received dot identifier and, as required, the received additional information in the entry-exit management database 1921. When a matching dot identifier is already registered, the entry-exit management server 1920 does not register the dot identifier and prompts registration with another dot image. Furthermore, when registration is completed, in Step S2019, the entry-exit management server 1920 notifies completion of the dot identifier registration. In Step S2021, the smartphone 1911 in the registration terminal 1910 notifies registration completion.

It is assumed in the operational sequence in FIG. 20 that an entry-exit location (venue) and a date and time of entry-exit are previously set. When an entry-exit location, and a date and time of entry-exit are set at registration, input and registration of the entry-exit location and the date and time of entry-exit are performed. Further, when management based on a visitor identifier (ID) and a guest identifier (ID) is performed, input and registration of the visitor identifier (ID) and the guest identifier (ID) are performed. Such input of the visitor identifier (ID) and the guest identifier (ID) may be registered in the entry-exit management database 221 through operation input by the guest or character recognition from a captured image of a business card.

### Functional Configuration of Smartphone

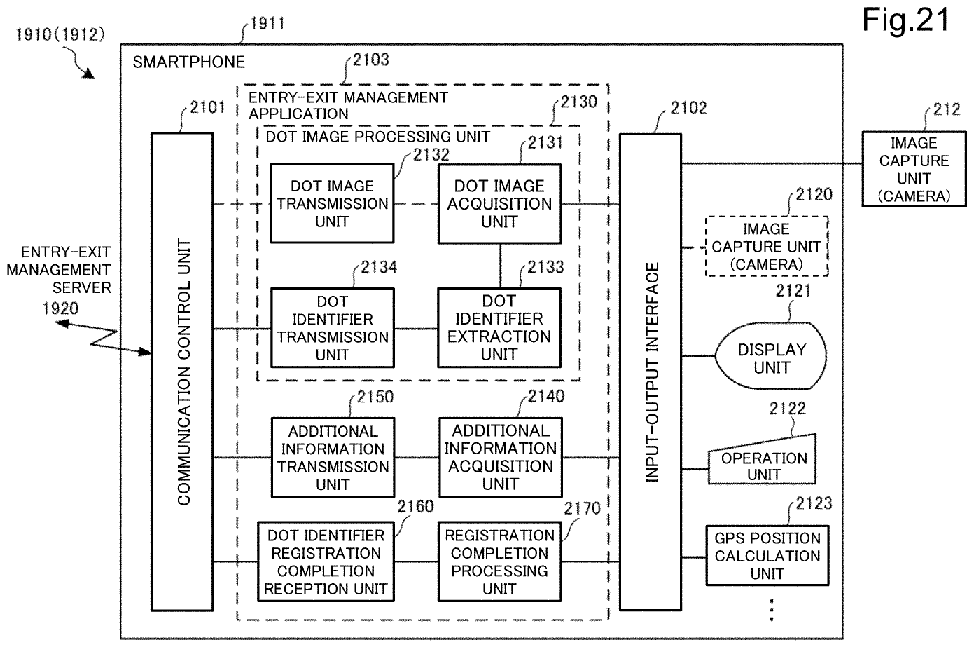

FIG. 21 is a block diagram illustrating a functional configuration of the smartphone 1911 as the registration terminal 1910 according to the present example embodiment.

The smartphone 1911 includes a communication control unit 2101, an input-output interface 2102, an entry-exit management application 2103, an image capture unit (camera) 2120, a display unit 2121, an operation unit 2122, and a GPS position calculation unit 2123. The image capture unit (camera) 2120, the display unit 2121, the operation unit 2122, and the GPS position calculation unit 2123 are connected to the input-output interface 2102. Further, the external image capture unit (camera) 212 is also connected to the input-output interface 2102.

The communication control unit 2101 controls communication with the entry-exit management server 1920 through a network. The input-output interface 2102 serves as an interface with input-output equipment. The entry-exit management application 2103 includes a dot image processing unit 2130, an additional information acquisition unit 2140, an additional information transmission unit 2150, a dot identifier registration completion reception unit 2160, and a registration completion processing unit 2170.

The dot image processing unit 2130 includes a dot image acquisition unit 2131, a dot image transmission unit 2132, a dot identifier extraction unit 2133, and a dot identifier transmission unit 2134. When a dot identifier is transmitted to the entry-exit management server 1920, a dot identifier is extracted, by the dot identifier extraction unit 2133, from a dot image acquired by the dot image acquisition unit 2131 and is transmitted from the dot identifier transmission unit 2134. On the other hand, when a dot image is transmitted to the entry-exit management server 1920, a dot image acquired by the dot image acquisition unit 2131 is transmitted from the dot image transmission unit 2132.

For example, the optional additional information acquisition unit 2140 acquires present location information from the GPS position calculation unit 2123, present date-and-time information from a timer (unillustrated), or a visitor identifier and a guest identifier from the operation unit 2122 and the image capture units (camera) 212 and 2120. The dot identifier registration completion reception unit 2160 receives a completion notification of registration of a dot identifier in the entry-exit management database 1921 from the entry-exit management server 1920. The registration completion processing unit 2170 performs registration completion processing such as reporting registration completion to the display unit 2121.

Although not illustrated in FIG. 21, when management based on a visitor identifier (ID) and a guest identifier (ID) is performed, the smartphone 1911 may perform character recognition on a captured image of a business card and register a visitor identifier (ID) and a guest identifier (ID) in the entry-exit management database 1921 when registration processing is performed, and the visitor identifier (ID) and the guest identifier (ID) may be checked when open-close control is performed. Further, while it is assumed that an entry-exit location (venue) and a date and time of entry-exit are previously set, when an entry-exit location and a date and time of entry-exit are set at registration, input and registration of the entry-exit location, and the date and time of entry-exit are performed by a guest.

### Hardware Configuration of Smartphone

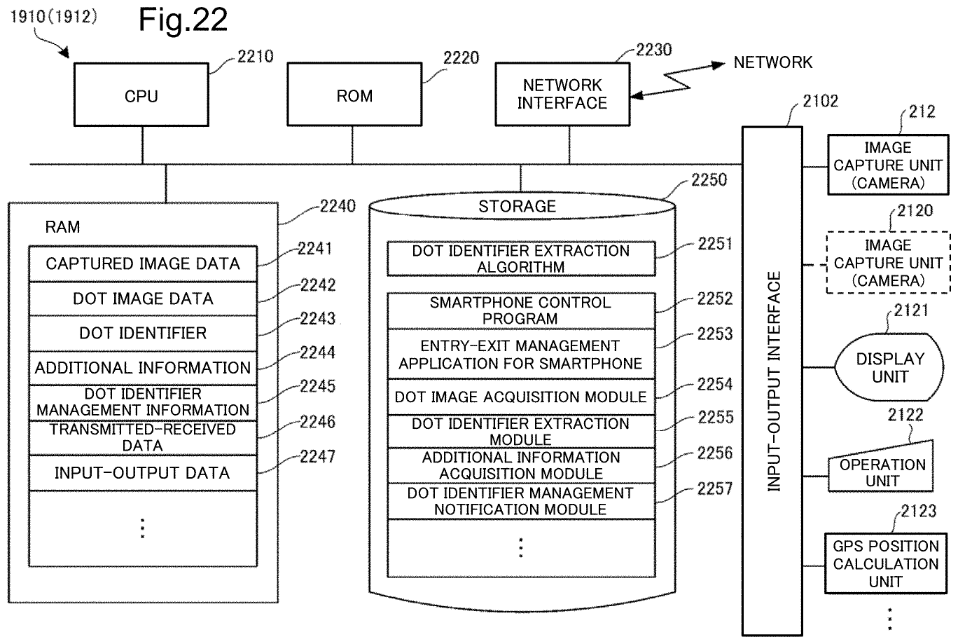

FIG. 22 is a block diagram illustrating a hardware configuration of the smartphone 1911 in the registration terminal 1910 according to the present example embodiment. In FIG. 22, a functional configuration for character-recognizing a visitor identifier (ID) from a captured image of a business card, or the like for considering a visitor identifier (ID) and a guest identifier (ID) is omitted. Further, a functional configuration for registration of an entry-exit location and a date and time of entry-exit, and the like are also omitted.

In FIG. 22, a CPU 2210 is a processor for arithmetic control and provides the function configuration units in FIG. 21 by executing a program. There may be one or a plurality of CPUs 2210. A ROM 2220 stores initial data, fixed data for a program and the like, and a program. A network interface 2230 controls communication with the entry-exit management server 1920 through a network.

A RAM 2240 is a random access memory used by the CPU 2210 as work area for temporary storage. A region for storing data required for providing the present example embodiment is secured in the RAM 2240. Captured image data 2241 are image data including a dot 253 described on an object 252 an image of which is captured by the image capture unit (camera) 212. Dot image data 2242 are data of a dot image extracted from captured image data 2241. When the image capture unit (camera) 212 has a dot image extraction function, dot image data 2242 are data of a dot image received from the image capture unit (camera) 212. A dot identifier 2243 is data of a dot identifier extracted from dot image data 2242 when the smartphone 1911 has the function of extracting a dot identifier from a dot image. Additional information 2244 is information, such as a registration location, a registration date and time, and a visitor identifier, being added when additional information is used for authentication other than a dot identifier check. Dot identifier management information 2245 is information for dot identifier management used in a case of a notification of registration of a dot identifier in the entry-exit management database 1921, an instruction from the smartphone 1911 for deletion of a dot identifier from the entry-exit management database 1921, or the like. Transmitted-received data 2246 store data transmitted and received through the network 240 and include a dot image, a dot identifier, and a registration completion notification in this example. Input-output data 2247 are data input and output from and to input-output equipment through the input-output interface 2102.

A storage 2250 stores a database, various parameters, or the following data or programs required for providing the present example embodiment that are used by the CPU 2210. A dot identifier extraction algorithm 2251 is an algorithm used for dot identifier extraction when the smartphone 1911 has a dot identifier extraction function. The storage 2250 holds the following programs. A smartphone control program 2252 is a program controlling the entire smartphone 1911. An entry-exit management application for a smartphone 2253 is an application program for performing entry-exit management as the registration terminal 1910. A dot image acquisition module 2254 is a module including acquisition of a dot image from an image captured by the image capture unit (camera) 212 and enlargement of a dot image. A dot identifier extraction module 2255 is a module extracting a dot identifier from a dot image when the smartphone 1911 has the dot identifier extraction function. An additional information acquisition module 2256 is a module acquiring additional information from input equipment connected to the input-output interface 2102. A dot identifier management notification module 2257 is a module managing a notification of registration of a dot identifier in the entry-exit management database 1921, an instruction from the smartphone 1911 for deletion of a dot identifier from the entry-exit management database 1921, or the like.

The input-output interface 2102 serves as an interface for controlling data input and output from and to an input-output device. As illustrated in FIG. 21, the input-output interface 2102 is connected to the image capture unit (camera) 212, the image capture unit (camera) 2120, the display unit 2121, the operation unit 2122, the GPS position calculation unit 2123, and the like, according to the present example embodiment.

A program and data related to a general-purpose function and another executable function of the smartphone 1911 are not illustrated in the RAM 2240 and the storage 2250 in FIG. 22.

### Processing Procedure of Smartphone

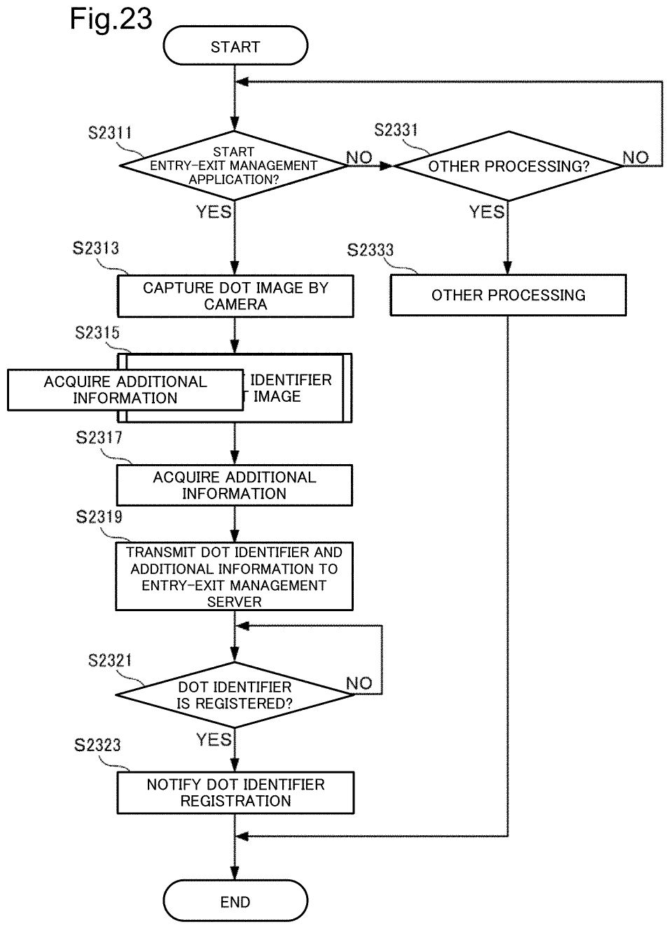

FIG. 23 is a flowchart illustrating a processing procedure of the smartphone 1911 as the registration terminal 1910 according to the present example embodiment. The flowchart is executed by the CPU 2210 in FIG. 22 by use of the RAM 2240 and provides the function configuration units in FIG. 21. Processing “EXTRACT DOT IDENTIFIER FROM DOT IMAGE” in FIG. 23 is selected from the dot identifier extraction processing presented in FIG. 2B and FIG. 8A to FIG. 12B and for example, executes the processing in accordance with the flowchart in FIG. 8B, FIG. 11B, or FIG. 12B. Further, in FIG. 23, processing for character-recognizing a visitor identifier (ID) from a captured image of a business card, or the like for considering a visitor identifier (ID) and a guest identifier (ID) is omitted. Further, processing for registration of an entry-exit location and a date and time of entry-exit, and the like are also omitted.

In Step S2311, the smartphone 1911 determines whether or not the entry-exit management application program for a smartphone is to be started. When determining that the entry-exit management application program for a smartphone is to be started, in Step S2313, the smartphone 1911 captures, by the image capture unit (camera) 212, an image of a dot image of a dot 253 or 1953 described on an object 252 or 1952. In Step S2315, the smartphone 1911 extracts a dot identifier from the dot image. Then, as required, in Step S2317 the smartphone 1911 acquires additional information to be added to the dot identifier.

In Step S2319, the smartphone 1911 transmits the extracted dot identifier and, as required, the additional information to the entry-exit management server 1920. Then, in Step S2321, the smartphone 1911 awaits a registration completion notification of the dot identifier from the entry-exit management server 1920. When receiving a registration completion notification of the dot identifier from the entry-exit management server 1920, in Step S2323, the smartphone 1911 notifies registration completion of the dot identifier from the display unit 2121 or the like.

When determining that the entry-exit management application program for a smartphone is not to be started, in Step S2331, the smartphone 1911 determines whether or not other processing is to be performed. When determining that other processing is to be performed, in Step S2333, the smartphone 1911 performs the processing.

While only the dot identifier registration processing is described as the entry-exit management application program for a smartphone in FIG. 23, for example, dot identifier deletion processing may be included.

In addition to the effects of the aforementioned example embodiments, the present example embodiment allows easy addition of the admission pass function to a possession at any time at any location and therefore can reduce cost and effort required for entry-exit management. For example, the admission pass function can be added to a possession by connecting a high-resolution camera to a mobile terminal and capturing a dot image described on the possession, at any time at any location. Accordingly, a printer for printing a bar code or the like is not required. As long as resolution of a camera on a mobile terminal is sufficient for image capture of a dot image or dot identifier extraction, a separate camera is not required, and the admission pass function can be added to a possession merely by image capture of a dot image with the camera on the mobile terminal. Furthermore, a dot image and a dot identifier do not include information related to personal information at all, and therefore protection of personal information required in face authentication or the like is also perfectly performed.

### Fourth Example Embodiment

Next, an entry-exit management system according to a fourth example embodiment will be described. Compared with the aforementioned second example embodiment and third example embodiment, the entry-exit management system according to the present example embodiment differs in performing entry-exit management by also using information about a possession on which a dot is described. The other configuration and operation are similar to those according to the second example embodiment or the third example embodiment, and therefore the same configuration and operation are given the same reference signs, thus omitting detailed description thereof.

### Overview of Entry-Exit Management System

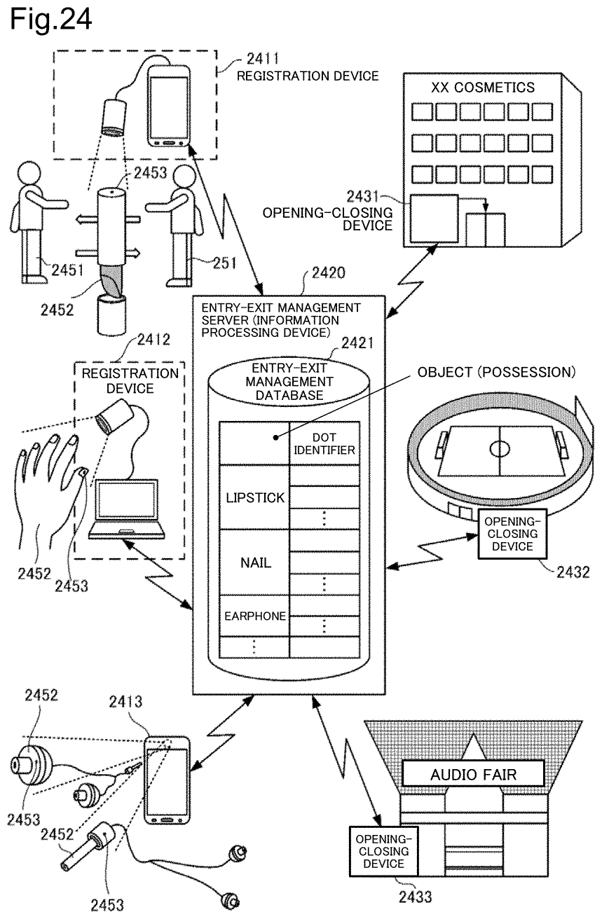

FIG. 24 is a diagram illustrating an overview of the entry-exit management system according to the present example embodiment.

The entry-exit management system in FIG. 24 includes registration devices 2411 to 2413, an entry-exit management server 2420 as an information processing device, and opening-closing devices 2431 to 2433 installed at various venues.

The registration device 2411 sets a lipstick being a possession of a visitor 251 as an object 2452, captures an image of a dot 2453 described on the object 2452 being a lipstick by a guest 2451, and registers a dot identifier in an entry-exit management database 2421 in the entry-exit management server 2420, along with information about the possession (lipstick). The opening-closing device 2431 that is open-close managed based on the dot 2453 described on such an object 2452 being a lipstick manages entry-exit to and from an XX Cosmetics building or entry-exit to and from a predetermined location in the XX Cosmetics building. Such management of entry-exit to and from the XX Cosmetics building or entry-exit to and from the predetermined location in the XX Cosmetics building in consideration of not only a dot identifier but also a possession (lipstick) on which a dot is described enables more reliable entry-exit management. Further, performing management of entry-exit to and from the XX Cosmetics building or entry-exit to and from the predetermined location in the XX Cosmetics building, based on the dot described on the object 2452 being a lipstick, reduces a possibility of presenting a wrong admission pass. Furthermore, performing management of entry-exit to and from the XX Cosmetics building or entry-exit to and from the predetermined location in the XX Cosmetics building, based on the dot 2453 described on the object 2452 being a lipstick, also provides an advertisement effect with respect to cosmetics. The advertisement effect becomes particularly outstanding when the guest 2451 describes a dot on a lipstick from XX Cosmetics and gives the lipstick to a visitor.

The information about the possession (lipstick) at registration may be input from the registration device 2411 or recognized from an image captured by a camera. While it is desirable that a camera capturing an image of a dot and a camera capturing an image of a possession be the same, the cameras may be separately connected. Alternatively, image capture of a possession may be instead performed by a surveillance camera. Further, when the information is recognized from an image captured by a camera, recognition processing may be performed by the registration device 2411 or may performed by the entry-exit management server 2420. Further, information about the possession (lipstick) at a check may be input from the opening-closing device 2431 or may be recognized from an image captured by a camera. Alternatively, the information may be confirmed by visual observation by a receptionist when the receptionist is present.

The registration device 2412 sets a fingernail of a visitor as an object 2452, captures an image of a dot 2453 described on the object 2452 being a nail, and registers a dot identifier in the entry-exit management database 2421 in the entry-exit management server 2420, along with information about a possession (nail). The opening-closing device 2432 that is open-close managed based on the dot 2453 described on such an object 2452 being a nail manages entry-exit to and from a YY soccer field or entry-exit to and from a predetermined gate in the YY soccer field. Such management of entry-exit to and from the YY soccer field or entry-exit to and from the predetermined gate in the YY soccer field in consideration of not only a dot identifier but also a possession (nail) on which a dot is described enables more reliable entry-exit management. Performing management of entry-exit to and from the YY soccer field or entry-exit to and from the predetermined gate in the YY soccer field, based on the dot 2453 described on the object 2452 being a nail, reduces a possibility of presenting a wrong admission pass. Furthermore, performing management of entry-exit to and from the YY soccer field or entry-exit to and from the predetermined gate in the YY soccer field, based on a dot described on a uniform or a pennant, provides a cheering effect for a team. An advertisement effect becomes particularly outstanding when a guest describes a dot on a uniform or a pennant and gives the uniform or the pennant to a visitor.

The registration device 2413 sets an earphone possessed by a visitor as an object 2452, captures an image of a dot 2453 described on the object 2452 being an earphone, and registers a dot identifier in the entry-exit management database 2421 in the entry-exit management server 2420, along with information about the possession (earphone). The opening-closing device 2433 that is open-close managed based on the dot 2453 described on such an object 2452 being an earphone manages entry-exit to and from an audio fair venue or entry-exit to and from a predetermined booth in the audio fair venue. Such management of entry-exit to and from the audio fair venue or entry-exit to and from the predetermined booth in the audio fair venue in consideration of not only a dot identifier but also a possession (earphone) on which a dot is described enables more reliable entry-exit management. Performing management of entry-exit to and from the audio fair venue or entry-exit to and from the predetermined booth in the audio fair venue, based on the dot 2453 described on the object 2452 being an earphone, reduces a possibility of presenting a wrong admission pass. Furthermore, performing management of entry-exit to and from the audio fair venue or entry-exit to and from the predetermined booth in the audio fair venue, based on the dot 2453 described on the object 2452 being an earphone, provides an advertisement effect with respect to the audio fair. The advertisement effect becomes particularly outstanding when a dot is described on an earphone manufactured by a company to which a guest belongs and the earphone is given to a visitor.

While three examples are illustrated in FIG. 24 as possessions on which dots are described, the possession is not limited to the above. In order to more reliably perform entry-exit management, or enhance an induction effect and an advertisement effect, dots may be described on various possessions and an admission pass function may be given to the possessions.

### Entry-Exit Management Database

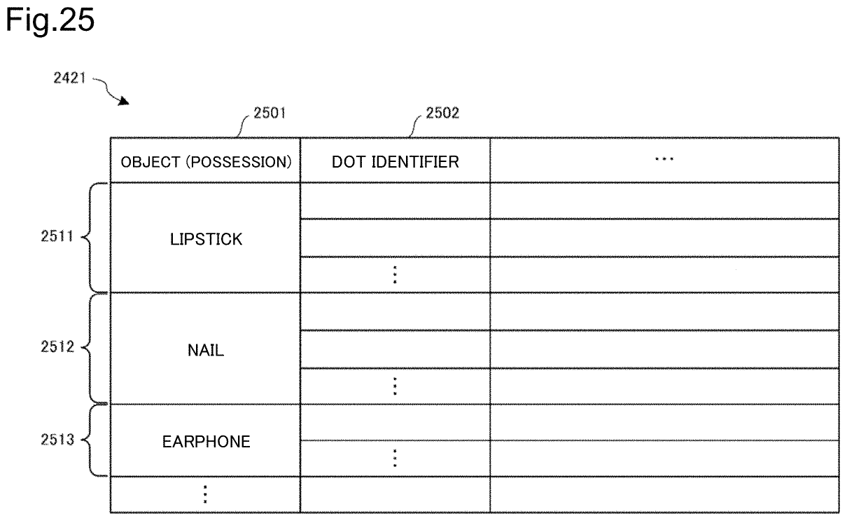

FIG. 25 is a diagram illustrating a structure of the entry-exit management database 2421 according to the present example embodiment. The entry-exit management database 2421 is used for performing entry-exit management in consideration of information about various objects (possessions) on which dots are described, in addition to a dot identifier.

The entry-exit management database 2421 registers a plurality of dot identifiers 2502 in association with an object (possession) 2501. Further, in connection with FIG. 24, a dot identifier group 2511 for a dot described on a lipstick, a dot identifier group 2512 for a dot described on a nail, and a dot identifier group 2513 for a dot described on an earphone are included.

The structure of the entry-exit management database 2421 is not limited to FIG. 25, and other additional information in addition to a dot identifier may be registered, as illustrated in FIG. 5. Further, information included in the entry-exit management database 2421 is not limited to FIG. 25. Other information useful for enhancing reliability of entry-exit management, providing more efficient entry-exit management, or providing other effects such as an advertisement effect may be added.

### Processing Procedure of Entry-Exit Management Server

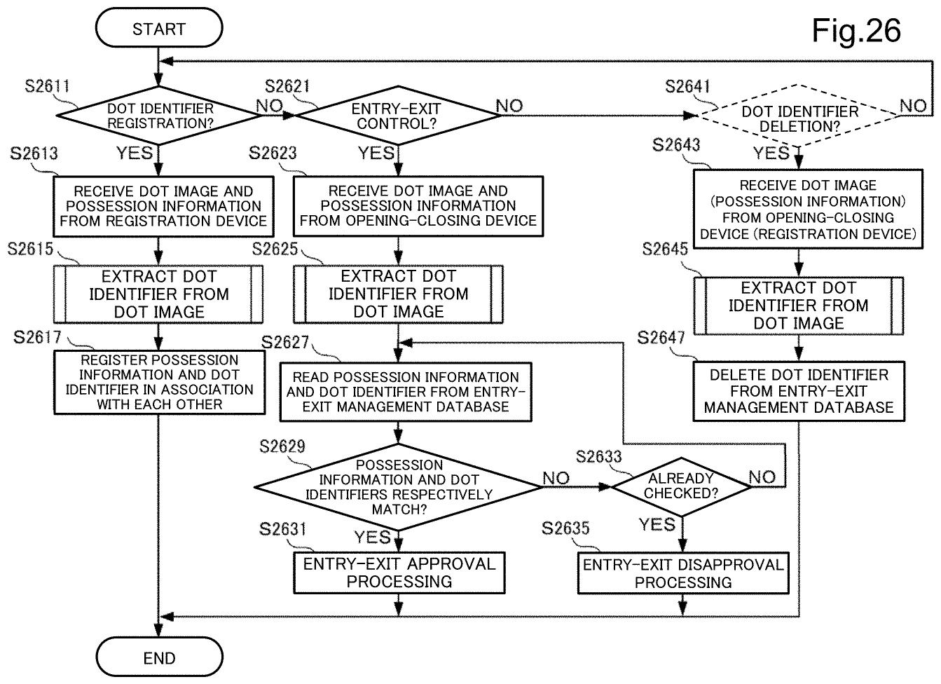

FIG. 26 is a flowchart illustrating a processing procedure of the entry-exit management server 2420 as the information processing device according to the present example embodiment. The flowchart is executed by the CPU 1310 in FIG. 13 by use of the RAM 1340 and provides function configuration units in the entry-exit management server 2420. The flowchart in FIG. 26 corresponds to the operational sequence in FIG. 3A by which the entry-exit management server extracts a dot identifier. Further, processing “EXTRACT DOT IDENTIFIER FROM DOT IMAGE” in FIG. 26 is selected from the dot identifier extraction processing presented in FIG. 2B and FIG. 8A to FIG. 12B and for example, executes processing in accordance with the flowchart in FIG. 8B, FIG. 11B, or FIG. 12B. Further, in FIG. 26, processing of recognizing information about a possession (lipstick) from an image captured by a camera, and the like are omitted. Further, processing for registering an entry-exit location and a date and time of entry-exit, processing for considering a visitor identifier (ID) and a guest identifier (ID), and the like are also omitted.

In Step S2611, the entry-exit management server 2420 determines whether or not dot identifier registration processing is to be performed. For example, the dot identifier registration processing is determined to be performed by reception of a dot image or a dot identifier from the registration device 2411, 2412, or 2413, or a registration instruction command. When determining that the dot identifier registration processing is to be performed, in Step S2613, the entry-exit management server 2420 receives a dot image and possession information from the registration device 2411, 2412, or 2413. In Step S2615, the entry-exit management server 2420 extracts a dot identifier from the received dot image. Then, in Step S2617, the entry-exit management server 2420 registers the possession information and the extracted dot identifier in the entry-exit management database 2421 in association with each other.

When determining that the dot identifier registration processing is not to be performed, in Step S2621, the entry-exit management server 2420 determines whether or not entry-exit control processing is to be performed. For example, the entry-exit control processing is determined to be performed by reception of a dot image or a dot identifier from the opening-closing device 2431, 2432, or 2433, or an entry-exit control instruction command. When determining that the entry-exit control processing is to be performed, in Step S2623, the entry-exit management server 2420 receives a dot image from the opening-closing device 2431, 2432, or 2433. In Step S2625, the entry-exit management server 2420 extracts a dot identifier from the received dot image. Then, in Step S2627, the entry-exit management server 2420 reads registered possession information and a registered dot identifier from the entry-exit management database 2421 and checks the possession information and the dot identifier against the received possession information and the extracted dot identifier.

In Step S2629, the entry-exit management server 2420 determines whether or not each of the checks of the possession information and the dot identifiers indicates a match. Whether or not the check of the dot identifiers indicates a match may be determined to be a match when the difference derived from the check result is equal to or less than a predetermined threshold value. When determining that the possession information and the dot identifiers match, respectively, in Step S2631, the entry-exit management server 2420 notifies approval of entry-exit to the matching opening-closing device 2431, 2432, or 2433. On the other hand, when determining that the dot identifiers do not match, in Step S2633, the entry-exit management server 2420 determines whether or not a check of a dot identifier to be checked is completed, the dot identifier being registered in the entry-exit management database 2421. For example, a dot identifier to be checked is selected from registered dot identifiers, based on possessor information. When determining that the check is completed, in Step S2635, the entry-exit management server 2420 notifies disapproval of entry-exit to the mismatching opening-closing device 2431, 2432, or 2433. On the other hand, when determining that the check is not completed, the entry-exit management server 2420 continues a check against another dot identifier in the possessor information from Step S2627.

When determining that neither the dot identifier registration processing nor the entry-exit control processing is to be performed, in Step S2641, the entry-exit management server 2420 determines whether or not dot identifier deletion is to be performed. For example, a dot identifier may be deleted, based on a deletion request from the registration device 2411, 2412, or 2413, or the opening-closing device 2431, 2432, or 2433, a case of a predetermined registration time or a predetermined date and time of visit being overdue, or the like. Alternatively, a deletion instruction may be given by a system operator. A procedure in the case of a deletion request from the registration device 2411, 2412, or 2413, or the opening-closing device 2431, 2432, or 2433 will be described below. When determining that the dot identifier deletion processing is to be performed, in Step S2643, the entry-exit management server 2420 receives a dot image (or a dot image and possession information) from the registration device 2411, 2412, or 2413, or the opening-closing device 2431, 2432, or 2433. In Step S2645, the entry-exit management server 2420 extracts a dot identifier from the received dot image. Then, when the extracted dot identifier is registered in the entry-exit management database 2421, in Step S2647, the entry-exit management server 2420 deletes the dot identifier. Deletion may be determined with reference to not only a dot identifier but also possession information.

In addition to the effects of the aforementioned example embodiments, the present example embodiment can provide more reliable entry-exit management by reducing cost and effort, by performing entry-exit management also using information about a possession on which a dot is described. Furthermore, by associating a possession on which a dot is described with an attribute of a venue, an error at entry-exit can be reduced, and also an advertisement effect can be provided.

### Fifth Example Embodiment

Next, an entry-exit management system according to a fifth example embodiment will be described. Compared with the aforementioned second example embodiment to fourth example embodiment, the entry-exit management system according to the present example embodiment differs in performing entry-exit management by also using information about any registration date and time, and any registration location when and where an admission pass function is added to a possession. The other configuration and operation are similar to those according to the second example embodiment to the fourth example embodiment, and therefore the same configuration and operation are given the same reference signs, thus omitting detailed description thereof.

### Overview of Entry-Exit Management System

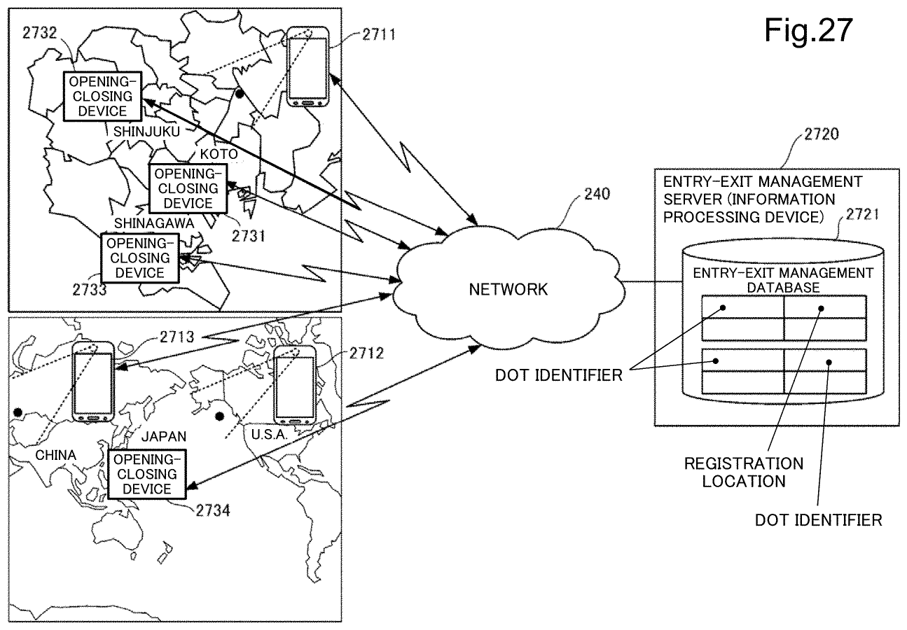

FIG. 27 is a diagram illustrating an overview of the entry-exit management system according to the present example embodiment. FIG. 27 illustrates an entry-exit management system using information about a registration location.

The entry-exit management system in FIG. 27 includes registration devices 2711 to 2713, an entry-exit management server 2720 as an information processing device, and opening-closing devices 2731 to 2734 that are connected through a network 240. The entry-exit management server 2720 as the information processing device includes an entry-exit management database 2721 in which a dot identifier and a registration location (or a registration date and time) are registered in association with each other. A registration location can be acquired by use of a GPS function of the registration devices 2711 to 2713. Further, a registration date and time can be acquired by use of a timer function of the registration devices 2711 to 2713.

A set of the registration device 2711 and the opening-closing devices 2731 to 2733 in the upper diagram in FIG. 27 are placed in the 23 wards of Tokyo. The registration device 2711 can register a dot identifier at any time from any location. On the other hand, the opening-closing devices 2731 to 2733 are placed at specific locations. A location and/or a date and time at which the registration device 2711 registers a dot identifier in the entry-exit management database 2721 is related to open-close control of the opening-closing devices 2731 to 2733. For example, a location and/or a date and time of registration is considered in determination of approval-disapproval in the opening-closing devices 2731 to 2733, along with a dot identifier. A visitor may perform input to the opening-closing devices 2731 to 2733, or a reception operator managing the opening-closing devices 2731 to 2733 may confirm a registered location and/or date and time. Alternatively, only an opening-closing device within a predetermined range from a registration location or within a ward where registration is performed may be determined as an entry-exit management target, or an opening-closing device may be determined as an entry-exit management target within a lapse of predetermined time from a date and time of registration or within a predetermined period after predetermined time from the date and time of registration.

Further, a set of the registration devices 2712 and 2713, and the opening-closing device 2734 in the lower diagram in FIG. 27 are placed in various countries in the world. The registration devices 2712 and 2713 can register a dot identifier at any time from any location. On the other hand, the opening-closing device 2734 is placed at customs or a gate in an Olympic stadium in Japan. When the registration device 2712 registers a dot identifier in the entry-exit management database 2721 from the U.S., the number of parameters other than a dot identifier in open-close control by the opening-closing device 2734 is small. On the other hand, when the registration device 2712 registers a dot identifier in the entry-exit management database 2721 from China, the number of parameters other than a dot identifier in open-close control by the opening-closing device 2734 is increased. Alternatively, contents and the number of parameters other than a dot identifier in open-close control by the opening-closing device 2734 may be adjusted according to a date and time of registration, or an opening-closing device may be determined as an entry-exit management target within a lapse of predetermined time from the date and time of registration or within a predetermined period after predetermined time from the date and time of registration.

### Entry-Exit Management Database

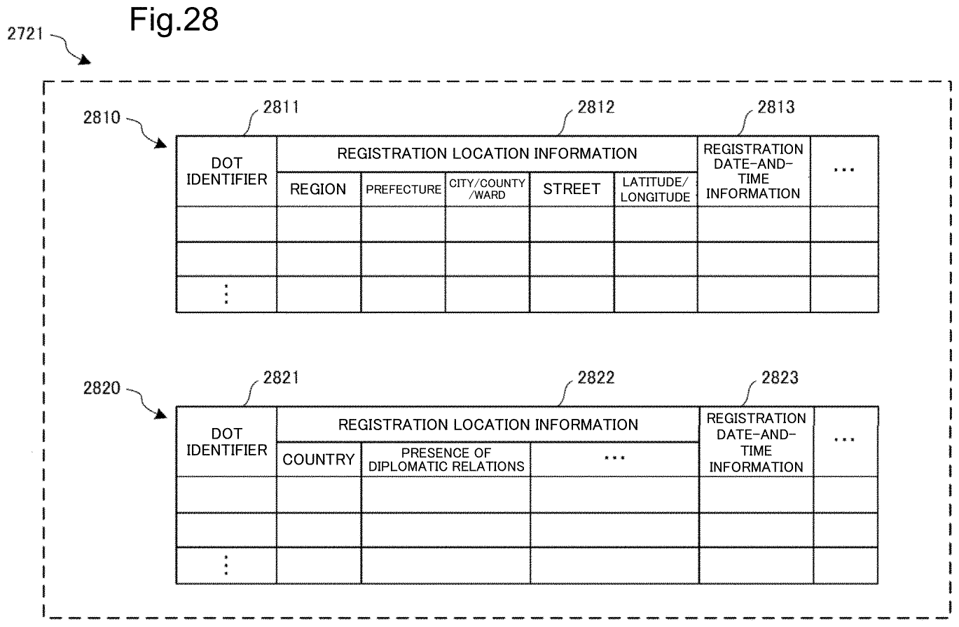

FIG. 28 is a diagram illustrating a structure of the entry-exit management database 2721 according to the present example embodiment. The entry-exit management database 2721 is used for performing entry-exit management considering registration location information and registration date-and-time information of a dot identifier in addition to the dot identifier.

The entry-exit management database 2721 in FIG. 28 illustrates a database 2810 used in the upper diagram in FIG. 27 and a database 2820 used in the lower diagram in FIG. 27.

The database 2810 stores a dot identifier 2811, registration location information 2812, and registration date-and-time information 2813. The registration location information 2812 includes a region, a prefecture, a city/county/ward, a street, and latitude/longitude in Japan.

Further, the database 2820 stores a dot identifier 2821, registration location information 2822, and registration date-and-time information 2823. The registration location information 2822 includes a country in the world and presence of diplomatic relations.

The structure of the entry-exit management database 2721 is not limited to FIG. 28, and other additional information in addition to a dot identifier may be registered, as illustrated in FIG. 5. Further, information included in the entry-exit management database 2721 is not limited to FIG. 28. Other information useful for enhancing reliability of entry-exit management, providing more efficient entry-exit management, or providing other effects such as an advertisement effect may be added.

### Processing Procedure of Entry-Exit Management Server

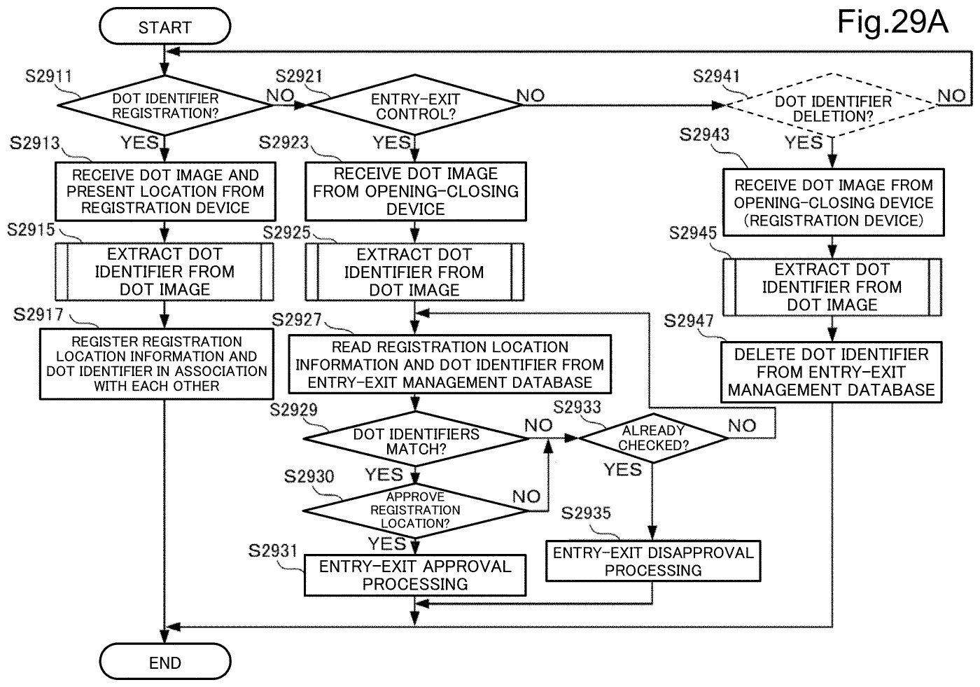

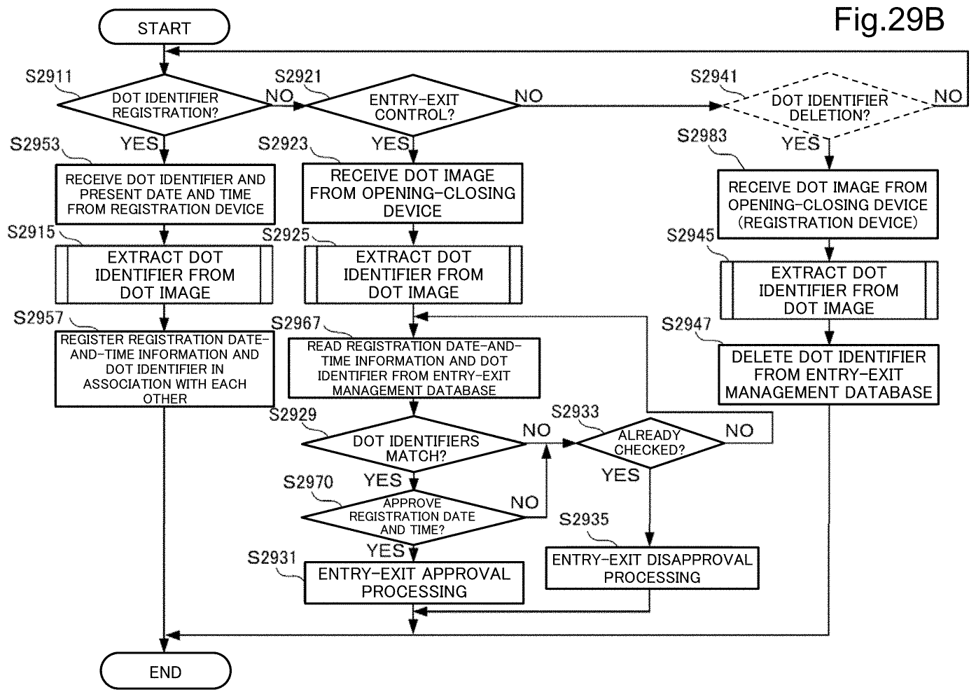

FIG. 29A and FIG. 29B are flowcharts illustrating processing procedures of the entry-exit management server 2720 as the information processing device according to the present example embodiment. The flowcharts are executed by the CPU 1310 in FIG. 13 by use of the RAM 1340 and provide function configuration units of the entry-exit management server 2720. The flowcharts in FIG. 29A and FIG. 29B correspond to the operational sequence in FIG. 3A by which the entry-exit management server extracts a dot identifier. Further, processing “EXTRACT DOT IDENTIFIER FROM DOT IMAGE” in FIG. 29A and FIG. 29B is selected from the dot identifier extraction processing presented in FIG. 2B and FIG. 8A to FIG. 12B and for example, executes processing in accordance with the flowchart in FIG. 8B, FIG. 11B, or FIG. 12B.

FIG. 29A is a flowchart considering a location where a dot identifier is registered.

In Step S2911, the entry-exit management server 2720 determines whether or not dot identifier registration processing is to be performed. For example, the dot identifier registration processing is determined to be performed by reception of a dot image or a dot identifier from the registration device 2411, 2412, or 2413, or a registration instruction command. When determining that the dot identifier registration processing is to be performed, in Step S2913, the entry-exit management server 2720 receives a dot image and a present location from the registration device 2411, 2412, or 2413. In Step S2915, the entry-exit management server 2720 extracts a dot identifier from the received dot image. Then, in Step S2917, the entry-exit management server 2720 registers registration location information and the extracted dot identifier in the entry-exit management database 2721 in association with each other.

When determining that the dot identifier registration processing is not to be performed, in Step S2921, the entry-exit management server 2720 determines whether or not entry-exit control processing is to be performed. For example, the entry-exit control processing is determined to be performed by reception of a dot image or a dot identifier from the opening-closing device 2731, 2732, 2733, or 2734, or an entry-exit control instruction command. When determining that the entry-exit control processing is to be performed, in Step S2923, the entry-exit management server 2720 receives a dot image from the opening-closing device 2731, 2732, 2733, or 2734. In Step S2925, the entry-exit management server 2720 extracts a dot identifier from the received dot image. Then, in Step S2927, the entry-exit management server 2720 reads registered registration location information and a registered dot identifier from the entry-exit management database 2421 and checks the read dot identifier against the extracted dot identifier.

In Step S2929, the entry-exit management server 2720 determines whether or not the check of the dot identifiers indicates a match. Whether or not the check of the dot identifiers indicates a match may be determined to be a match when the difference derived from the check result is equal to or less than a predetermined threshold value. When determining that the dot identifiers match, in Step S2930, the entry-exit management server 2720 determines whether or not the registration location information can be approved. When determining that the registration location information can be approved, in Step S2931, the entry-exit management server 2720 notifies approval of entry-exit to the approved opening-closing device 2731, 2732, 2733, or 2734. On the other hand, when determining that the dot identifiers do not match or determining that the registration location information cannot be approved, in Step S2933, the entry-exit management server 2420 determines whether or not a check of a dot identifier to be checked is completed, the dot identifier being registered in the entry-exit management database 2721. For example, a dot identifier to be checked may be selected from registered dot identifiers, based on the registration location information. When determining that the check is completed, in Step S2935, the entry-exit management server 2720 notifies disapproval of entry-exit to the disapproved opening-closing device 2731, 2732, 2733, or 2734. On the other hand, when determining that the check is completed, the entry-exit management server 2720 continues a check against another dot identifier from Step S2927.

When determining that neither the dot identifier registration processing nor the entry-exit control processing is to be performed, in Step S2941, the entry-exit management server 2720 determines whether or not dot identifier deletion is to be performed. For example, a dot identifier may be deleted, based on a deletion request from the registration device 2411, 2412, or 2413, or the opening-closing device 2731, 2732, 2733, or 2734, a case of a predetermined registration time or a predetermined date and time of visit being overdue, or the like. Alternatively, a deletion instruction may be given by a system operator. A procedure in the case of a deletion request from the registration device 2411, 2412, or 2413, or the opening-closing device 2731, 2732, 2733, or 2734 will be described below. When determining that the dot identifier deletion processing is to be performed, in Step S2943, the entry-exit management server 2720 receives a dot image from the registration device 2411, 2412, or 2413, or the opening-closing device 2731, 2732, 2733, or 2734. In Step S2945, the entry-exit management server 2720 extracts a dot identifier from the received dot image. Then, when the extracted dot identifier is registered in the entry-exit management database 2721, in Step S2947, the entry-exit management server 2720 deletes the dot identifier. Deletion may be determined with reference to not only a dot identifier but also registration location information.

FIG. 29B is a flowchart considering a date and time when a dot identifier is registered. In FIG. 29B, a step similar to that in FIG. 29A is given the same step number, and redundant description thereof is omitted.

In Step S2953, the entry-exit management server 2720 receives a dot image and a present date and time from the registration device 2411, 2412, or 2413. Then, in Step S2957, the entry-exit management server 2720 registers registration date-and-time information and an extracted dot identifier in the entry-exit management database 2721 in association with each other.

In the entry-exit control processing, in Step S2967, the entry-exit management server 2720 reads registered registration date-and-time information and a registered dot identifier from the entry-exit management database 2721 and checks the dot identifier against the received extracted dot identifier. Then when determining that the dot identifiers match, in Step S2970, the entry-exit management server 2720 determines whether or not the registration date-and-time information can be approved. When determining that the registration date-and-time information can be approved, in Step S2931, the entry-exit management server 2720 notifies approval of entry-exit to the approved opening-closing device 2731, 2732, 2733, or 2734. On the other hand, when determining that the dot identifiers do not match or determining that the registration date-and-time information cannot be approved, in Step S2933, the entry-exit management server 2420 determines whether or not a check of a dot identifier to be checked is completed, the dot identifier being registered in the entry-exit management database 2721. For example, a dot identifier to be checked may be selected from registered dot identifiers, based on the registration date-and-time information.

In the dot identifier deletion action, deletion may be determined with reference to not only a dot identifier but also registration date-and-time information.

In addition to the effects of the aforementioned example embodiments, the present example embodiment can provide more reliable entry-exit management by reducing cost and effort by performing exit management also using information about any registration date and time, and any registration location when and where the admission pass function is added to a possession. Furthermore, by associating a registration date and time, and a registration location when and where a dot is described with an attribute of a venue, an error at entry-exit can be reduced, and also enhanced efficiency in entry-exit management can be provided.

### Sixth Example Embodiment

Next, an entry-exit management system according to a sixth example embodiment will be described. Compared with the aforementioned second example embodiment to fifth example embodiment, the entry-exit management system according to the present example embodiment differs in performing entry-exit management by also using information about an entry date and time, and an entry location by a possession added with an admission pass function. The other configuration and operation are similar to those according to the second example embodiment to the fifth example embodiment, and therefore the same configuration and operation are given the same reference signs, thus omitting detailed description thereof.

### Overview of Entry-Exit Management System

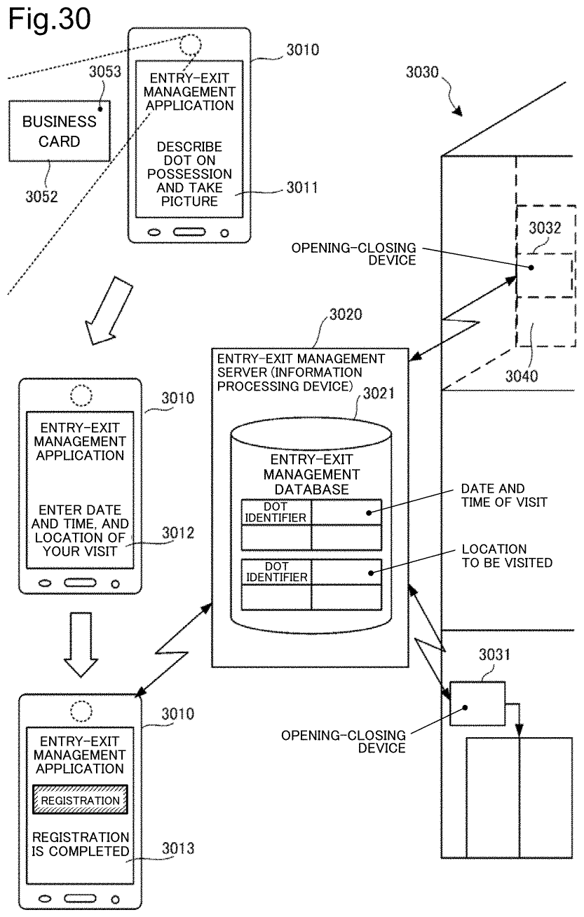

FIG. 30 is a diagram illustrating an overview of the entry-exit management system according to the present example embodiment.

The entry-exit management system 3000 in FIG. 30 includes a registration terminal 3010 including a high-resolution image capture unit (camera), an entry-exit management server 3020 as an information processing device, and opening-closing devices 3031 and 3032 that are connected through a network. The entry-exit management server 3020 includes an entry-exit management database 3021 in which a dot identifier extracted from a dot described on a possession, and a date and time of visit and/or a location to be visited are registered in association with each another.

In FIG. 30, a display screen on the registration terminal 3010 changes in a direction from top to bottom. A message “DESCRIBE DOT ON POSSESSION AND TAKE PICTURE” is displayed on a display screen 3011 on the registration terminal 3010 in the top diagram, and an image of a dot 3053 described on a business card 3052 is captured by the image capture unit (camera). A message “ENTER DATE AND TIME, AND LOCATION OF YOUR VISIT” is displayed on a display screen 3012 on the registration terminal 3010 in the middle diagram, and a date and time of visit and a location to be visited are input from an operation unit. The date and time of visit and the location to be visited may be acquired from a captured image of the possession (business card). A “REGISTRATION button” is displayed on a display screen 3013 on the registration terminal 3010 in the bottom diagram, and when the button is pushed, a dot identifier extracted from a dot image of the dot 3053 described on the business card 3052, and the date and time of visit and the location to be visited are transmitted to the entry-exit management server 3020.

The entry-exit management server 3020 registers the received dot identifier, and the received date and time of visit and the received location to be visited in the entry-exit management database 3021 in association with one another. Then, when the registration processing is completed, a message “REGISTRATION IS COMPLETED” is displayed on the display screen 3013 on the registration terminal 3010 in the bottom diagram.

In FIG. 30, entry-exit to and from a building 3030 is controlled by the opening-closing device 3031, and entry-exit to and from a room 3040 in the building 3030 is controlled by the opening-closing device 3032, based on a dot identifier, and a date and time of visit and a location to be visited that are registered in the entry-exit management database 3021.

### Entry-Exit Management Database

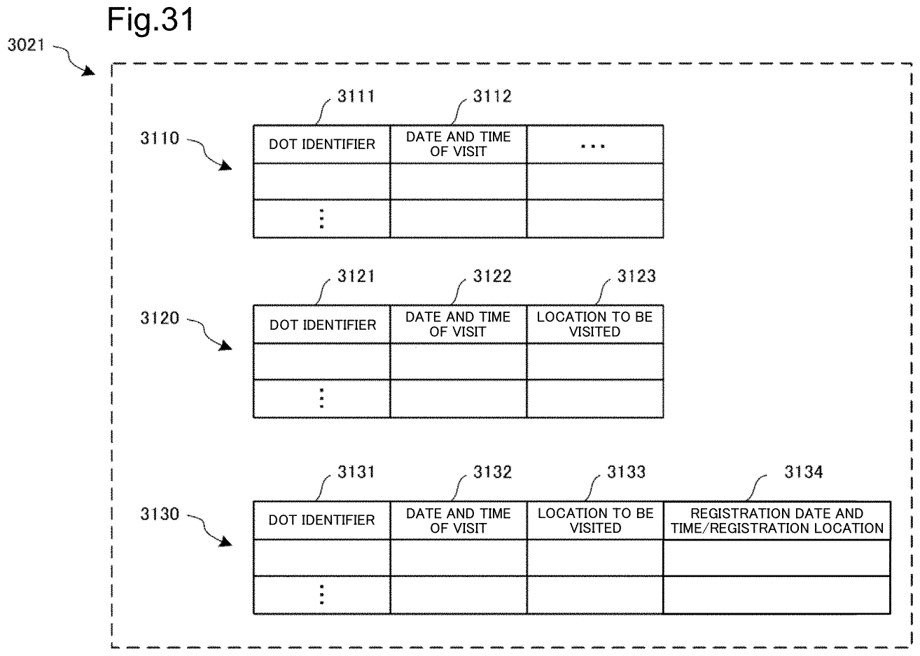

FIG. 31 is a diagram illustrating a structure of the entry-exit management database 3021 according to the present example embodiment. The entry-exit management database 3021 is used for performing entry-exit management considering date-and-time-of-visit information and location information in addition to a dot identifier.

A configuration 3110, a configuration 3120, a configuration 3130, and the like are registered in the entry-exit management database 3021 in FIG. 31. The configuration 3110 stores a dot identifier 3111 and a date and time of visit 3112 in association with each other. The configuration 3120 stores a dot identifier 3121, a date and time of visit 3122, and a location to be visited 3123 in association with one another. The configuration 3130 stores a dot identifier 3131, a date and time of visit 3132, a location to be visited 3133, and a registration date and time/registration location 3134.

The structure of the entry-exit management database 3021 is not limited to FIG. 31, and other additional information in addition to a dot identifier may be registered, as illustrated in FIG. 5. Further, information included in the entry-exit management database 3021 is not limited to FIG. 31. Other information useful for enhancing reliability of entry-exit management, providing more efficient entry-exit management, or providing other effects such as an advertisement effect may be added.

### Processing Procedure of Entry-Exit Management Server

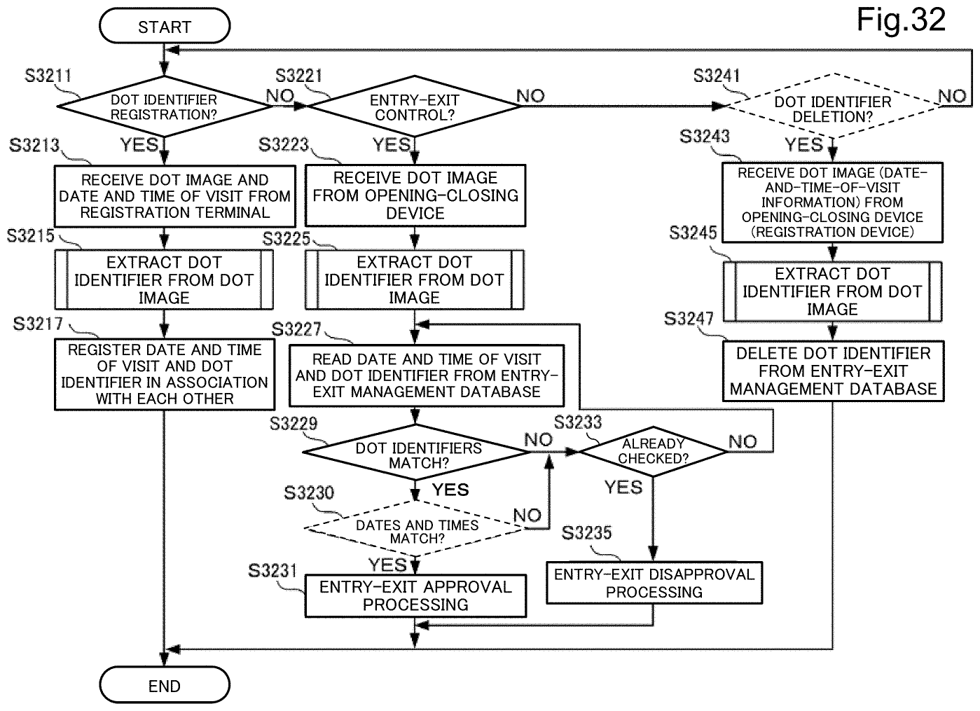

FIG. 32 is a flowchart illustrating a processing procedure of the entry-exit management server 3020 as the information processing device according to the present example embodiment. The flowchart is executed by the CPU 1310 in FIG. 13 by use of the RAM 1340 and provides function configuration units in the entry-exit management server 3020. The flowchart in FIG. 32 corresponds to the operational sequence in FIG. 3A by which the entry-exit management server extracts a dot identifier. Further, processing “EXTRACT DOT IDENTIFIER FROM DOT IMAGE” in FIG. 32 is selected from the dot identifier extraction processing presented in FIG. 2B and FIG. 8A to FIG. 12B and for example, executes processing in accordance with the flowchart in FIG. 8B, FIG. 11B, or FIG. 12B.

FIG. 32 is a flowchart considering a date and time of visit. A processing procedure considering a location to be visited is similar to the flowchart considering a date and time of visit, and therefore is omitted.

In Step S3211, the entry-exit management server 3020 determines whether or not dot identifier registration processing is to be performed. For example, the dot identifier registration processing is determined to be performed by reception of a dot image or a dot identifier from the registration terminal 3010 or a registration instruction command. When determining that the dot identifier registration processing is to be performed, in Step S3213, the entry-exit management server 3020 receives a dot image and date-and-time-of-visit information from the registration terminal 3010. In Step S3215, the entry-exit management server 3020 extracts a dot identifier from the received dot image. Then, in Step S3217, the entry-exit management server 3020 registers the date-and-time-of-visit information and the extracted dot identifier in the entry-exit management database 3021 in association with each other.

When determining that the dot identifier registration processing is not to be performed, in Step S3221, the entry-exit management server 3020 determines whether or not entry-exit control processing is to be performed. For example, the entry-exit control processing is determined to be performed by reception of a dot image or a dot identifier from the opening-closing device 3031 or 3032, or an entry-exit control instruction command. When determining that the entry-exit control processing is to be performed, in Step S3223, the entry-exit management server 3020 receives a dot image from the opening-closing device 3031 or the 3032. In Step S3225, the entry-exit management server 3020 extracts a dot identifier from the received dot image. Then, in Step S3227, the entry-exit management server 3020 reads registered date-and-time-of-visit information and a registered dot identifier from the entry-exit management database 3021 and checks the dot identifier against the extracted dot identifier.

In Step S3229, the entry-exit management server 3020 determines whether or not the check of the dot identifiers indicates a match. Whether or not the check of the dot identifiers indicates a match may be determined to be a match when the difference derived from the check result is equal to or less than a predetermined threshold value. When determining that the dot identifiers match, in Step S3230, the entry-exit management server 3020 determines whether or not the date-and-time-of-visit information can be approved. When determining that the date-and-time-of-visit information can be approved, in Step S3231, the entry-exit management server 3020 notifies approval of entry-exit to the approved opening-closing device 3031 or 3032. On the other hand, when determining that the dot identifiers do not match or determining that the date-and-time-of-visit information cannot be approved, in Step S3233, the entry-exit management server 3020 determines whether or not a check of a dot identifier be checked is completed, the dot identifier being registered in the entry-exit management database 3021. For example, a dot identifier to be checked may be selected from registered dot identifiers, based on the date-and-time-of-visit information. When determining that the check is completed, in Step S3235, the entry-exit management server 3020 notifies disapproval of entry-exit to the disapproved opening-closing device 3031 or 3032. On the other hand, when determining that the check is not completed, the entry-exit management server 3020 continues a check against another dot identifier from Step S3227.

When determining that neither the dot identifier registration processing nor the entry-exit control processing is to be performed, in Step S3241, the entry-exit management server 3020 determines whether or not dot identifier deletion is to be performed. For example, a dot identifier may be deleted by a deletion request from the registration terminal 3010, or the opening-closing device 3031 or 3032, a case of a predetermined registration time or a predetermined date and time of visit being overdue, or the like. Alternatively, a deletion instruction may be given by a system operator. A procedure in the case of a deletion request from the registration terminal 3010, or the opening-closing device 3031 or 3032 will be described below. When determining that the dot identifier deletion processing is to be performed, in Step S3243, the entry-exit management server 3020 receives a dot image and date-and-time information from the registration terminal 3010, or the opening-closing device 3031 or 3032. In Step S3245, the entry-exit management server 3020 extracts a dot identifier from the received dot image. Then, when the extracted dot identifier is registered in the entry-exit management database 3021, in Step S3247, the entry-exit management server 3020 deletes the dot identifier. Deletion may be determined with reference to not only a dot identifier but also date-and-time-of-visit information.

In addition to the effects of the aforementioned example embodiments, the present example embodiment can provide more reliable entry-exit management by reducing cost and effort, by performing entry-exit management also using information about an entry date and time, and an entry location by a possession added with the admission pass function. Furthermore, by associating an entry date and time, and an entry location by a possession added with the admission pass function with an attribute of a venue, an error at entry-exit can be reduced, and also enhanced efficiency in entry-exit management can be provided.

### Seventh Example Embodiment

Next, an entry-exit management system according to a seventh example embodiment will be described. Compared with the aforementioned second example embodiment to sixth example embodiment, the entry-exit management system according to the present example embodiment differs in performing entry-exit management, based on a suitable combination of a dot identifier type and additional information. The other configuration and operation are similar to those according to the second example embodiment to the sixth example embodiment, and therefore the same configuration and operation are given the same reference signs, thus omitting detailed description thereof.

### Overview of Entry-Exit Management System

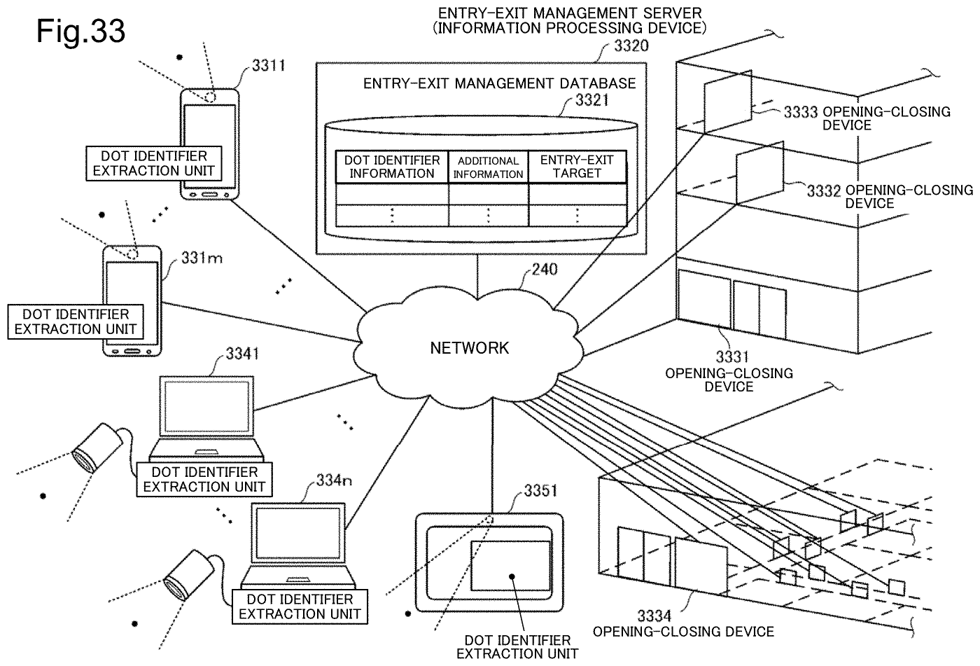

FIG. 33 is a diagram illustrating an overview of the entry-exit management system 3300 according to the present example embodiment.

The entry-exit management system 3300 includes registration devices 3311 to 331m, 3341 to 334n, and 3351, an entry-exit management server 3320 as an information processing device, and opening-closing devices 3331 to 3334 that are connected through a network 240. The registration devices 3311 to 331m, 3341 to 334n, and 3351 are various terminals each of which includes an image capture unit (camera) or is connectable to an image capture unit (camera), and captures an image of a dot described with a writing tool on an object to be an admission pass. It is desirable that each of the registration devices 3311 to 331m, 3341 to 334n, and 3351 include a dot identifier extraction unit extracting a dot identifier from a dot image.

The entry-exit management server 3320 includes an entry-exit management database 3321, checks a registered dot identifier against a dot identifier of a dot an image of which is captured by the opening-closing device 3331, 3332, 3333, or 3334, and notifies the check result to the opening-closing device 3331, 3332, 3333, or 3334. When a match between the registered dot identifier and the dot identifier of the dot an image of which is captured is notified from the entry-exit management server 3320, the opening-closing device 3331, 3332, 3333, or 3334 approves entry by opening a door (or a lock) at each facility. On the other hand, when a mismatch between the registered dot identifier and the dot identifier of the dot an image of which is captured is notified from the entry-exit management server 3320, the opening-closing device 3331, 3332, 3333, or 3334 disapproves entry by closing a door (or a lock) at each facility.

It is assumed in the present example embodiment that the dot identifier extraction unit in each of the registration devices 3311 to 331m, 3341 to 334n, and 3351 has materials of dots described with a writing tool on various objects and dot identifier extraction methods supporting the materials, and each method is associated with a method of extracting a dot identifier from a dot an image of which is captured by the related opening-closing device 3331, 3332, 3333, or 3334. Further, a match between combinations of a plurality of dot identifiers is checked.

### Entry-Exit Management Database

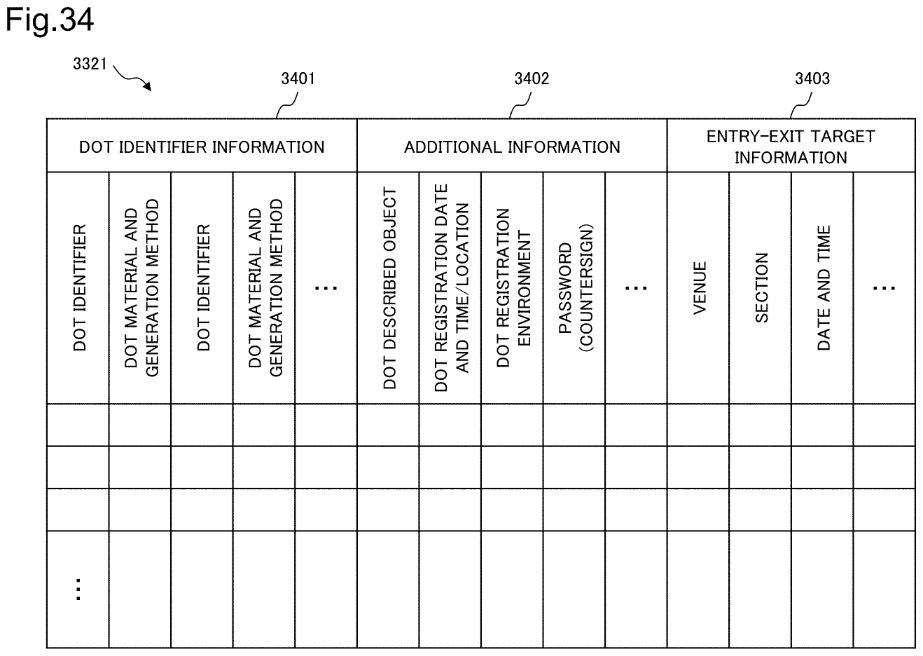

FIG. 34 is a diagram illustrating a structure of the entry-exit management database 3321 according to the present example embodiment. The entry-exit management database 3321 is used for a check of dot identifiers according to the present example embodiment.

The entry-exit management database 3321 stores dot identifier information 3401, additional information 3402, and entry-exit target information 3403. The dot identifier information 3401 includes a plurality of sets of a dot identifier, and a dot material and a dot identifier generation method. Further, the additional information 3402 includes a dot described object, a date and time, and a location of dot registration, a dot registration environment including the weather, and a password or a countersign exchanged between a visitor and a guest. Further, the entry-exit target information 3403 includes a venue where entry-exit management is performed, a section (for example, a floor number or a room number in a building) in the venue, and a scheduled date and time of visit.

Information included in the entry-exit management database 3321 is not limited to FIG. 34. Other information useful for enhancing reliability of entry-exit management, providing more efficient entry-exit management, providing other effects such as an advertisement effect, or the like may be added.

In addition to the effects of the aforementioned example embodiment, the present example embodiment can provide more suitable and reliable entry-exit management by reducing cost and effort, by performing entry-exit management, based on a suitable combination of a dot identifier type and additional information. Furthermore, by associating a suitable combination of a dot identifier type and additional information with an attribute of a venue, an error at entry-exit can be reduced, and also more enhanced efficiency in entry-exit management can be provided.

### Other Example Embodiments

While the present disclosure has been described above with reference to the example embodiments, the present embodiments is not limited to the aforementioned example embodiments. Various changes and modifications that may be understood by a person skilled in the art may be made to the configurations and details of the example embodiments. Further, a system or a device in which different features included in the respective example embodiments are appropriately combined is also included in the scope of the present example embodiment.

Further, the present example embodiment may be applied to a system configured with a plurality of pieces of equipment or may be applied to a single device. Further, the present example embodiment may be applied in a case of an information processing program providing the functions of the example embodiments being directly or remotely supplied to a system or a device. Accordingly, a program installed on a computer in order to provide the functions of the present example embodiment with the computer, a medium holding the program, or a world wide web (WWW) server from which the program is downloaded are also included in the scope of the example embodiment. At least a non-transitory computer-readable medium holding a program causing a computer to execute the processing steps included in the aforementioned example embodiments is particularly included in the scope of the present example embodiment.

### Other Expressions of Example Embodiments

The aforementioned example embodiments may also be described in part or in whole as the following Supplementary Notes but are not limited thereto.

### Supplementary Note 1

An entry-exit management system including:

a registration means configured to register a dot identifier extracted from a dot described with a writing tool on an object to be an admission pass of a visitor;

an image capture means configured to capture an image of the dot;

a checking means configured to check a dot identifier extracted from a dot an image of which is captured by the image capture means against a dot identifier registered in the registration means; and

a control means configured to control entry-exit of the visitor, based on a check result by the checking means.

### Supplementary Note 2

The entry-exit management system according to Supplementary Note 1, wherein

an object to be an admission pass of the visitor is a belonging of the visitor or a belonging of a guest giving the object to the visitor.

### Supplementary Note 3

The entry-exit management system according to Supplementary Note 2, wherein

the belonging includes a business card.

### Supplementary Note 4

The entry-exit management system according to Supplementary Note 3, wherein

the registration means further registers a described content of the business card in association with the dot identifier.

### Supplementary Note 5

The entry-exit management system according to Supplementary Note 2, wherein

the registration means further registers information about the object being a belonging of the visitor or a belonging of a guest giving the object to the visitor, in association with the dot identifier, and

the checking means further checks information about an object an image of which is captured by the image capture means against information about an object registered in the registration means.

### Supplementary Note 6

The entry-exit management system according to Supplementary Note 2, wherein

the registration means further registers information about the object being a belonging of the visitor or a belonging of a guest giving the to object to the visitor, and an entry-exit location being related to information about the object and being associated with information about the object, and

the checking means checks a dot identifier extracted from a dot an image of which is captured by the image capture means against a dot identifier related to information about the object registered in the registration means.

### Supplementary Note 7

The entry-exit management system according to any one of Supplementary Notes 1 to 6, wherein

the registration means further registers at least either of information about a date and time when a dot identifier of a dot described with a writing tool on the object is registered and information about a location where the dot identifier is registered, in association with the dot identifier, and

the checking means further checks at least either of information about a date and time when a dot identifier possessed by the visitor is registered and information about a location where the dot identifier is registered against at least either of information about a date and time registered in the registration means and information about a location registered in the registration means, respectively.

### Supplementary Note 8

The entry-exit management system according to any one of Supplementary Notes 1 to 7, wherein

the registration means further registers information about the visitor or a guest in association with the dot identifier, and

the checking means further checks information about the visitor or a guest acquired upon visit against information about the visitor or a guest registered in the registration means.

### Supplementary Note 9

The entry-exit management system according to any one of Supplementary Notes 1 to 8, wherein

the registration means further registers information about a location to be visited or a date and time of visit by the visitor, in association with the dot identifier, and

the checking means further checks the information about a location to be visited or a date and time of visit acquired upon visit against information about a location to be visited or a date and time of visit by the visitor, the information being registered in the registration means.

### Supplementary Note 10

The entry-exit management system according to any one of Supplementary Notes 1 to 9, wherein

the registration means registers a plurality of dot identifiers extracted from a plurality of dots in association with one another, and

the checking means checks at least one of the plurality of dot identifiers.

### Supplementary Note 11

The entry-exit management system according to any one of Supplementary Notes 3 to 10, wherein

the control means further restricts entry-exit to and from a predetermined location by the visitor, based on a check result by the checking means according to any one of Supplementary Notes 3 to 10.

### Supplementary Note 12

The entry-exit management system according to any one of Supplementary Notes 1 to 11, wherein

the control means approves entry-exit by the visitor when a check result by the checking means indicates a match and disapproves entry-exit by the visitor when a check result by the checking means indicates a mismatch.

### Supplementary Note 13

The entry-exit management system according to Supplementary Note 12, further including

a storage means configured to store information about the visitor entry-exit by whom is approved by the control means.

### Supplementary Note 14

The private accommodation management system according to any one of Supplementary Notes 1 to 13, wherein

the dot identifier indicates a distribution of a microscopic grain contained in the dot.

### Supplementary Note 15

An entry-exit management method including:

a registration step of registering, in a registration means, a dot identifier extracted from a dot being given to an object to be an admission pass of a visitor and being described with a writing tool;

an image capture step of capturing an image of the dot;

a checking step of checking a dot identifier extracted from a dot an image of which is captured in the image capture step against a dot identifier registered in the registration means; and

a control step of controlling entry-exit of the visitor, based on a check result in the checking step.

### Supplementary Note 16

An information processing device including:

a registration means configured to register a dot identifier extracted from a dot described with a writing tool on an object to be an admission pass of a visitor;

an acquisition means configured to acquire a dot identifier extracted from a captured image of the dot;

a checking means configured to check a dot identifier acquired by the acquisition means against a dot identifier registered in the registration means; and

an instruction means configured to instruct control of entry-exit of the visitor, based on a check result by the checking means.

### Supplementary Note 17

An information processing program causing a computer to execute:

a registration step of registering, in a registration means, a dot identifier extracted from a dot described with a writing tool on an object to be an admission pass of a visitor;

an acquisition step of acquiring a dot identifier extracted from a captured image of the dot;

a checking step of checking a dot identifier acquired in the acquisition step against a dot identifier registered in the registration means; and

an instruction step of instructing control of entry-exit of the visitor, based on a check result in the checking step.

### Supplementary Note 18

An opening-closing device including:

a holding means configured to hold a dot identifier extracted from a dot described with a writing tool on an object to be an admission pass of a visitor;

an image capture means configured to capture an image of the dot;

a checking means configured to check a dot identifier extracted from a dot an image of which is captured by the image capture means against a dot identifier held in the holding means; and

a control means configured to control entry-exit of the visitor, based on a check result by the checking means.

### Supplementary Note 19

A processing program for an opening-closing device, the processing program causing a computer to execute:

a holding step of holding, in a holding means, a dot identifier extracted from a dot described with a writing tool on an object to be an admission pass of a visitor;

an image capture step of capturing an image of the dot;

a checking means of checking a dot identifier extracted from a dot an image of which is captured in the image capture step against a dot identifier held in the holding means; and

a control step of controlling entry-exit of the visitor, based on a check result in the checking step.

### Supplementary Note 20

A registration device including:

an image capture means configured to capture an image of a dot described with a writing tool on an object to be an admission pass of a visitor;

an acquisition means configured to acquire at least either of a date and time when an image of the dot is captured and a location where an image of the dot is captured; and

a transmission means configured to perform transmission to an information processing device including a registration means configured to register a dot identifier extracted from the dot and at least either of the date and time, and the location.

### Supplementary Note 21

A processing program for a registration device, the processing program causing a computer to execute:

an image capture step of capturing an image of a dot described with a writing tool on an object to be an admission pass of a visitor;

an acquisition step of acquiring at least either of a date and time when an image of the dot is captured and a location where an image of the dot is captured; and

a transmission step of performing transmission to an information processing device including a registration means configured to register a dot identifier extracted from the dot and at least either of the date and time, and the location.

This application claims priority based on Japanese Patent Application No. 2017-168897 filed on Sep. 1, 2017, the disclosure of which is hereby incorporated by reference thereto in its entirety.

1. An entry-exit management system comprising:
a memory configured to store instructions; and
at least one processor configured to execute the instructions to:
register a dot identifier extracted from a dot described with a writing tool on an object to be an admission pass of a visitor;
capture an image of the dot;
check a dot identifier extracted from a dot an image of which is captured against a dot identifier registered; and
control means configured to control entry-exit of the visitor, based on a check result.

2. The entry-exit management system according to claim 1, wherein
an object to be an admission pass of the visitor is a belonging of the visitor or a belonging of a guest giving the object to the visitor.

3. The entry-exit management system according to claim 2, wherein
the belonging includes a business card.

4. The entry-exit management system according to claim 3, wherein
the at least one processor further configured to execute the instructions to register
a described content of the business card in association with the dot identifier.

5. The entry-exit management system according to claim 2, wherein
the at least one processor further configured to:
register information about the object being a belonging of the visitor or a belonging of a guest giving the object to the visitor, in association with the dot identifier, and
chuck information about an object an image of which is captured against information about an object registered.

6. The entry-exit management system according to claim 2, wherein
the at least one processor further configured to:
register information about the object being a belonging of the visitor or a belonging of a guest giving the object to the visitor, and an entry-exit location being related to information about the object and being associated with information about the object, and
check a dot identifier extracted from a dot an image of which is captured against a dot identifier related to information about the object registered.

7. The entry-exit management system according to claim 1, wherein
the at least one processor further configured to:
register at least either of information about a date and time when a dot identifier of a dot described with a writing tool on the object is registered and information about a location where the dot identifier is registered, in association with the dot identifier, and
check at least either of information about a date and time when a dot identifier possessed by the visitor is registered and information about a location where the dot identifier is registered against at least either of information about a date and time and information about a location registered, respectively.

8. The entry-exit management system according to claim 1, wherein
the at least one processor further configured to:
register information about the visitor or a guest in association with the dot identifier, and
check information about the visitor or a guest acquired upon visit against information about the visitor or a guest registered.

9. The entry-exit management system according to claim 1, wherein
the at least one processor further configured to:
register information about a location to be visited or a date and time of visit by the visitor, in association with the dot identifier, and
check the information about a location to be visited or a date and time of visit acquired upon visit against information about a location to be visited or a date and time of visit by the visitor, the information being registered.

10. The entry-exit management system according to claim 1, wherein
the at least one processor further configured to:
register a plurality of dot identifiers extracted from a plurality of dots in association with one another, and
check at least one of the plurality of dot identifiers.

11. The entry-exit management system according to claim 3, wherein
the at least one processor further configured to
restrict entry-exit to and from a predetermined location by the visitor, based on a check result.

12. The entry-exit management system according to claim 1, wherein
the at least one processor configured to approve entry-exit by the visitor when a check result indicates a match and disapprove entry-exit by the visitor when a check result indicates a mismatch.

13. The entry-exit management system according to claim 12, wherein
the at least one processor further configured to store information about the visitor entry-exit by whom is approved.

14. The entry-exit management system according to claim 1, wherein
the dot identifier indicates a distribution of a microscopic grain contained in the dot.

15. An entry-exit management method comprising:
registering a dot identifier extracted from a dot being given to an object to be an admission pass of a visitor and being described with a writing tool;
capturing an image of the dot;
checking a dot identifier extracted from the dot an image of which is captured against the registered dot identifier; and
controlling entry-exit of the visitor, based on the check result.

16. (canceled)

17. A non-transitory computer readable recording medium storing an information processing program causing a computer to execute:
registration processing of registering, in registration means, a dot identifier extracted from a dot described with a writing tool on an object to be an admission pass of a visitor;
acquisition processing of acquiring a dot identifier extracted from a captured image of the dot;
checking processing of checking the acquired dot identifier against the registered dot identifier; and
instruction processing of instructing control of entry-exit of the visitor, based on the check result.

18.-21. (canceled)
